(19) United States
(12) Patent Application Publication
(10) Pub. No.: US 2008/0040137 A1
(43) Pub. Date: Feb. 14, 2008

(54) Internet-Based Discussion System And Method Thereof, Record Media Recorded Discussion Method

(76) Inventors: Jong-Gu Lee, Seoul (KR); Chung-Koo Lee, Seoul (KR)

Correspondence Address: NEEDLE & ROSENBERG, P.C., SUITE 1000, 999 PEACHTREE STREET, ATLANTA, GA, 30309-3915, US

(21) Appl. No.: 11/661,883

(22) PCT Filed: Sep. 1, 2005
(86) PCT No.: PCT/KR05/02900

§ 371 Date: May 21, 2007

(30) Foreign Application Priority Data
Sep. 3, 2004 (KR) 10-2004-0070447

(51) Int. Cl. G06Q 10/00; G06F 17/30; G06F 17/40

(52) U.S. Cl. 705/1

(57) ABSTRACT

Provided is a discussion system and method for Internet-based reasonable decision-making tool, capable of inducing healthy discussion prosecution by a systematic and standardized discussion procedure and rule to solve various points at issue or conflicts and decision-making generated in a society, an enterprise and group; and of establishing theory and knowledge by creating a model that can extract all information, knowledge, suggestion and proposition of a group needed for decision-making through interactive discussion ping-pong by structural objectification for each case and inducing a conclusion. The system is capable of selectively specifying and operating a different discussion prosecuting procedure for each nature and type of the discussion using a pre-classified and registered discussion rule; defining a role of all discussion participants such as a moderator, a panel, a stakeholder, and an audience; and producing and managing discussion information in a hierarchical structure of discussion classification information, subtopic information, suggestions, suggestion grounds, and counter arguments. The system comprises a special statement editor capable of breaking down an argument for each detailed point at issue and structurally registering it. The system has a function of performing interactive ping-pong on various arguments and arguments for each point at issue, structurally enquiring a ping-pong situation, analyzing all suggested arguments and counter arguments to define a logical structure, correlation and nature between arguments, kicking out logically unsuitable arguments and defective arguments based on the logical structure, correlation and nature, defining an evaluation rule that can define logical reasonableness of the argument based on a nature definition and ping-pong result; and performing systematic, automatic evaluation for each detailed case on suitability of the suggestion.

### TECHNICAL FIELD

The present invention relates to a system and method for Internet-based discussion that supports optimal decision-making, capable of solving conflicts and problems in an organization through innovative, interactive Internet discussion.

### BACKGROUND ART

Conventionally, decision-making and policy establishment in societies or organizations has been the exclusive work of a few elites in possession of limited information. However, with growth of the Internet, extensive exchange of arguments and information, as well as collection and expression of the interests of specific groups, has become possible. Clearly, the intentions of various interest groups, as well as the participation of netizens in decision-making and policy establishment, have had a significant affect on representation of public argument, policy establishment, and decision-making in societies and organizations.

Since 1990, society has been rapidly increasing in diversity and complexity and a conventional public argument system is no longer sufficient. While the roles of different parts of society have become increasingly specialized, non-specialists or a few elites make the laws and policies, etc., causing social problems and loss of opportunity.

Conventional media such as newspaper and television can only convey a limited number of views due to limited pages and airtime, lack of interactiveness, and in-continuity, which makes it difficult for readers to recognize biased or distorted suggestions. And, limited monitoring of various suggestions, arguments, and information prevents the arguments of all but a few panels from being expressed.

In addition, lack of specialty and diversity caused by journalists' insufficient social experience does not lead to a management model based on the analysis of various suggestions, arguments, and information, and does not clearly distinguish between good and bad arguments and information. Journalists, while able to clarify and educate the public about detailed problems surrounding various issues, have limited power to help in the solution process.

To solve such conventional problems, Internet-based discussion sites have appeared, allowing a number of citizens to participate in policy establishment by enabling all levels of society to openly and interactively express their arguments and information.

Such Internet discussion sites are the only means of overcoming the above-mentioned limitations of conventional media and communicating diverse arguments. Such sites make it possible to thoroughly discuss issues at length so that reliable conclusions can be drawn and more reasonable and logical arguments can be formulated, thus increasing the productivity of such discussion and minimizing confusion and misinformation. Since all arguments and information suggested in the discussion process are made available to the public and retained over time, such sites have the potential to exert a more powerful influence on policy making than any other form of media. Further, such Internet sites are a potential source of valuable feedback to policy planers.

Such conventional Internet discussion sites, however, do not promote systematic discussion. Numerous unworthy arguments clutter up the discussion so that worthy arguments become difficult to find as time goes on. Further, constructive arguments are often kicked out by less educated panels (discussion participants). Since there are no rules for productive discussion, discussions often deteriorate into quarrels, insults, and resentment.

Further, lengthy arguments generally contain supporting suggestion and grounds, and it is impossible to discuss the appropriateness of such arguments by dividing them into parts. Also, unnecessary language, arguments irrelevant to the issue, and overlapping arguments make it difficult for the audience as well as discussion participants to follow the progress of the discussion.

In addition, it is difficult for an audience or decision-maker to recognize a necessary objective or a problem to be solved, and it is hard to reach agreement on an issue by combining parts of a discussion.

Thus, such Internet discussion sites do not represent a new paradigm utilizing the power of the Internet, but rather take on simpler roles like that of a guest board. And, rather than helping to solve problems, they tend to enhance conflict. Mature and aware netizens ignore such sites.

The above-described problems of conventional Internet discussion sites are summarized in FIG. 1.

### DISCLOSURE OF INVENTION

### Technical Problem

1. The Philosophy of the Present Invention
An object of discussion is to arrive at a reasonable conclusion, as well as render stakeholders able to recognize a process of reasoning and deduction so that a conclusion can be reached.
Everyone can have reasonable thought. While one may have moments of unreasonable thought, educated and thoughtful people are substantially reasonable. Reasonable suggestions have information and value. Unreasonable suggestions are due to selfish subjectivity (subjective value) and/or misinformation.
When out of the public eye, everyone is self-centered, resulting in group egoism. When in the public eye, one generally thinks to give up group egoism. It is assumed that all suggestions may contain a group-seeking object.
Social agreement and conclusion through discussion is not necessarily derived from reasonable suggestion. Occasionally, they may be derived from public preference, i.e., public argument, regardless of reason. This is referred to as public value. However, public value is also prejudiced by erroneous public argument. Modern society has very high public intelligence but allows information required to formulate public argument to be provided by limited sources, which can lead to bias and misinformation.
If information or values matured into suggestions are clearly open to the public, suggestions will become more reasonable. The system performs a social role to provide and realize certain assumptions about actual, professional information or justice for values leading to the public's correct consciousness structure. The philosophy of the system is that a good discussion can result in healthy social agreement and productive conclusions.

Since modern society is highly diverse, it is impossible to make a perfect decision. Any decision has merits and faults. Decision-making is only a part of a more important value. Stubborn opposition focused on the problem rather than the solution cannot be a factor affecting decision-making. Any deduced problem is only recognized as a problem to be further solved.

It is noted that in the present system, a discussion may not come to a perfect conclusion but at least points out optimal direction to proceed based on collected information, values, and certain assumptions, with the conclusion implying certain vital power and limitation, not absolute conclusion.

2. Technical Means

The present invention has been made to solve the conventional problems of Internet discussion, based on the above-described philosophy.

It is an object of the present invention to provide a system and method for Internet-based discussion, capable of deducing agreement and interest between stakeholders and scientific, reasonable conclusion through cycles by structuralizing arguments and suggestions from all levels of society for each nature to register them for each detailed point at issue, performing interactive ping-pong about points at issue such as counterarguments and further counterarguments on the arguments and suggestions so that an audience or a decision-maker easily recognizes substantial points at issue and discussion status, and reaches a conclusion for each detailed point at issue in view of logical appropriateness of each argument.

Accordingly, the present invention attempts to provide the following technical means to overcome the shortcomings of conventional Internet discussion.

1) What is a type of discussion, what nature does each discussion have, and how will the system accommodate various types of discussions?

2) What discussion prosecution rule should be defined to perform efficient and healthy discussions and what roles of all discussion participants and a moderator should be defined?

3) How are arguments broken down for each detailed point at issue and input to be itemized for meaningful discussion ping-pong?

4) What characteristics do arguments interrupting healthy discussion ping-pong have and what is an alternative?

5) What types of suggestions and counterarguments are there, how should each nature and logicality be classified, and what correlation do suggestions and counterarguments have?

6) How will an information structure and an enquiry form be built so that an audience recognizes a discussion ping-pong situation at a glance for each detailed point at issue rather than for each argument?

7) How is the discussion ping-pong terminated and how is the terminated ping-pong concluded?

### Technical Solution

According to an aspect of the present invention, there is provided an Internet-based discussion system supporting decision-making through Internet discussion, the system comprising: a discussion managing server for performing interactive argument ping-pong for each detailed point at issue of the subject of a discussion according to a certain rule predefined for each type of discussion by panels having access to the server via the Internet, deriving a conclusion by an evaluation rule defined depending on nature of each argument and a ping-pong result, and registering and managing discussion information, discussion ping-pong information, and discussion result deduction information, as well as personal information of all discussion participants, in a database; a number of panel client terminals having a web browser enabling the panel to access the discussion managing server via the Internet; and a number of audience client terminals for suggesting a free argument on a discussion ping-pong situation processed according to the discussion ping-pong between a number of the panels, asking a panel's argument or participating in the discussion ping-pong in response to a panel's advocacy request, and participating in a public argument poll.

The discussion managing server comprises a master code information DB that stores master code information (code table) for various classifications on a discussion; a member information DB that stores basic information about all members; a discussion information DB that stores each discussion object related information such as discussion division and classification, discussion prosecution rules and prosecuting situation, which define nature of the discussion, as well as information such as a title and a subtopic of the discussion; an argument information DB that stores argument information such as all suggestion grounds, counterarguments and enquiries produced in a discussion process; a discussion body information DB that stores all participants-in-discussion information for each discussion extracted from the member information DB, and a log information DB that stores a member log-in result by measuring participation for each of members registered in the member information DB.

The member information DB includes stakeholder information about specific organizations or groups; and individual member information about individuals such as a moderator, panels and audience members.

The discussion information DB includes basic discussion information for identifying each discussion; various discussion type classification information for the discussion; discussion rule information for defining all operating rules for the discussion; discussion prosecution information for recognition of prosecuting situation of the discussion; and discussion's subtopic information for classification for each discussion case.

The argument information including various argument information having discussion background information and all suggestions, counterarguments and enquiries produced in a discussion process; additional information such as various evaluation information and kick-out information; and background information 543 and kick-out 544.

The discussion body information DB includes essential registration information of stakeholders, panels and a moderator; and audience information for restricting selective visit or participation in the discussion, and the discussion body information DB stores information extracted from the member information DB by an operator, a moderator or stakeholders when the discussion is determined.

According to another aspect of the present invention, there is provided a method for Internet-based discussion that combines discussions of all participants-in-discussion having access via Internet to deduce a conclusion, the method comprising steps of: automatically connecting a terminal to a discussion managing server and sending a discussion body-specific menu screen to a terminal in response to an access request from all discussion participants; determining whether an operator is selected from a group consisting of an operator, a moderator, a stakeholder, a panel, an audience on the discussion body-specific menu screen sent to the terminal; when the operator is selected on the discussion body-specific menu screen, sending a discussion information registration screen to the terminal; inputting basic information such as a discussion period and a discussion title on the discussion information registration screen sent to the terminal to register the basic information in a discussion information DB; when the basic discussion information is registered, sending a discussion body information registration screen to the terminal; and designating the moderator on the discussion body information registration screen sent to the terminal to register the moderator in the discussion body information DB.

The method comprises steps of: when the moderator is selected on the discussion body-specific menu screen, sending a moderator menu screen for discussion body registration, discussion operating information registration, discussion subtopic registration, background information registration, argument screen, advocacy request review and moderator evaluation to the terminal; if the discussion operating information registration is selected on the moderator menu screen sent to the terminal, sending a discussion information registration screen to the terminal; inputting discussion operating information such as a discussion classification and a discussion field on the discussion information registration screen sent to the terminal to register the discussion operating information in the discussion information DB; and determining whether the discussion classification registered in the discussion information DB is a main discussion and inputting discussion classification information and discussion rule information when it is the main discussion to register the information in the discussion information DB.

The method comprises steps of: when the stakeholder is selected on the discussion body-specific menu screen, sending a discussion body information registration screen to the terminal; inputting a delegated panel on the discussion body information registration screen sent to the terminal to register the panel in the discussion body information D; when the delegated panel is registered, sending a requesting sentence production screen to the terminal; and producing a requesting sentence on the requesting sentence production screen sent to the terminal to register the requesting sentence in the argument information DB.

The method comprises steps of: when the panel is selected on the discussion body-specific menu screen, sending a panel menu screen for suggestion registration, counterargument registration, advocacy request, and reply acceptance to the terminal; when suggestion registration is selected on the panel menu screen sent to the terminal, determining whether a statement editor is installed; when the statement editor is not installed, automatically downloading the statement editor and executing the statement editor to send a statement editor screen to the terminal when the statement editor is installed; and inputting an argument on the statement editor screen sent to the terminal to register the argument in the argument information DB and automatically notifying all discussion participants and a related audience that the new argument is registered in the argument information DB via E-mail.

The method comprises steps of: when the audience is selected on the discussion body-specific menu screen, sending an audience menu screen for counterargument (enquiry), free argument suggestion, and advocacy request reply to the terminal; when the advocacy request reply is selected on the audience menu screen sent to the terminal, sending a discussion ping-pong situation screen to the terminal; selecting a reply object argument on the discussion ping-pong situation screen sent to the terminal to register an optional panel; when the optional panel is registered, sending a reply input screen to the terminal to perform closed-processing an input and then register an input processing result in the argument information DB; and notifying the input processing result registered in the argument information DB via E-mail and then processing argument screen.

The method further comprises a discussion result deduction step of processing a result of discussion ping-pong between all discussion participants and processing evaluation as suitability, conditional suitability, unsuitability or reservation on subject opinions (SOs). The discussion result deduction step comprises: a discussion ping-pong processing step of performing superiority and inferiority processing on a ping-pong result of the SA on which a counterargument is given up; an SO evaluation step of performing system evaluation processing on the SO, on which the discussion ping-pong processing step has performed the ping-pong result processing, as suitability, conditional suitability, unsuitability or reservation; a discussion closing step of closing the discussion upon discussion period termination and notifying a discussion termination notice via E-mail; a confrontation evaluation step of processing a ping-pong result on a confronted SO; and a suggestion evaluation step of checking SO evaluation information for each suggestion and processing system evaluation on the suggestion.

According to yet another aspect of the present invention, there is provided a method for Internet-based discussion that combines discussions of all participants-in-discussion having access via Internet to deduce a conclusion, the method comprising: a discussion preparation step including a discussion determination process of determining a subject of a discussion, a moderator, a stakeholder and an audience; a basic discussion data determination and conference process of determining a discussion period and discussion rules through conference and determining a panel for each stakeholder; an all participants-in-discussion registration process of first registering a moderator to perform the discussion by an operator of a discussion managing server and registering remaining all participants-in-discussion directly participating in the discussion by the registered moderator; a discussion operating information registration process of registering basic discussion data, discussion nature classification and background information; and a subtopic registration process of registering subtopics of the discussion and determining and registering a subject party for each subtopic; a discussion ping-pong step including a discussion initiation process of announcing a registration and guide message in a site on-going discussion list and notifying a discussion initiation notice via E-mail; a subject argument registration process of registering a subject argument (SA) and automatically notifying all discussion participants of a new argument registration notice via E-mail; an argument screen process of classifying and registering subject argument (SA) nature and notifying defect argument kicking-out via E-mail; and a counterargument registration process of registering a counterargument on the SA and automatically notifying all discussion participants of a counterargument registration notice via E-mail; a discussion evaluation step including a discussion ping-pong result processing step of performing superiority and inferiority processing as a result of ping-pong on the SA on which a counterargument is given up; and an SA evaluation step of performing system evaluation such as suitability, conditional suitability, unsuitability and reservation on the SA; and a discussion termination step including a discussion closing step of performing closing processing upon discussion period termination and notifying a discussion termination notice via E-mail; a ping-pong termination step of performing on-going ping-pong confrontation processing and confronted ping-pong SA evaluation processing; and a discussion evaluation step of performing suggestion system evaluation, subtopic evaluation, and all-discussion evaluation processing.

According to yet another aspect of the present invention, there is provided a method for Internet-based discussion that combines discussions of all participants-in-discussion having access via Internet to deduce a conclusion, the method comprising: a branch discussion step of prosecuting, by a few specific group, a discussion independently from a main discussion and reflecting a result in the main discussion when special knowledge is needed in a discussion prosecution process; and a counter discussion step of attempting discussion ping-pong on a specific case at a reversed position, the branch discussion step and the counter discussion step being included as sub-discussions dependent on the main discussion.

### BRIEF DESCRIPTION OF THE DRAWINGS

The foregoing and other objectives, features and advantages of the present invention will become more apparent from the following detailed description when taken in conjunction with the accompanying drawings in which:

FIG. 1 is a diagram summarizing problems of conventional discussion;

FIG. 2 illustrates an overall configuration of an Internet-based discussion system according to the present invention;

FIG. 3 illustrates an overall structure of an information table applied to the present invention;

FIG. 4 illustrates a detailed structure of an information table applied to the present invention;

FIG. 5 illustrates registering and building a discussion body information DB according to the present invention;

FIG. 6 is a flowchart showing an overall discussion procedure according to the present invention;

FIG. 7 illustrates a log-in and menu activation process according to the present invention;

FIG. 8 illustrates a discussion body-specific menu structure according to the present invention;

FIG. 9 illustrates registering and building a member information DB according to the present invention;

FIG. 10 illustrates an operator mode according to the present invention;

FIG. 11 illustrates a discussion operating information (moderator mode) registration process according to the present invention;

FIG. 12 illustrates a discussion body information registration process according to the present invention;

FIG. 13 illustrates a discussion subtopic information registration process according to the present invention;

FIG. 14 illustrates a background information registration process according to the present invention;

FIG. 15 illustrates an argument screen processing procedure according to the present invention;

FIG. 16 illustrates an advocacy request reviewing process according to the present invention;

FIG. 17 illustrates a moderator evaluation process according to the present invention;

FIG. 18 illustrates an advocacy request registration process according to the present invention;

FIG. 19 illustrates a suggestion registration process according to the present invention;

FIG. 20 illustrates a counterargument registration process according to the present invention;

FIG. 21 illustrates an advocacy request process according to the present invention;

FIG. 22 illustrates a reply acceptance process according to the present invention;

FIG. 23 illustrates an advocacy request reply process according to the present invention;

FIG. 24 illustrates a discussion ping-pong termination process according to the present invention;

FIG. 25 illustrates a SA evaluation process according to the present invention;

FIG. 26 illustrates a discussion closing process according to the present invention;

FIG. 27 illustrates a SA confrontation evaluation process according to the present invention;

FIG. 28 illustrates a suggestion evaluation process according to the present invention;

FIG. 29 illustrates a subtopic and discussion evaluation process according to the present invention;

FIG. 30 illustrates producing a subject argument evaluation rule according to the present invention;

FIG. 31 illustrates an evaluation portfolio with an evaluation factor according to the present invention;

FIG. 32 illustrates an overall process according to the present invention;

FIG. 33 illustrates an overall structure of an Internet-based discussion system according to the present invention;

FIG. 34 illustrates a screen representation of an argument object according to the present invention;

FIG. 35 illustrates a screen representation of a ping-pong situation on all discussions according to the present invention;

FIG. 36 illustrates a screen representation of a ping-pong situation on one SA according to the present invention;

FIG. 37 illustrates a screen structure of a statement editor (for argument structure registration) according to the present invention;

FIG. 38 illustrates discussion information classification according to the present invention;

FIG. 39 illustrates discussion prosecution according to the present invention;

FIG. 40 illustrates an argument structure according to the present invention;

FIG. 41 illustrates a suggestion ground structure according to the present invention;

FIG. 42 illustrates registration of discussion-with-proposition according to the present invention;

FIG. 43 illustrates association of counterarguments according to the present invention; and

FIG. 44 illustrates a document identification notation structure according to the present invention.

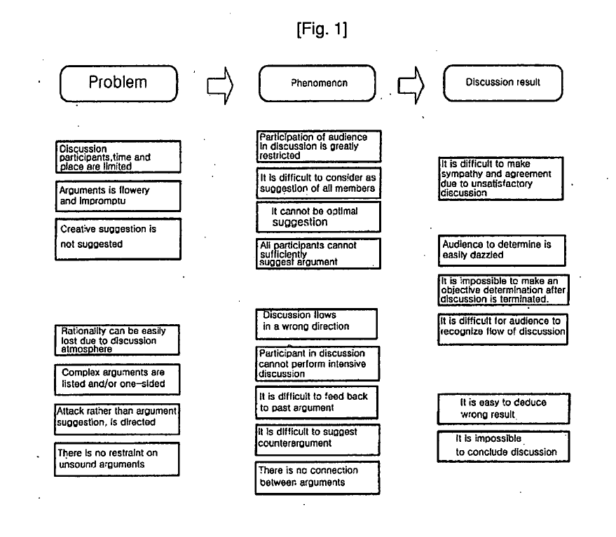

### BEST MODE FOR CARRYING OUT THE INVENTION

Reference will now be made in detail to the preferred embodiments of the present invention. In the following description of the present invention, a detailed description of known functions and configurations incorporated herein will be omitted when it may make the subject matter of the present invention rather unclear.

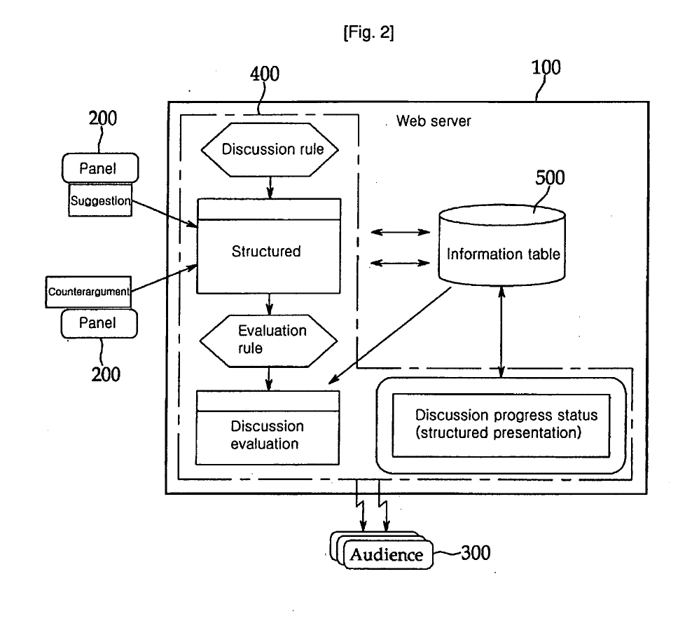

FIG. 2 illustrates an overall configuration of an Internet-based discussion system according to an exemplary embodiment of the present invention. The system includes a discussion managing server 100 for performing interactive argument ping-pong for each detailed point at issue of the subject of a discussion according to a certain rule predefined for each type of discussion by panels (including members) having access to the server via the Internet, deriving a conclusion by an evaluation rule defined depending on the nature of each argument and a ping-pong result, and registering and managing discussion information, discussion ping-pong information, and discussion result deduction information, as well as personal information of all discussion participants, in a database; a number of panel client terminals 200 (connected to the discussion managing server through the panel's operation) having a web browser enabling the panel to access the discussion managing server 100 via the Internet; and a number of audience client terminals 300 (connected to the discussion managing server through the audience's operation) for suggesting a free argument on a discussion ping-pong situation processed according to the discussion ping-pong between a number of the panels, asking a panel's argument or participating in the discussion ping-pong in response to a panel's advocacy request, and participating in a public argument poll. The advocacy request used herein refers to the act of a specific panel or stakeholder requesting aid from the audience when in difficulty to respond to an argument due to lack of special knowledge or information during ping-pong on a point at issue.

The discussion managing server 100 is composed of a web server 400 and an information table (database) 500. When each of client terminals 200 and 300 connects to the web server 400, the web server 400 downloads a main web site screen from the discussion system to the client terminal, enquires about and downloads a screen of a menu in an information table 500 in response to each of the client terminals 200 and 300 selecting a menu of a web site, and writes user input content to the information table 500. The information table 500 stores, updates, and manages data for providing an information screen and user-input data in response to the user selecting the menu on the main web site screen.

Examples of connections between the discussion managing server 100 and a number of panels and audience client terminals 200 and 300 include a wired Internet connection using a modem, a PSTN, a private line, or an ISDN; and a wireless Internet connection using a cellular, PCS, microwaves, or satellite communication network. Each of the client terminals 200 and 300 may be any type of terminal capable of connecting to a terminal network, including the Internet, using one of the connections.

Each of the client terminals 200 and 300 may be any type of PC or terminal as long as it has an Internet web browser that supports Internet access by a typical personal computer equipped with, for example, a Pentium microprocessor, a hard disk drive, a communication modem, a multimedia reading device, and the like. In addition, a workstation, a typical portable communication terminal (PCS and PHS), a personal digital assistant (PDA), a set-top box, a digital television, and a web phone may be used instead of a PC as long as they can connect to the Internet.

The information table 500 may be composed of a known relational data management system (RD BMS) such as Oracle, a Structured Query Language (SQL) server, or Informix.

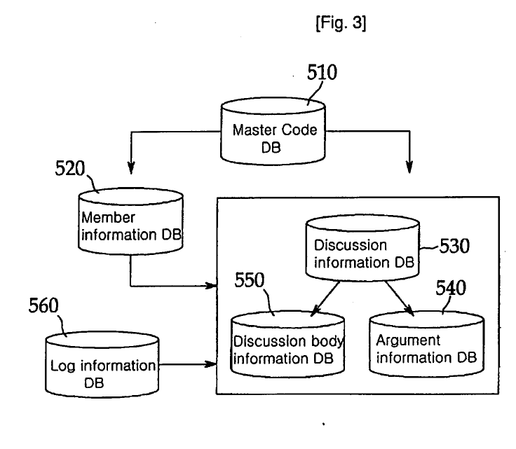

FIG. 3 illustrates a schematic structure of an information table applied to the present invention. The table comprises a master code information DB 510 for managing master code information (code table) including various classification information used in a system; a member information DB 520 for managing information about all members registered in the system (personal information about all members such as audience members, panel members, a moderator, and the like, and information about stakeholders such as organizations); a discussion information DB 530 that stores information about respective discussion objects such as classifications, rules, and prosecuting situation, as well as basic information such as a title of a discussion and a subtopic; an argument information DB 540 that stores argument information such as all suggestion grounds, counterarguments, and enquiries generated in a discussion process; a discussion body information DB 550 that stores information about all discussion participants extracted from the member information DB 520 (designating a moderator, panels, specified audience, and stakeholders participating in the discussion); and a logging information DB 560 that stores a member-specific system log-in result (referenced to select an audience poll by measuring each individual member's participation). The discussion body (all participants in the discussion) used herein collectively refers to a moderator, panels, stakeholders, audience, and the like, who participate in the discussion.

Suggestions, opinions, and arguments first put forth for each subtopic of the discussion are collectively called a suggestion. Each of multiple sub-arguments that form the ground of a suggestion is called a ground of suggestion. Further, a ground of suggestion is an object of a counterargument (discussion), and a suggestion is only a word representing a ground of suggestion, not the object of discussion. Fact, value, and proposal are collectively called a subject argument (SA), and a counterargument, an enquiry, a condition submission, and the like, first suggested for each SA, are collectively called an object argument (OA). In some exemplary embodiments, the term statement may be used instead of the term argument. That is, a subject statement or an object statement may be used instead of a subject argument or an object argument. Further, panels suggesting SA and OA are called a subject panel and an object panel, respectively.

In the case of a point at issue (or a detailed point at issue, i.e., thread), if a specific OA is suggested against a specific SA, it is said that a point at issue (thread) occurs. Accordingly, when n OAs are generated on a specific SA, n points at issue related to the specific SA are generated.

The master code information DB 510 indicates classification that is uniquely defined in advance so that sites operating this discussion system use it in common regardless of individual discussion. The master code information DB 510 is organized so that an operating person-in-charge (manager) optionally inputs code values of all code tables upon disposing a system. There is the following classification information:
Discussion field: society, politics, economy, culture, health, environment, education, etc.
Type of discussion: pro&con/solution discussion, one-to-one/multi-discussion, local/public discussion, opened/closed discussion, discussion-with-proposition/discussion-with-no-proposition, and free/panel discussion
Discussion classification: Main discussion, background discussion, branch discussion, counter discussion, and re-discussion

The counter discussion used herein refers to a discussion separately performed at a reversed position in the discussion such as the discussion-with-proposition in which one side suggests an alternative plan, a proposition, or a policy, and the other side presents a problem. Further, the branch discussion is determined in the discussion rule in advance with a time limit to register the counterargument. When a counterargument time limit has elapsed, discussion ping-pong on the point at issue is terminated.
Member information: Individuals (active participating members and normal members)/stakeholders
Member participation: argument suggestion, vote/jury, and access/enquiry
All discussion participants: Moderator, stakeholders, panel (delegated and optional), audience, etc.
Discussion's subtopic: Meaning (definition) of a case, problem or solution, cause or factor, and urgency of a case
Argument submission: subject argument (SA), object argument (OA), and counterargument (CA, object/subject)

As used herein, all ping-pongs generated when a ping-pong such as a further counterargument and a still further counterargument for each point at issue occurs are collectively called a counterargument. Arguments suggested by the subject panel and the object panel are called a subject counterargument and an object counterargument, respectively.
A Classification of suggestion
Ground structure: Independent and Dependent
Ground classification: Fact information, value (tone), and proposition
Suggestion of discussion-with-proposition (subtopic): Suggestion proposition, necessity suggestion, expected problem and alternative plan, case, etc.
Classification of counterargument
Counter argument: Active objection and negative objection
Condition submission: aggressive condition submission and defensive condition submission
Enquiry: question and counter-question
Moderator's first enquiry
Argument class: New argument, changed argument, redrawn argument, substitute argument, and supplemental argument
Argument kick-out: Defective argument, overlapping argument, meaningless argument, and parallel argument
A Evaluation classification
Ping-pong argument result: SA superiority, SA inferiority, and confrontation
Evaluation: Suitability, unsuitability, and evaluation reservation
Discussion status: discussion prosecution, discussion cancellation, discussion suspension, discussion closing, and discussion termination

A discussion-with-proposition refers a discussion focusing on any proposition or suggestion, and policy established by a specific stakeholder prior to initiating the discussion, and a discussion-with-no-proposition refers to a discussion in a situation having no proposition or policy.

[Discussion Class]

A. Pro&Con Discussion and a Solution Discussion: Classification Depending on Nature of a Discussion Point at Issue
Discussions may be classified into a pro&con discussion about a selection dispute in which there are pros, cons, and confrontation cases, and any one of the cases should be selected, and a solution discussion that yields a solution to all problems or requests various arguments, wherein discussion methods differ in part.
In the pro&con discussion, a dispute on a specific issue occurs regardless of stakeholders.
A number of issues occur in the solution discussion. Most solution discussions become multi-discussions, in which each stakeholder has his or her suggestion and if the suggestions include a different attack object, interests are divided. The solution discussion is a discussion that confirms the answer to the question “what is the problem?” and discusses possible answers to the question “what is the solution?” unlike the pro&con discussion. Accordingly, the solution discussion segments a subject and often leads to private discussions.
The pro&con discussion necessarily has an attack object in all arguments while the solution discussion may or may not have an attack object.

B. One-to-One Discussion and Multi-Discussion: Classification Depending on a Stakeholders' Confrontation Relationship
A one-to-one discussion refers to a discussion with confronted stakeholders being in one-to-one correspondence. The pro&con discussion is regarded as one-to-one discussion when several stakeholders are clearly divided into yes and no camps.
The multi-discussion refers to a discussion with a plurality of confronted stakeholders. In this case, a specific stakeholder or panel's argument may have one or a plurality of specified attack objects (attack object stakeholders).

C. Public Discussion and Private Discussion: Classification Depending on a Range (Area) of Discussion Participants
The discussion case may be classified into a public discussion having a discussion case in which unspecific persons are interested and a private discussion in which an interest relationship of a specific group is discussed.
The private discussion indicates that audience, panels, and stakeholders as well as a moderator belong to a specific enterprise or group. Specific stakeholders participating in a public discussion can perform a private discussion between stakeholders to reflect various internal arguments. In this case, the system opens a discussion only to discussion participants specified by stakeholders.

D. Open Debate and Closed Discussion: Classification Depending on Restriction of Discussion Participants
The discussion may be classified into an open debate that opens all contents of the discussion to the public and a closed discussion that opens it only to a specific discussion body. The closed discussion may be held in some cases of the open debate.

E. Free Discussion and Panel Discussion: Classification Depending on Whether the Participation Panel is Restricted or not
A discussion in which unspecific persons other than specific stakeholders or specific panels participate while reflecting various arguments is called a public discussion. A discussion mainly held by a specific, delegated panel is called a panel discussion.
The free discussion may be applied when the subject of issue is broad, when a solution cannot be found based on knowledge and argument of a few specific persons, or when a number of arguments are combined and controlled.
Discussion between netizens in a conventional typical web site may be called free discussion. That is, a discussion mainly performed by a panel, pre-delegated by stakeholders, is called a panel discussion. A discussion opened to the public so that all viewers freely participate in the discussion as panels, excluding a pre-delegated panel, is called a free discussion.

<Case of Free Discussion>

Subject: “Do young people of Korea and Japan have to enhance their awareness of each other's country for a future relationship as good neighbors?”

Participants: All university students in both Korea and Japan
The free discussion does not designate a panel in advance. A member is allowed to occasionally apply and register as a panel during the discussion and has the authority of a delegated panel. The free discussion does not designate stakeholders either. A person (or stakeholder) suggesting a specific argument or a counterargument thereto in the discussion is called a panel, a panel specified by a stakeholder in advance in the panel discussion is called a delegated panel, and a panel temporarily selected on a specific point at issue during the discussion in the panel discussion or discussion-with-no-proposition is called a temporary panel.
Since the public discussion does not designate a stakeholder, there is an object coping with a discussion result or a prosecuting situation directly and actively. This will generally not deduce a discussion conclusion since a discussion conclusion always results in optimal conclusion and a specific interest group whose interest relationship depends on the discussion result is not expressed. The discussion rule is optionally determined by the moderator.
Free discussion prosecution excluding a conclusion processing portion is similar to the panel discussion. Accordingly, most descriptions and definitions regarding this system are based on panel discussion, if not specifically mentioned.

F. Discussion-with-Proposition and Discussion-with-No-Proposition: Classification by a Discussion Prosecution Method
First stating a specific policy or a business program or proposition (hereinafter, “suggestion”) established by a specific stakeholder upon initiating a discussion, and then proceeding with the discussion focusing on the policy or program, is called a discussion-with-proposition. Arbitrarily suggesting an argument according to a detailed case of a discussion and counterarguing against the argument is called a discussion-with-no-proposition.
Preferably, most of the pro&con discussions proceed as the discussion-with-proposition. The solution discussion may be the discussion-with-proposition or may be executed in the form of the discussion-with-no-proposition.
When the subject of the discussion is concrete as a detailed case, the discussion is executed in the form of the discussion-with-proposition.
In the case of the discussion-with-no-proposition, the moderator should provide discussion background information prior to initiating the discussion, for the sake of systematic prosecution of the discussion, and should perform subtopic classification for the discussion for each detailed point-at-issue. On the other hand, in the case of the discussion-with-proposition, it is possible to omit discussion background information and subtopic classification since suggestion itself may be assumed to be arranged for each point at issue and discussion background information is expressed. The background information used herein is all information or facts provided prior to initiating the discussion to increase the efficiency of panels' discussion and allow the audience to understand discussion points at issue (focus). Term definitions, objective facts and information, problems, urgency and the like belong to the background information, which is provided directly or input by a moderator with the aid of specific stakeholders, and may be provided through background discussion, if necessary.

G. Background Discussion
When the moderator cannot provide apparent background information, a problem-recognition discussion to improve the efficiency of the main discussion can be performed. Further, in the case of the discussion where the moderator cannot provide background information by himself since the discussion range is very broad or special knowledge is required, like the solution discussion, a background discussion may be held to assist in problem recognition.

Subtopic of Background Discussion
The background discussion necessarily concerns only three background information items which are a problem, a cause, and urgency of solution, and the urgency of the solution and the cause may be discussed in the main discussion.

Procedure for Background Discussion
Even though the background discussion is dependent on the main discussion, it is one independent discussion and includes all processing procedures like the main discussion, to determine background information, in which if the evaluations are confronted, evaluation reservation is made and handed over to the main discussion.
Time limit of background discussion, subject setting, participation panel determination and the like are determined by agreement between the moderator and all discussion participants.

Succession of Background Discussion to the Main Discussion
The background discussion does not include re-discussion or branch discussion. When the background discussion does not result in conclusion, the registered argument is handed over as an argument of the main discussion and is expressed again in the main discussion.

Case Requiring Background Discussion: Discussion on Speech Reform in a Broadcasting Station (Two Hours)
While a citizen group suggesting a reform draft and a side objecting to the draft discussed for a long time by prosecuting the discussion in the state where the two sides agreement about detailed necessity of the speech reform (urgency of influence on society) is not confirmed during the entire discussion process, they cannot approach a core case about a reform method, resulting in useless discussion.

That is, the citizen group argued a drafted reform to build a committee of the Congress, citizen groups, journalists, readers and the like with the view that the speech reform is the most urgent case, while the objecting side believed that the reform should be gradual and in line with general societal reform.
The necessity of the speech reform is recognized by both sides but the degree of necessity is the subject of disagreement. Discussion prosecution having no confirmation of such a disagreement makes both sides' suggestions in parallel.

H. Counter Discussion
If one side makes only criticism without an alternative plan in discussion prosecution, opposite stakeholders may encounter a logically difficult situation. At this time, the effectiveness of an original draft is verified by performing the discussion with reversed positions, i.e., by the other side suggesting an alternative plan and the one side arguing against the plan.

Example) Dispute on the necessity of corporal punishment by a teacher (in this example, appropriateness of the content stated in this example is not discussed).
Everyone agrees that corporal punishment should be eliminated, if possible. Corporal punishment has been used for a long time in the world. Punishment for fault has been recognized as necessary evil for controlling a number of groups by preventing punishable actions from being repeated. However, teachers trouble is that there is no alternative to corporal punishment. Thus, if corporal punishment is prohibited, teachers will lose control, leading to greater problems in education.
In this case, the dispute centers on the question, “Is there a control means (punishment) other than corporal punishment?” not “the necessity and reason of corporal punishment?” Further, the prosecution method is performed with positions reversed. That is, the corporal punishment opponent suggests an alternative to corporal punishment while the teacher argues against the suggested alternative.
Agreement is achieved by making corporal punishment opponents realize through the discussion that there is no viable alternative to corporal punishment, convincing them not to deny it, and discussing a corporal punishment method (degree) or a corporal punishment time point.

Holding the Counter Discussion
Counter discussion is necessary only on a counter-argued, specific suggestion (SA), not the overall discussion.
The counter discussion can be suggested only by a panel (or stakeholder) registering the argument and can be performed when the moderator accepts the suggestion.
The moderator inputs details and purport of the counter discussion. The system automatically notifies all the discussion bodes of the details and purport of the counter discussion via E-mail. The details and purport of the counter discussion should be preserved as prosecution information for a discussion associated with the counter discussion.
If the counter discussion is determined, the moderator creates counter content of the SA as a new subtopic or new subject argument and should specify the subject panel in a reverse manner. Further, the system classifies presentation of the counter discussion differently from an original argument presentation.
If a further counterargument is not suggested by the time a suitable counterargument is suggested against a correspondent's subject arguments at a reversed position after the counter discussion, and then the further counterargument time limit ends, an initial subject argument is terminated with suitable evaluation by the moderator.

(In the example, if any alternative plan for corporal punishment suggested by a corporal punishment opponent is properly shown to be ineffective as a control means, the necessity for corporal punishment is accepted.)

The counterargument time limit used herein refers to a time limit by which a counterargument is to be registered and is determined in the discussion rules in advance. If the counterargument time limit lapses, discussion ping-pong about a point at issue is terminated.
Counter discussion is an effective proposition for blocking pre-modern and non-productive, inevitable political behavior that originally blocks the second best decision-making selection and builds a logical barrier by offering only logical objection and no alternative plan, which will be the core factor for the utility of this system.

I. Re-Discussion
Re-discussion refers to re-discussing an issue for which discussion evaluation is reserved.
Re-discussion is suggested by agreement between all stakeholders.
Panel change: the panel may be changed and registered upon re-discussion.
If the re-discussion begins, the system carries over all arguments handled in the main discussion as they are.
In the re-discussion, various discussion rules, subtopic classification, and the like are handed over as they are. Subtopics may be added by the moderator, if necessary.

J. Closed Discussion
Closed discussion may be held in the case where all arguments in a discussion process should be especially open only to specific participants.
The closed discussion is initiated in response to a stakeholder's request and a moderator's determination.
The system should prevent discussion details from being exposed by storing all discussion information using a special encryption scheme (encoding and decoding), and have a function of controlling access to a site using a password.
Audience members in the closed discussion must be directly registered by a moderator through a private approval procedure based on off-line processing independent from the system.
The closed discussion is a private discussion and becomes a branch discussion when dealing with specific subject arguments.

K. Branch Discussion
Branch discussion refers to separate discussion performed by a discussion body, such as a panel and stakeholders, which is changed due to a specialized and technical problem associated with a specific case occurring during the discussion.
Conclusion of the branch discussion is automatically registered as background information of the main discussion.

Example of the Branch Discussion
When production, sales, and material departments in a factory perform discussion on “appropriate stock and delivery,” they perform a separate discussion with the staff of a business enterprise as new stakeholders and panels on an issue of “cooperation with the business enterprise” that delivers materials.

Processing the Branch Discussion
Branch discussion is initiated in response to a panel or stakeholder's recommendation and a moderator's determination.
The branch discussion is treated as a new discussion with changed panel and stakeholders.
The branch discussion is regarded as an independent discussion. A main discussion maintains information for association with the branch discussion, and screen presentation is treated as subtopic classification of the main discussion.
If the branch discussion begins, a moderator “reserves” all discussions on a case causing the branch discussion (suggestion, ground of suggestion, counterargument, etc.) by the time the branch discussion is terminated.

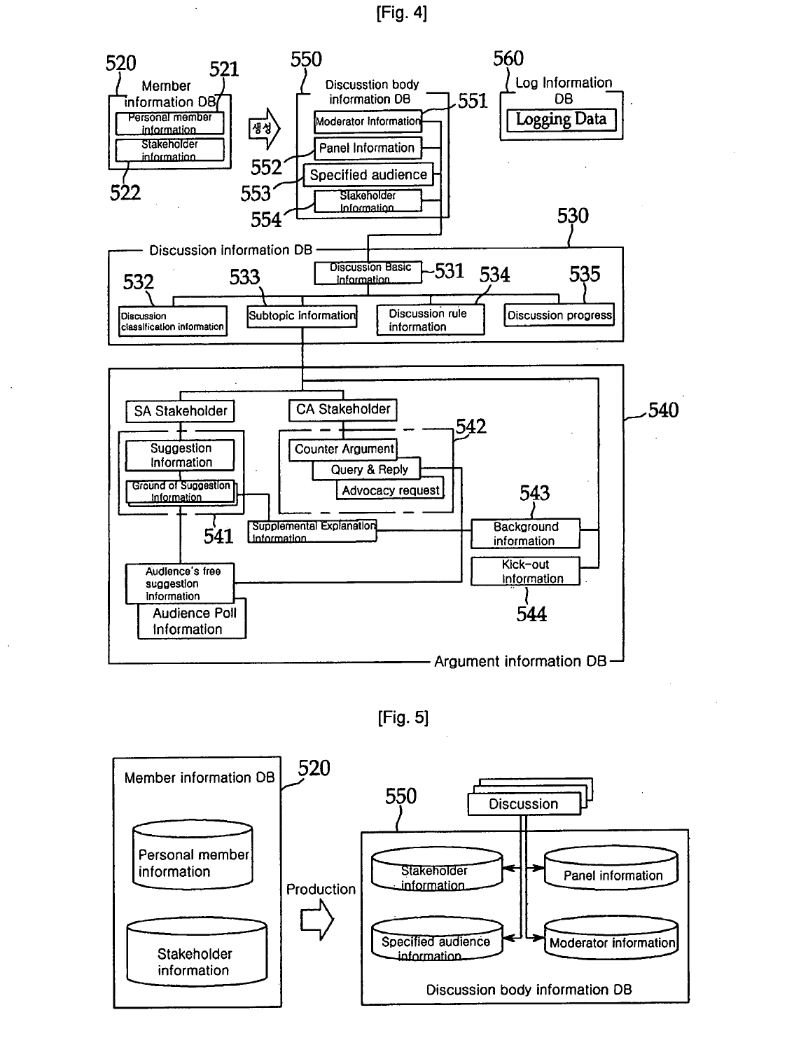

FIG. 4 illustrates a detailed structure of an information table applied to the present invention.

A member information DB 520 provides a function of creating a database by directly loading an external file (personage file in an enterprise) in the case of a private discussion having a database for an organization member. In the case of a public discussion, the member information DB 520 allows a member to directly create a database through on-line registration. The member information DB 520 is composed of stakeholder information 522 which is information about a specific organization or group; and individual member information 521 which is information about individuals such as a moderator, panel members, and audience members. Since the information has a different nature, they are physically divided into two.

The individual member information 521 includes basic history information including ID, password, resident registration number, occupation, department, position, name, contact information (E-mail and telephone number), last scholarship and registration date; and personal career information having up to ten personal careers (important careers). The individual member is classification information for measuring a member's discussion participation capability using discussion participation log information. The individual members are classified into audience (pure audience or members not experienced as panels or jurymen/voters), active participants (widely experienced as active voters/jurymen or panels), and normal participants (do not reach the level of active participants among the members experienced as voters/jurymen or panel members).

The widely experienced, active participant is defined in initial site information for each site, and a discussion participation result of each individual is read out from the log information DB 560 having discussion information stored therein. The stakeholder information 522 stores ID, stakeholder name, stakeholder classification, advocacy request number, and <person-in-charge information-n>. The <person-in-charge information-n> has memberid-n, person-in-charge name-n, position-n, business-in-charge-n, and contact information-n. The stakeholders will refer to organization classification such as a department or a business department within specific enterprises or groups, or comprehensive classification such as an enterprise and group in portal sites serving unspecific persons. Accordingly, the system is designed so that users classify and use stakeholder classification as they desire.

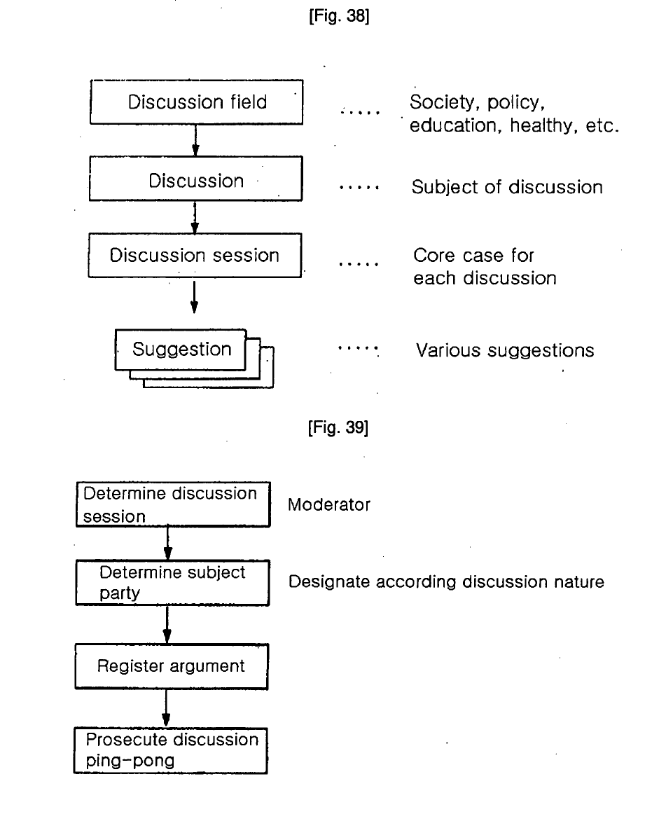

The discussion information DB 530 is composed of basic discussion information 531 for identifying a discussion, various discussion classification information 532 of the discussion, discussion rule information 534 defining overall rules of the discussion, discussion prosecution information 535, and subtopic information 533. The discussion rule information used herein is input after stakeholders and a moderator agree with each other regarding a rule about discussion prosecution prior to the discussion, the discussion rule conforming to items defined in the system in advance.
Discussion information classification is divided into three stages, formed, and managed as in FIG. 38. The classification is assigned to and performed by a site operator and a discussion moderator. To this end, the system provides a function for classification in the form of a tree, like Microsoft Windows Explorer.

First step: issue category—society, politics, education, health, etc.

Second step: subject of issue—discussion list

Third step: a subtopic of discussion (suggestion classification)—classification of some core case suggestions for each discussion.
The first step classification input is first performed by a site operator when a site is opened, and the second and third step classification inputs are performed by a moderator in a different manner for each discussion.

The basic discussion information 531 contains basic discussion information related to all discussions, such as a discussion ID, a discussion title, a discussion classification, and a discussion period. The basic discussion information 531 further contains discussion classification information, such as a main discussion, a background information discussion, a branch discussion, a counter discussion, and a re-discussion. The branch discussion, the counter discussion, the re-discussion and the background information discussion, not the main discussion, are accompanied with basic information (discussion ID) of the main discussion. The discussion period is composed of a discussion period determined when the discussion begins, and a substantial discussion period extended to a counterargument time limit.

The discussion classification information 532 contains discussion type information such as pro&con/solution discussion, local/public discussion, public/closed discussion; and classification information relating to a discussion field such as society, politics, economics, health, etc.

The discussion rule information 534 defines argument a submission time limit, a counterargument/reply time limit, an additional argument closing time limit, and a background information counterargument time limit in days. The discussion rule information 534 also defines closed argument argument acceptance, audience free argument acceptance, counter-argument audience vote, sanction to a kicked-out argument, evaluation reservation as yes/no. In addition, the discussion rule information 534 defines an argument modification allowed number as a maximum number of changes allowed for each argument plus a total allowed change number.

The discussion prosecution information 535 contains information providing discussion prosecution situations such as a subject argument (SA) number, a rebutted SA number, an evaluated SA number, a suitability evaluation SA number, a kicked-out argument number, and discussion status. This information is provided to the audience as a menu of “discussion status information” for each discussion. A subject argument (SA) rebutted but not rebutted again is called a rebutted SA. Discussion prosecution, discussion cancellation, discussion suspension, discussion closing, discussion termination, and the like are collectively called a discussion status.

The discussion subtopic information 533 contains subtopic ID, discussion ID, subtopic, subtopic classification, subject party, and subject party designation date. The subtopic classification is made at random for each discussion case or in the following manner:
Problem & solution: This may be substituted by necessity or an effect depending on a discussion case.
Cause and factor: This indicates a cause and factor of the problem.
Meaning and definition of various cases: This defines the meaning and definition of the core content of a case.
Urgency of case: This indicates a core case that tends to be generally ignored in many conventional discussions but on which success or failure of the discussion depends. Two factors of importance and time limit should be always considered. The time limit may be represented by a specific condition or circumstance in a certain period.

Objects participating in the discussion will be specific stakeholders (organizations) or individuals. Since they may be panel members or audience members depending on the discussion, all discussion bodies, excluding the audience, are defined depending on the discussion in advance. All the discussion bodies such as stakeholders, panel, and audience are collectively registered in the member information regardless of a specific discussion in advance, to thereby form basic information allowing registration for each discussion.

The argument information DB 540 stores argument information such as all suggestion grounds, counterarguments, and enquiries produced in the discussion process. The argument information collectively refers to discussion background information, various arguments 541 and 542 including all arguments s, counterarguments, and enquiries produced in the discussion process, and additional data such as various evaluation information and kicking-out information. The information excluding the background information 543 and kick-out argument information 544 is logically produced and managed for each subtopic of the discussion and for each stakeholder.
The argument information is produced for each subtopic of the discussion. The argument information is classified into initial SA information of subject stakeholders and other CA information. Audience's free-argument information and poll information, as well as the evaluation data, may be added to the initial argument information of the SA stakeholders. All arguments may include supplemental explanatory information.
The background information and kick-out argument information are not generated for each stakeholder.
One subtopic includes a plurality of SA stakeholders. One SA stakeholder includes a plurality of SAs. However, there is only one CA stakeholders for one SA.

The argument information is classified depending on the type of argument and generated in a different manner, as follows:

1. Suggestion information: Suggestion ID, suggesting person, date, attack object, counterargument, evaluation situation, evaluation date, discussion ID, subtopic ID, and suggestion.
The suggesting person indicates a stakeholder and a panel.
The counterargument indicates whether one of relevant SAs is rebutted.
The attack object indicates a stakeholder who should rebut the suggestion.

2. Ground of suggestion information indicates suggestion ID, ground of suggestion ID, suggesting person, date, attack object, ground requirement, ground structure, ground classification, counterargument, object arg-ID, argument content, ping-pong result, evaluation information, and evaluation date.
Ping-pong result indicates superiority, inferiority, and confrontation
   Evaluation information indicates suitability, conditional suitability, unsuitability, and evaluation reservation

3. Counterargument and further counterargument: arg-id, counterarguing person, date, classification, counterargument classification, further counterargument, counterargument object SA Arg-id, CA content, and counterargument time limit
Classification: SA, OA classification (indicates whether it is counterargument against SA or counterargument against OA)

4. Enquiry: Arg-id, enquiring person, date, classification, enquiry classification, reply or non-reply, enquiry object Arg-id, and enquiry details
Classification: SA and CA classification (indicating whether it is an enquiry to SA or CA)
Enquiry classification: counter-question and question

5. Reply: Arg-id, responding person, reply date, classification, reply classification, blank, relevant enquiry Arg-id, and reply details
Classification: SA and CA classification (whether it is a reply on SA or CA)

6. Advocacy request: Arg-id, classification, advocacy request classification, advocacy request sentence, and advocacy request time limit (effective time limit)

7. Supplemental explanation: Arg-id, relevant Arg-id, relevant word connection information, and supplemental explanation details

8. Background information: Arg-id, subtopic ID, registration classification, construction item classification, registration date, and background information details

9. Kick-out: kicked-out date, kicked-out reason, and kicked-out argument information
The suggestion information and ground of suggestion information are collectively referred to as SA information, and the counterargument, enquiry and reply are collectively referred to as CA information. In the present invention, all arguments are conceptually represented as separate information, but may be integrated in an actual detailed design process. Further, SA stakeholders and CA stakeholders may be integrated.
All the arguments may contain tag information for supplemental explanation. It further contains information associated with the supplemental explanatory information of Item 7.

The discussion body information DB 550 stores and preserves information about a discussion body participating in the discussion, and created from the member information DB 520 and registered when the moderator makes discussion determination, as shown in FIG. 5. Information on the discussion body for each discussion is defined to maintain information on the discussion body (excluding the audience) substantially participating in the discussion, which is called discussion body information. The discussion body information includes three items of essential registration information 551 to 553 relating to a stakeholder, a panel and a moderator, and specified audience information 554 that can be selectively defined. Since the personal information is variable, personal information at the time of discussion is preserved as the discussion body information.

The discussion body information is extracted and registered from the member information, as follows:
[Discussion body information]=[Discussion information+Discussion body information],

where, [discussion body information] refers to moderator, panel, stakeholders, and specified audience

Discussion information; discussion ID, discussion title, discussion period, and discussion classification information

The discussion body information; depending on the discussion body,
Moderator information: basic history information+<Personal Career>
Stakeholder information: basic data+<person-in-charge information>
Panel information: basic history information+<Personal Career>+a relevant stakeholder ID
Specified audience information: panel name and basic history information
   Person-in-charge information: persons-in-charge belonging to a stakeholder organization
   < >: notation indicating repetition of a plurality of information

<Classification of all Discussion Participants>
Moderator: he or she directs a discussion, provides background information, collects a panel, screens all arguments, and performs a conclusion task. Screening the argument used herein refers to the moderator screening and kicking-out out a defective argument, a meaningless argument, and the like, with respect to all arguments such as a suggestion, a counterargument, and a further counterargument, and performs inputting based on argument classification predefined in the system with respect to the SA and OA.
Panel: a person that suggests an argument and a counterargument. The panel is pre-delegated by a stakeholder or a supporter of stakeholders. The panel may be classified into registered delegated panels and optional panels who are optionally registered during the discussion.
Audience members: all registration or non-registered visitors who visit a site are collectively called an audience. A pre-registered audience member is called simply a member. The member serves as a juryman through vote when a suggestion is evaluated and may be an optional panel.
   A moderator, panel, and stakeholder are registered as information dependent on the discussion, i.e., specified for each discussion, but the audience is not specified for each discussion.
   The moderator, panel, and stakeholder are pre-registered as members, in which the individual information is recorded in the member information.
   Specified member and specified juryman (Hereinafter, “specified audience”):

In a closed discussion or private discussion, or on a nature of discussion, audience may be especially constrained or voting juryman may be constrained depending on stakeholders intentions. They are called a specified member and specified juryman, respectively. The specified member or specified juryman is specified by agreement between the stakeholders and the moderator for each discussion in advance (prior to initiating the discussion).
Stakeholder (party): The stakeholder refers to a group or organization directly or indirectly affected by the discussion result. The stakeholder may be the direct panel.

<Role of all Discussion Participants>

Audience Members
The audience indicates all discussion participants. Non-members as well as all members and all discussion participants are audience in a broad meaning.
The member performs voting for a value and may participate in a discussion as a panel and suggest free arguments, including enquiries, to the panel.
A member to participate in a discussion as a panel should necessarily join as the panel prior to suggesting his or her argument.

Panel
The panel refers to discussion participants for suggesting various arguments such as various suggestions, enquiries, and counterarguments.
A stakeholder designates a delegated panel in balance to perform the discussion prior to initiating the discussion. That is, the delegated panel is designated and input by the stakeholders.
The panel designates supporting stakeholders as well as basic real name information such as occupation, sex, and age. A delegated panel is not able to submit a neutral or hostile argument to the delegating stakeholders
The panel allows for requesting an additionally delegated panel and registering a real name during the discussion, in addition to a previously delegated panel.
The moderator is able to temporally designate a panel during the discussion in response to a member's request. This is called an optional panel, and participation of the optional panel in the discussion is restricted to an argument in which the optional panel has registered. That is, the optional panel is able to rebut only on a counterargument on his or her argument and is not able to rebut another panel's argument except for a question.

Moderator
The moderator initiates the discussion and determines all participants in the discussion
The moderator determines a discussion prosecution method and rules through a conference with each stakeholder
The moderator inputs basic discussion information and rule information
The moderator makes points at issue as background information
The moderator performs prosecuting, controlling and terminating the discussion through a conference with stakeholders
The moderator analyzes each argument of discussion participants, screens logicality of a suggested argument or suitability of representation screen, and performs argument kicking-out through a conference with an argument suggesting person (See argument screen)
The moderator structuralizes an argument suggested when receiving an unstructured argument
The moderator examines and determines a counter discussion and a branch discussion
The moderator votes on a highly confronted value and arranges the result
The moderator performs discussion evaluation

Stakeholder
The stakeholder designates a delegated panel
The stakeholder determines a discussion prosecution method and a rule through a conference with a moderator
The stakeholder requests to extend a discussion time limit and a counterargument time limit

For the two following purposes, three result information of all members argument suggestion, vote/jury, and access/enquiry are recorded and managed in the log information DB 560.

\textcircled{1} Discussion participation: logging information for measuring discussion participation (interest) of individual members such as all panels and audience is collected, analyzed and acquired.

\textcircled{2} Recording and conserving a discussion prosecution process:

Information such as transactor information, processing time, processing type, and processing content is recorded and managed as a generation ground of various discussion information such as all arguments and counterarguments with respect to all arguments that newly input, changed and deleted (canceled) within a discussion period for each panel.
Since whether to determine members discussion participation with any criterion by feeding the three result information back may be affected by nature of the discussion, system operator's point of view, or situation, this system does not cover it and allows an operator to process it optionally.

Hereinafter, the system and method for Internet-based discussion constructed as above will be described.

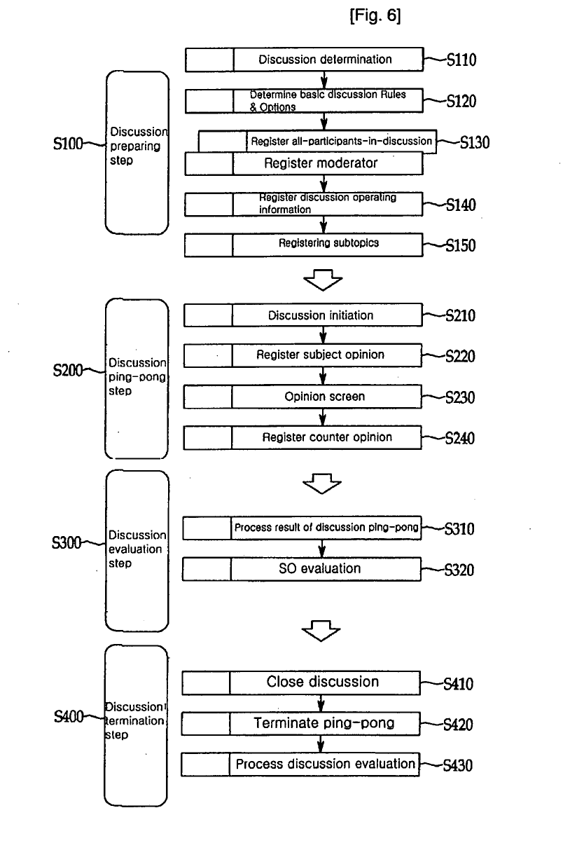

FIG. 6 is an overall flowchart showing a discussion procedure according to the present invention. The discussion procedure includes a discussion preparing step (S100), a discussion ping-pong step (S200), a discussion evaluating step (S300) and a discussion terminating step (S400).

The discussion preparing step (S100) includes a discussion determination process (S110) of determining a subject of a discussion, a moderator, a stakeholder and an audience; a basic discussion data determination and conference process (S120) of determining a discussion period and discussion rules through conference and determining a panel for each stakeholder; an all participants-in-discussion registration process (S130) of first registering a moderator to perform the discussion by an operator of a discussion managing server and registering remaining all participants-in-discussion directly participating in the discussion by the registered moderator; a discussion operating information registration process (S140) of registering basic discussion data, discussion nature classification and background information; and a subtopic registration process (S150) of registering subtopics of the discussion and determining and registering a subject party for each subtopic.

The discussion ping-pong step (S200) includes a discussion initiation process (S210) of announcing a registration and guide message in a site on-going discussion list and notifying a discussion initiation notice via E-mail; a subject statement registration process (S220) of registering a subject statement (SO) and automatically notifying all discussion participants of a new statement registration notice via E-mail; a statement screen process (S230) of classifying and registering subject statement (SO) nature and notifying defective statement kicking-out via E-mail; and a counterargument registration process (S240) of registering a counterargument on the SO (objection, condition submission, enquiry and the like) and automatically notifying all discussion participants of a counterargument registration notice via E-mail.

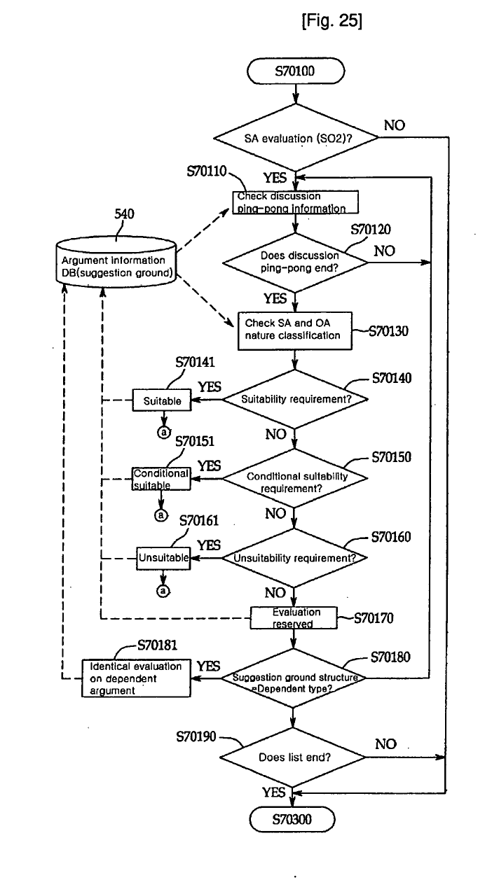

The discussion evaluation step (S300) includes a discussion ping-pong result processing process (S310) of performing superiority and inferiority processing as a result of ping-pong on the SO on which a counterargument is given up; and an SO evaluation process (S320) of performing system evaluation such as suitability, conditional suitability, unsuitability and reservation on the SO (see FIG. 25).

The discussion termination step (S400) includes a discussion closing process (S410) of performing closing processing (additional statement registration prevention) upon discussion period termination and notifying on a discussion termination notice via E-mail; a ping-pong termination process (S420) of performing on-going ping-pong confrontation processing and confronted ping-pong SO evaluation processing; and a discussion evaluation process (S430) of performing suggestion system evaluation, subtopic evaluation, and all-discussion evaluation processing.

Log-in operation of the present invention in which the overall discussion procedure is performed as described above will be described.

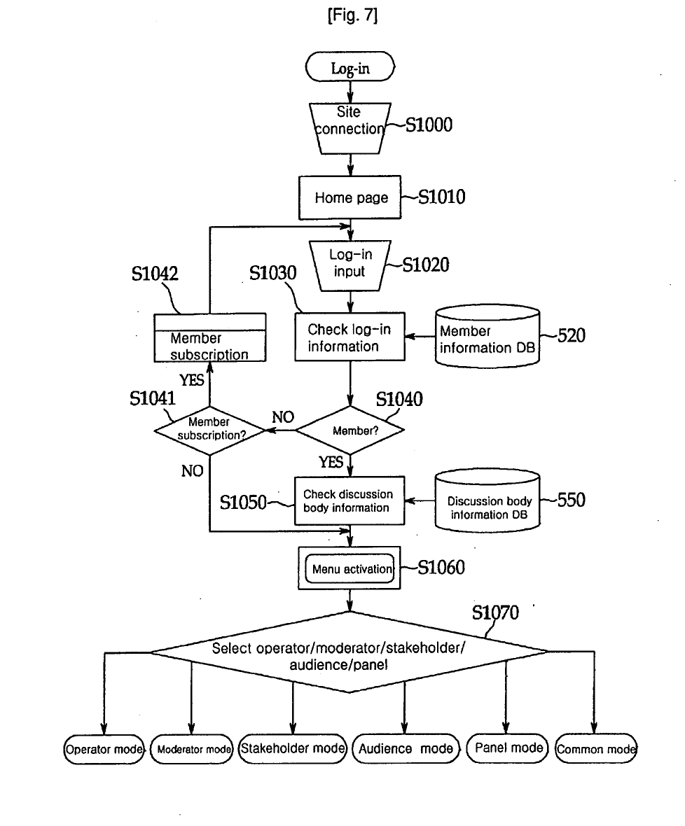

FIG. 7 illustrates a log-in and menu activation process according to the present invention

It is assumed that the discussion managing server 100 of the present invention has a master code information DB 510 and a member information DB 520 as basic system information, and discussion body information DB 550 and a discussion information DB 530 as discussion registration information. Information registration in the DB will be described later.

First, a user (member or non-member) has access to a web site of a discussion managing server 100 as a service provider via Internet (including a network) using his or her terminal (S1000 and S1010).

The discussion managing server 100 determines whether a user having access via the Internet is a registered member and inputs the member number to a member number input section on a web browser through a terminal (e.g., keyboard) if the user is the registration member (YES), and the input member number information is sent to the discussion managing server 100 (S1020 to S1040).

If the user is not the registered member (NO), the user is subscribed as a member by registering member information (basic information such as name, member ID, password, address, age, occupation, educational background, and marriage) according to a given subscription procedure prior to initiating the discussion, and the member information is registered in the member information DB 520 of the discussion managing server 100 (S1041 to S1042).

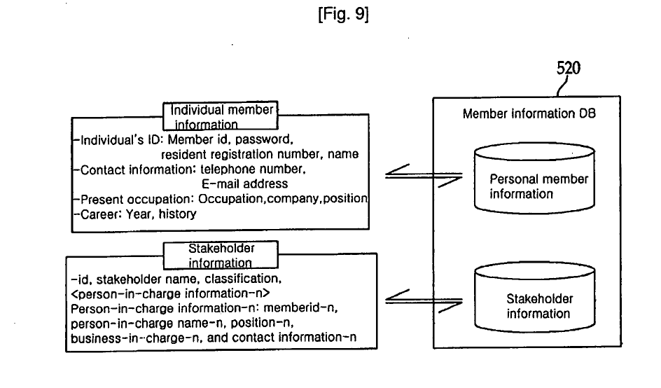

The member information registration in the member information DB 520 is summarized in FIG. 9.
Member information may be classified into personal member information 521 and stakeholder information 522, and is master code information for producing discussion body information for each discussion. The member information is registered and maintained by the member regardless of the discussion, and opened main information should be verified by the moderator or operator.

Registering Personal Member Information
This is personal information such as moderator, panel, and registered member.
Member ID and password in the individual member information can be occasionally changed by individual.
At most ten personal careers can be registered. The moderator or operator should necessarily verify the career to open it to the public.
If a discussion body such as the moderator and the panel is determined, the moderator or operator should necessarily verify the personal information.

Registering Stakeholder Information
The person in charge is a representative of stakeholders for performing a discussion with the moderator. The person in charge should be an individual member necessarily belonging to the stakeholders. The person-in-charge is extracted from the individual member information.
All persons in charge contributing to a discussion participation result are recorded in the stakeholder information, and a person in charge participating in the discussion as the representative is recorded in the discussion body and the stakeholder information.

If the member number is input via the terminal after the member information is registered in the member information DB 520 as described above, the discussion managing server 100 compares the member number from the terminal to the number stored in the member information DB 520 to determine whether they match each other (S1040).

If the member numbers match (YES), the discussion managing server 100 checks discussion body information in the discussion body information DB 550 (S1050).

In this case, the discussion body information in the discussion body information DB 550 is differently registered for each discussion body or according to the member classification, and a menu screen such as operator/moderator/stakeholders/audience/panel is sent to the user terminal (S1060).

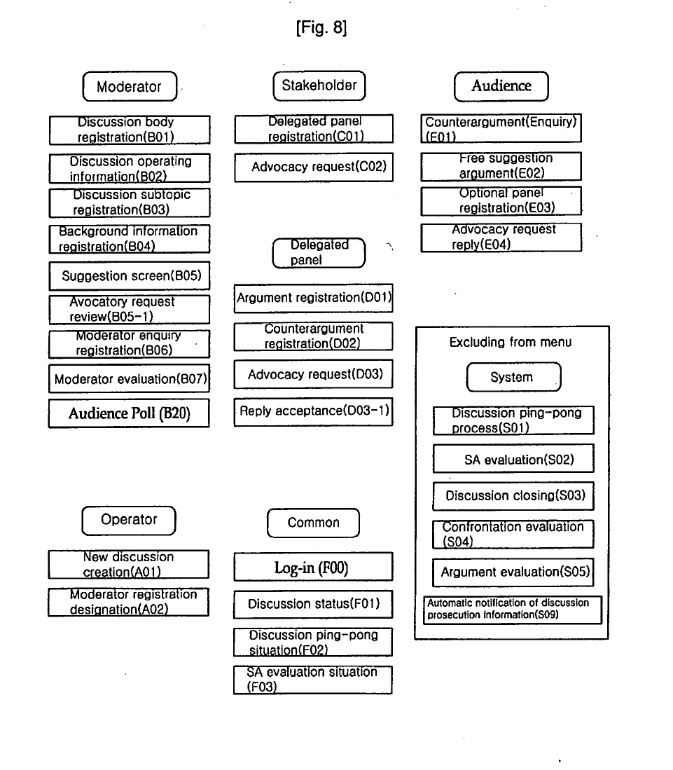

When a user logs in, only a corresponding menu in the menu screen, with the discussion body automatically classified into “operator”, “moderator”, “stakeholders”, “audience” and “panel” as shown in FIG. 8, is activated for each discussion body. When the user is not subscribed as a member, various outputs and enquiries [common mode F] are provided to all discussion bodies and accessing persons in common (S1070).

Further, as shown in FIG. 8, the system-processed system modes (S01 to S09) are not activated as a menu screen on a user terminal but internally processed.

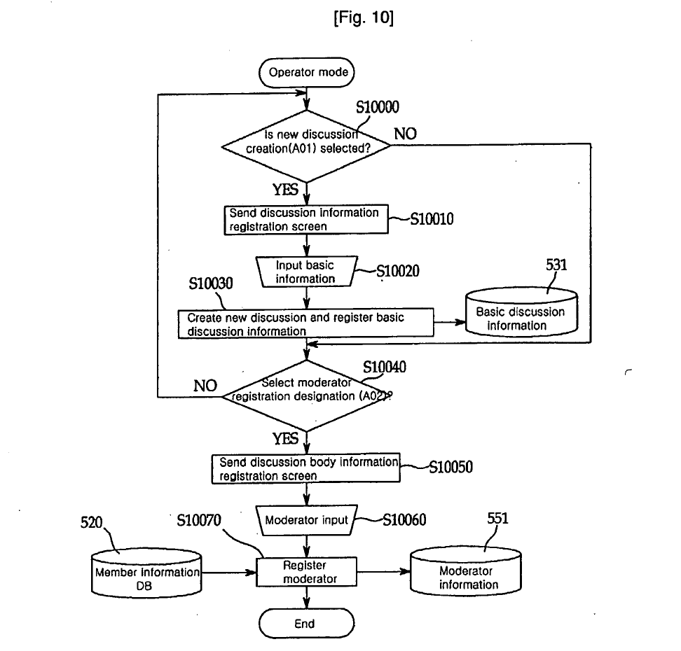

Next, processing operation when a user having access to the web site is an operator (A mode) will be described with reference to FIG. 10.

If a new discussion producing mode A01 is selected, the process sends a discussion information registration screen to a terminal so that the operator inputs basic information such as a discussion period and a discussion title, and the operator-input basic information is registered in the basic discussion information 531 of the discussion information DB 530 (S10000 to S10030).

When a moderator registration designation mode (A02) is selected, the process sends a discussion body information registration screen to the terminal so that the operator designates and inputs the moderator, and the operator-input moderator is registered in the moderator information 551 of the discussion body information DB 550 (S10040 to S10070).

The discussion body information registration in the discussion body information DB 550 is summarized as follows:
Discussion body: person-in-charge information in the stakeholder information can be registered. When the information is registered, it means common representatives for the discussion.
The discussion body information includes a moderator, a stakeholder, a panel, and a specified audience, who directly participate in the discussion. The operator produces a new discussion and registers the moderator. The registered moderator registers a remaining discussion body. All discussion body personal information is extracted from the member information. Only moderator information, not panel discussion is registered.
   Registration information: [Discussion body information]=[Discussion information+Discussion body information]

where, [Discussion body information]: moderator, panel, stakeholder, and specified audience

[Discussion information]: discussion ID, discussion title, discussion period, and discussion classification information

[Discussion body information]: depending on the discussion body,
Moderator information: basic history information+<Personal Career>
Stakeholder information: basic data+<person-in-charge information>
Panel information: basic history information+<Personal Career>
Specified audience information: panel name and basic history information

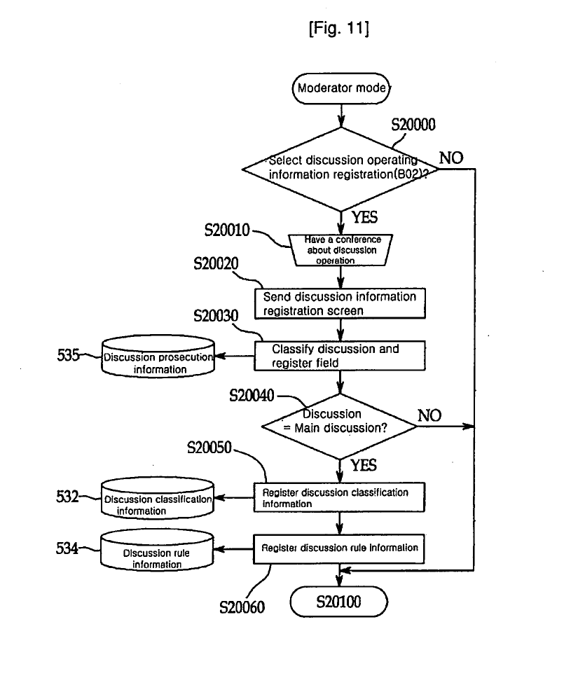

Processing when a user having access to a web site is in a moderator B mode will be now described with reference to FIGS. 11 to 17.

(1) Operation when discussion operating information registration (B02) in a moderator mode (B mode) is selected will be described with reference to FIG. 11. After a discussion rule is agreed, the process sends a discussion information registration screen to a terminal so that the moderator inputs discussion operating information such as discussion classification and discussion field, the moderator-input discussion operating information is registered in a discussion prosecution information 535 of a discussion information DB 530 (S20000 to S20030).

If the moderator-input discussion classification is a main discussion, input information is registered in the discussion classification information 532 and the discussion rule information 534 of the discussion information DB 530 (S20040 to S20060).

The discussion information registration of the discussion information DB 530 is summarized as follows:
The discussion information is divided and produced as \textcircled{1} information to be basically registered when the discussion is determined (basic discussion information) and \textcircled{2} information to be registered by the moderator having a conference in a stakeholder (discussion operating information).
The basic discussion information refers to information such as the subject of issue, initiation date and closing date, discussion classification, discussion category, etc.
   Discussion classification: Main discussion, background information discussion, branch discussion, counter discussion, re-discussion, etc.
The discussion operating information refers to the following information:
   Discussion rule information
   Discussion classification information: discussion class, nature, etc.
   Subtopic of discussion (optional) information
   A Background information: a problem causing discussion (optional; registered by a specific stakeholder)

Determining a Discussion Operating Rule
In all discussions, all rules relating to discussion-operation such as counterargument time limit, argument modification allowed number, and appropriateness evaluation are determined based on agreement between the moderator and the panel.
If a discussion rule is determined, the moderator inputs discussion rule information according to discussion rule information input form provided by the system.
The discussion rule may be changed by agreement between the moderator and the stakeholder on occasion during discussion.

Class of Discussion Rule
Discussion type determination: Private/opened discussion and public/private discussion
Discussion period and argument submission time limit: Discussion period and suggestion submission time limit, counterargument/reply time limit, and additional suggestion closing time limit
Background information counterargument time limit: This can be set differently from a counterargument time limit on SA.
Closed argument adaptation: an argument registered by an argument submission time limit is closed.
Audience's free argument acceptance.
Advocacy request allowed number and advocacy request closing time limit.
Audience vote of counter-argument
Sanction of kicking-out argument
Argument modification allowed number (the same argument modification number and total change number)
Moderator evaluation reservation

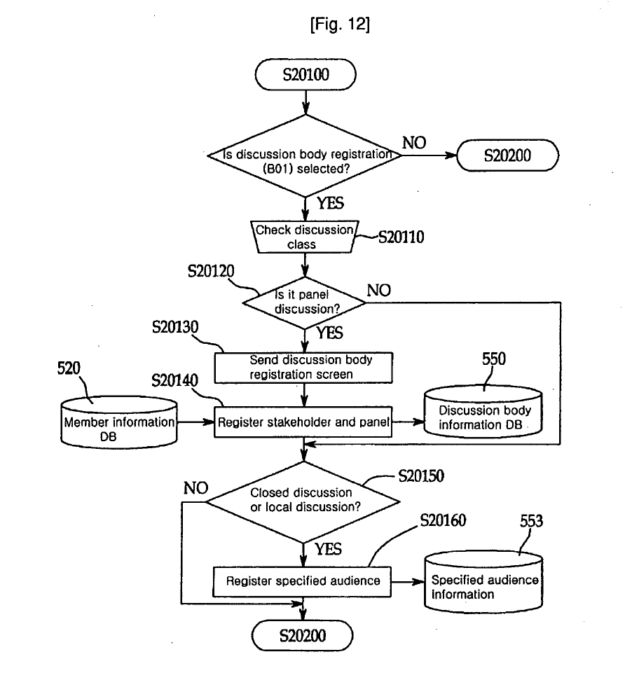

(2) Operation when discussion body information registration (B01) is selected in a moderator mode (B mode) will be described with reference to FIG. 12. The process checks a discussion class to determine whether it is a panel discussion (S20100 to S20120).

If it is determined that it is the panel discussion, the process sends a discussion body information registration screen to the terminal and the moderator inputs discussion body information such as a stakeholder and a panel. Here, the moderator-input discussion body information is registered in the panel information 552 and the stakeholder information 554 of the discussion body information DB 550 (S20130 to S20140).

If the moderator-input discussion is the closed discussion or the private discussion, the process inputs the specified audience and registers it in the specified audience information 553 of the discussion body information DB 550 (S20150 to S20160).

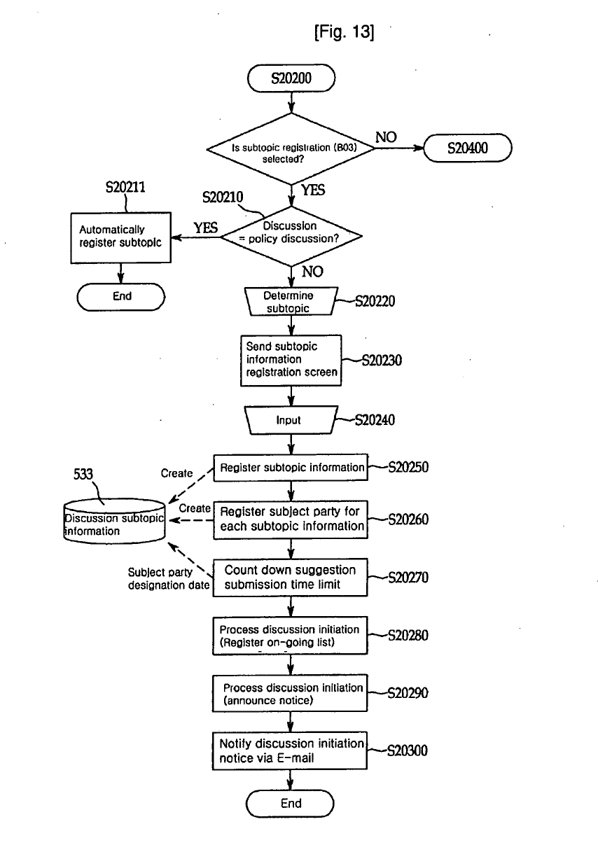

(3) Operation when the discussion subtopic registration B03 is selected in a moderator mode (B mode) will be described with reference to FIG. 13. The process checks a discussion classification to determine whether the discussion is a discussion-with-proposition (S20200 to S20210).

If it is determined that the discussion is the discussion-with-proposition, the process automatically registers the subtopic of the discussion and ends (S20211).

If it is determined that the discussion is not the discussion-with-proposition, the process determines the subtopic to send a subtopic information registration screen to a terminal, registers subtopic information and subtopic-specific subject party in the discussion's subtopic information 533 of the discussion information DB 530 if the moderator inputs them, and counts an argument submission time limit from a subject party designation date (S20220 to S20270).

The process then inputs a discussion initiation processing list and sends a discussion initiation processing notice via E-mail while announcing the notice (S20280 to S20300).

The discussion's subtopic information registration of the discussion information DB 530 is summarized, as follows:
The subtopic information registration task includes \textcircled{1} registering and modifying subtopic classification information, and \textcircled{2} processes a discussing method (SP-specified) according to subtopic natures.
If the discussion is not the discussion-with-proposition, the moderator inputs all subtopic information and designates a subject party to perform initial SA registration.
If the discussion is the discussion-with-proposition, the system automatically generates argument classification as subtopic information when a debate subject party terminates the SA suggestion registration.
When the subtopic is registered, the system counts the argument submission time limit down.
When the subtopic of the discussion is registered and the on-going list is registered, the process announces a notice of discussion initiation processing and notifies it via E-mail.

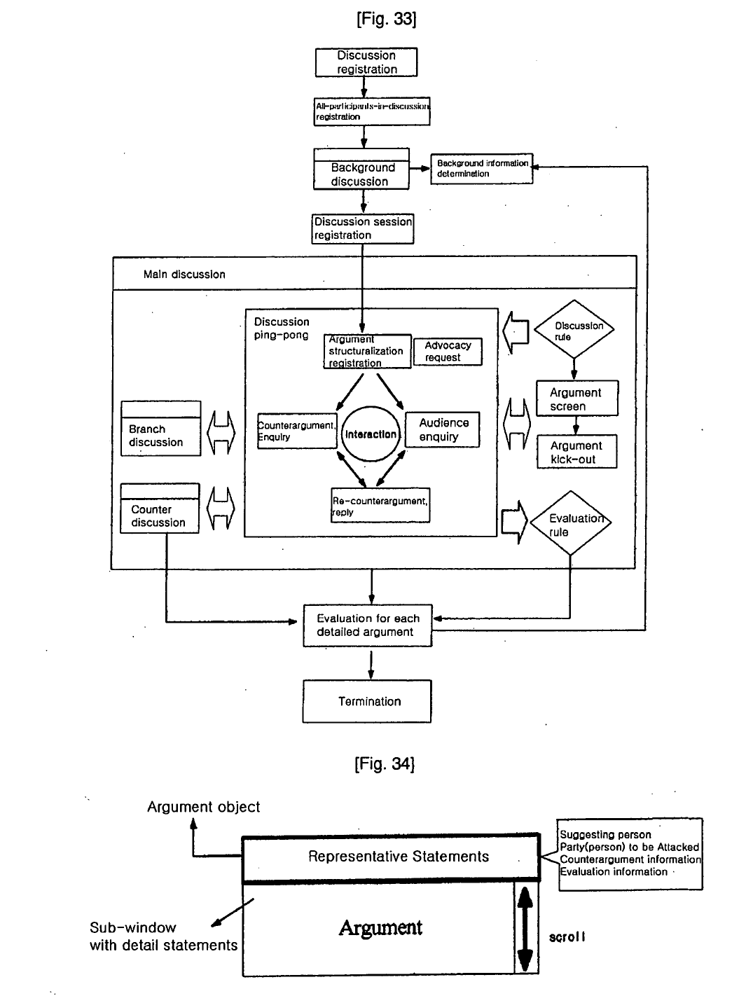

Meaning of Subtopic
The subtopic is of a discussion such as a meaning, nature, necessity and problem of discussion (point at issue). Suitability of subtopic extraction is a core case for efficient discussion prosecution (See FIG. 33).
It is a subtopic for classifying (sub-classifying) natures of an argument to increase efficiency of discussion and achieve information-making in the future. It may be presentation classification for allowing the audience to easily recognize overall discussion prosecution situation for each subtopic type.
The nature of the subtopic determines an order of argument submission (See the discussing method).
If the discussion subject is a specific concreted case, the subtopic may be not determined.

<Examples of the Subtopic>
Subject of issue (pro&con discussion)—Will public official labor union establishment be approved?

Subtopic—What difference is there between the public official and enterprise's workers?
What is a necessary and sufficient condition of the labor union establishment? (necessity and condition of labor union, etc.)
Subject of issue (pro&con discussion)—A five-day working system

Subtopic—Why do we do? or What is necessity of law establishment?
What problem is there in a group when the law is enforced? What solution?
How far is a five-day working system an urgent case?
Subject of issue (solution discussion)—an alternative plan to overheated real estate speculation

Subtopic—What problem is there? (seriousness of the problem)
What solution is there?

Determination of Subtopic
The subtopic, not in the discussion-with-proposition, is determined by agreement between the moderator, necessarily leading the discussion, and the stakeholder at the time when the discussion is determined. The subtopic may be added and changed after the discussion is initiated.
The subtopic in the discussion-with-proposition is automatically determined by the system depending on argument classification when the discussion object stakeholder has input his or her argument.
The subtopic may be determined in a broad sense depending on a nature or situation of the discussion, or may be determined through agreement. A case may be determined as a subtopic in a specific discussion and as an argument in other discussions.
All suggestions are classified in dependent on the subtopic and managed by the system.
If the subtopic is determined, the moderator designates a specific stakeholder (subject party) depending on a nature of each subtopic to submit his or her argument (subject argument) on the subtopic. The moderator should determine the subtopic for all stakeholders to submit their sufficient subject argument.

General Items of Subtopic
The following items may generally be an essential subject of a discussion point at issue. Accordingly, all or some of the following items should be necessarily set as a subtopic of the discussion.
   Meaning and definition of various cases: A question for the meaning and definition of core contents in the cases.
   Problem & solution: The problem may correspond to necessity and the solution may correspond to an effect according to discussion cases.
   Cause and factor: A case about a cause and a factor of a problem.
   Urgency of a case: Two factors—importance and time limit conventionally tends to be generally ignored in many discussions but should be considered as core cases determining success and failure of the discussion. The time limit may be represented as a specific condition or circumstance or may be represented as a certain period.

(4) Operation when a background information registration B04 is selected in a moderator mode (B mode) will be described with reference to FIG. 14. A discussion classification is checked to determine whether a discussion is a background discussion (S20400 to S20410).

If it is determined that the discussion is not the background discussion, the background information is subject to conference. The process then determines whether there is agreed background information, sends a background information registration screen to a terminal if there is the agreed background information. If the moderator inputs background information, the process registers subtopic-specific background information in the background information 543 of the argument information DB 540 (S20420 to S20460).

The background information registration of the argument information DB 540 is summarized, as follows:
The background information is information that clearly defines a discussion point at issue for efficiency of the discussion prior to initiating the discussion.

Structure of the background information
The background information should be composed of only the following items (hereinafter, referred to as background information construction item classification).
Outstanding problem: Definition regarding an outstanding problem that causes the discussion.
Cause: cause of the problem. The cause may be contained in the outstanding problem and omitted.
Urgency of solution: Definition regarding urgency of a solution to the problem. The urgency may be represented with a time limit or importance.

Background Information Registration
The background information is generated in two cases (hereinafter, referred to as background information registration classification) below and registered for each subtopic.

\textcircled{1} Where the moderator optionally provides the background information

\textcircled{2} Where the moderator determines, as the background information, any of arguments determined to be suitable in the background discussion or the main discussion

Background Information Registration Format
The background information registration format is processed in the same manner as the argument registration format. The following information is generated:
Arg-id, subtopic ID, registration classification, construction item classification, a registration date, and background information details
Supplemental explanation may be registered.

Meaning of Background Information
The background information clearly refers to define a point at issue to exclude unnecessary dispute and faulty logic prior to the discussion. That is, it refers to clearly define all factors surrounding a discussion such as a problem and a necessity prior to initiating the discussion. For convenience of illustration, such factors are collectively called a problem.
Examples of the background information include urgency of additional information such as a solution and terminology explanation, in addition to the factors.
The background information includes information about essential items of the subtopic of the discussion recognition, and all discussion participants should recognize assumption about all prosecution of the discussion.

Organization of the Background Information
The background information is composed of the following items:
Outstanding problem: an outstanding problem causing a discussion is clearly defined.

Example) What problem does a small number of vocational representation assemblymen cause in a discussion to reduce the number of local constituency assemblymen and increase the number of vocational national constituency assemblymen in a discussion regarding a revised election law?, What meaning does the national constituency representing a local constituency have?, etc.
Cause: the cause of the problem (may be contained in the outstanding problem and omitted).
Urgency of solution: this defines urgency of a solution to a problem. This urgency may be represented with a time limit or importance. The urgency is a very important item defining a focus of a point at issue in connection with debaters problem recognition. The moderator is able to define the urgency in any discussion case. The urgency may be defined through background discussion for problem recognition.

Providing Background Information
In the case of the discussion-with-proposition, a problem or phenomenon generated or expected to be generated when a suggesting person suggesting a policy or a proposition performs suggestion background, i.e., suggestion may be registered as the discussion background information. The moderator arranges and provides discussion background information through agreement with the suggesting person.
In the case of the discussion-with-no-proposition, the background information may be optionally provided by the moderator or determined through the background discussion. A main discussion may proceed without the background information.
The discussion's subtopic information should be provided even when the background information is not provided.
An argument evaluated as termination through the background discussion may be determined as the background information by the moderator.
Further, when this discussion is held without background information and background discussion and the argument evaluated as the termination is determined to be an argument having any nature of the background information in the discussion process, the moderator can form background information through discussion stakeholders' agreement at all times.
Even when the background information is evaluated, the subtopic of the discussion may be additionally generated.

Background Information Registration Form and Objection
Background information should have an argument structure form defined in this system and be composed of only fact or information excluding specific value or argument. See the suggestions and suggestion grounds
The background information may submit objection to be an object of the discussion. If a reasonable counterargument is submitted on the background information, the moderator should determine the background information as the object of the discussion. When being determined as the object of the discussion, the background information should be excluded until the discussion is terminated.

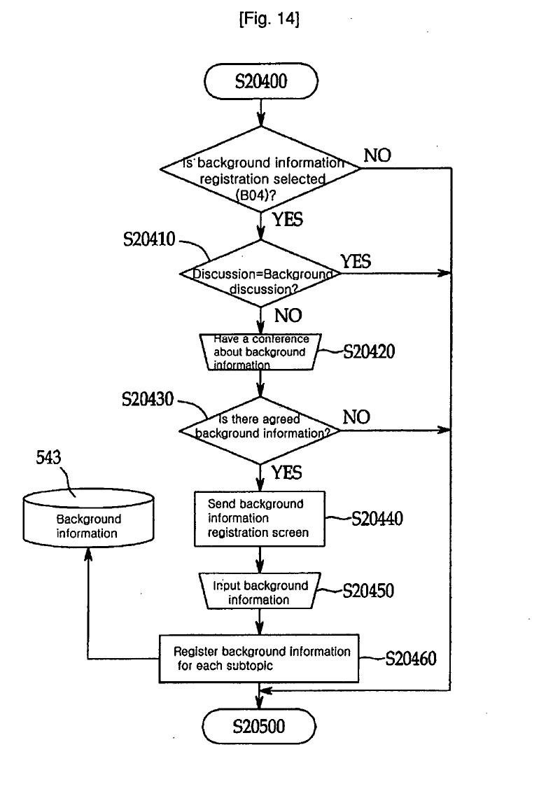

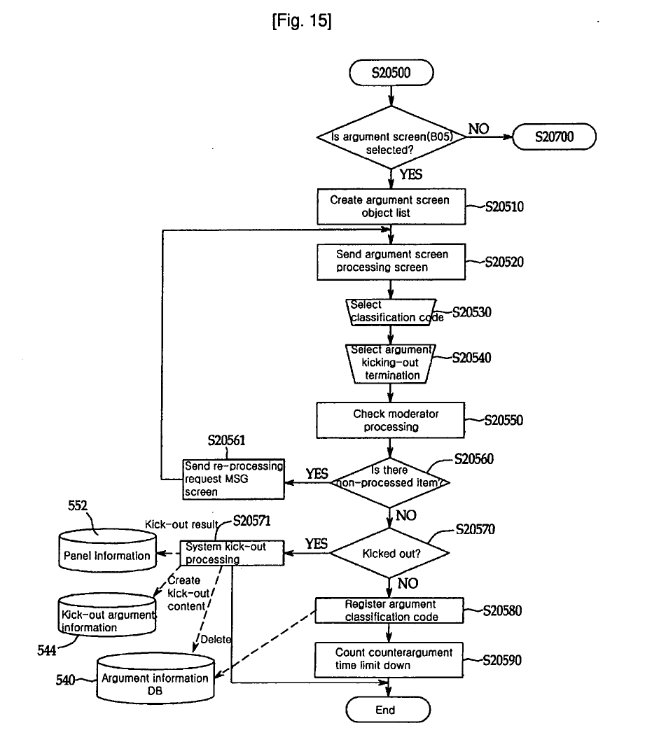

(5) Operation when an argument screen (B05) is selected in a moderator mode (B mode) will be described with reference to FIG. 15. A process generates an argument screen object list and sends an argument screen processing screen to the terminal (S20510 to S20520).

The process then determines whether the argument is kicked out for each object argument item and selects an argument classification code. The process checks moderator processing to determine whether there is an item that is not processed and sends a re-processing requesting message on the terminal screen if there is the item that is not processed (S20530 to S20561).

If it is determined that there is no item that is not processed, the process determined whether there is argument kick-out. If there is the argument kick-out, the process performs system kick-out processing to register kick-out result in the panel information 552 of the discussion body information DB 550, produce kick-out content to register it in kick-out argument information 544 of the argument information DB 540 (S20560 to S20571).

If it is determined that there is no argument kick-out, the process registers an argument classification code in the argument information DB 540 and counts the counterargument time limit (S20570 to S20590).

Argument screen registration in the argument information DB 540 is summarized, as follows:

The Argument Screen Refers to:
a moderator or system analyzing newly registered various argument, determining and registering suggestion grounds and a counterargument type, and kicking out meaningless, overlapping or inappropriate arguments interrupting discussion.

Kick-Out Processing and Sanctioning
It induces smooth discussion by the moderator thoroughly screening and kicking-out behavior interrupting the discussion such as abusive arguments, irrelevant arguments/counterarguments, and meaningless suggestions (hereinafter, referred to as inappropriate argument or kick-out argument) to maintain a site's quality level.
It is especially noted that appropriateness of kicking out a meaningless argument and a parallel argument significantly affects a discussion result and evaluation processing.
The system separately provides only newly registered arguments so that the moderator easily screens all arguments.
A panel suggesting a kicked out argument applies certain sanctions in principle.
However, the system originally has the following kick-out argument box to prevent the moderator from abusing the right and optionally kicking out a panel justified argument.
Inputting classification information for the SA and OA is performed in kicking out the argument.

System argument screen on counterargument
In argument kick-out, the moderator directly screens the argument in principle. However, when a counterargument on the SA corresponds to the following, the system automatically kicks out the argument:
   When a counterargument on a measuring suggestion is condition submission (meaningless argument).
   When a counterargument on a non-measuring suggestion is negative objection (parallel argument).
In this case, the system provides the kick-out information to the moderator.

Operating a Kick-Out Argument Box
an argument kicked out by the moderator or the system is necessarily stored with a kick-out reason in the kick-out argument box.
The kick-out argument box uses multi-dimensional classification by a discussion and a subtopic for easy retrieval, similarly to the normal discussion.
Kick-out reason:

1. Defective argument: an argument with abuse or with abuse having no ground

2. Overlapping argument: The same argument as already registered by other panels (See Supplemental Argument)

3. Meaningless argument: Argument deviating from a point at issue and a focus, argument that is not classified, or a meaningless argument

Examples of the argument classification (argument category) used herein include a system classification defining nature of suggested SA and OA (in the SA, suggestion ground classification such as fact, value (logic), proposition according to the nature of the SA, and a suggestion ground structure that dependently or independently defines logical correlation between SAs), and a counterargument classification that defines OA′ correspondence degree (complete objection, condition submission, etc.) to the SA

4. Parallel argument: an argument that performs the dispute in parallel by submitting a counterargument having no ground.
The healthy panel or moderator will not generate an argument kick-out situation. Accordingly, this function acts as checking means for blocking the moderator from optionally performing the discussion.

Sanctioning Kick-Out of Argument
A panel suggesting a kick-out argument receives a warning from a moderator and is subject to sanction of restricted discussion participation and panel disqualification. The system has a function of preserving and providing sanction information.
With the restricted discussion participation and the panel disqualification, the system refuses argument registration.
The system provides a function of inputting a sanction number, an elapse period and the like and a function of enquiry for each sanction class. The moderator is able to input a sanction content and release the sanction by referring to system-provided information.
The detailed sanction method is defined in the background discussion rule, in which sanction exemption may be defined.
   Nature classification and selection of SA and OA registered in the discussion process
SA: Ground structure and ground classification
OA: Counterargument classification
   A function of a moderator kicking out the following arguments for all arguments suggested in the discussion process:

\textcircled{1} Defective argument, \textcircled{2} Meaningless argument, \textcircled{3} Overlapping argument, and \textcircled{4} Parallel argument

System provided list: The system provides the following list on an argument screen processing screen to kick-out the argument.

\textcircled{1} Newly registered argument.

\textcircled{2} One of registered arguments that have not performed argument screen.

\textcircled{3} Newly modified argument

Argument screen processing: The following is performed using argument screen processing screen

\textcircled{1} Moderator's processing:
In kick-out, the moderator inputs kick-out reason and performs sanction on a suitable kick-out argument according to a discussion rule (In non-kick-out, the moderator inputs argument screen termination information to a relevant argument).
The moderator inputs SA and OA nature classification information.

\textcircled{2} System's processing:
The system deletes kick-out argument from argument information and generates kick-out argument in kick-out reason box.
The system writes a kick-out record for the panel to discussion body information and panel information.

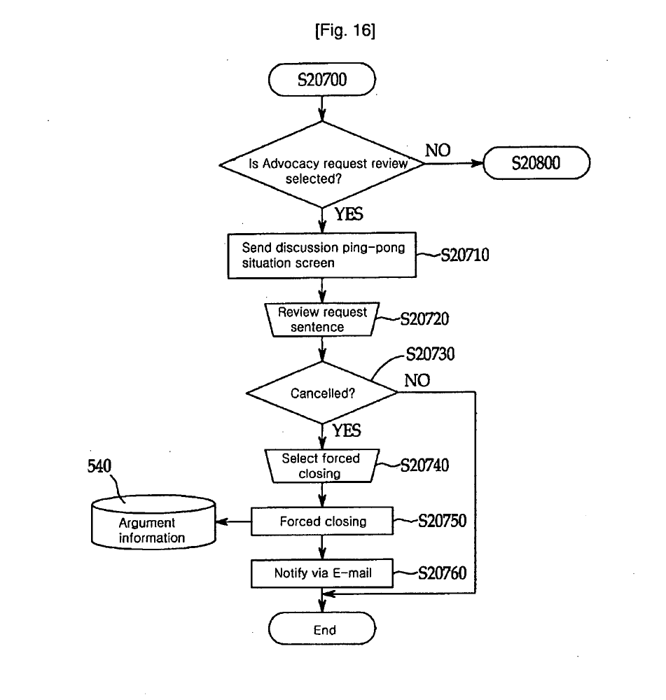

(6) Operation when advocacy request review (B05-1) is selected in a moderator mode (B mode) will be described with reference to FIG. 16. The moderator sends a discussion ping-pong situation screen to a terminal in order to review an advocacy request (S20510 to S20520).

Thereafter, the moderator reviews a requesting sentence to determine whether there is cancellation and, if there is the cancellation, selects forced closing, registers the forced closing in the argument information DB 540 and notifies it via E-mail (S20720 to S20760).

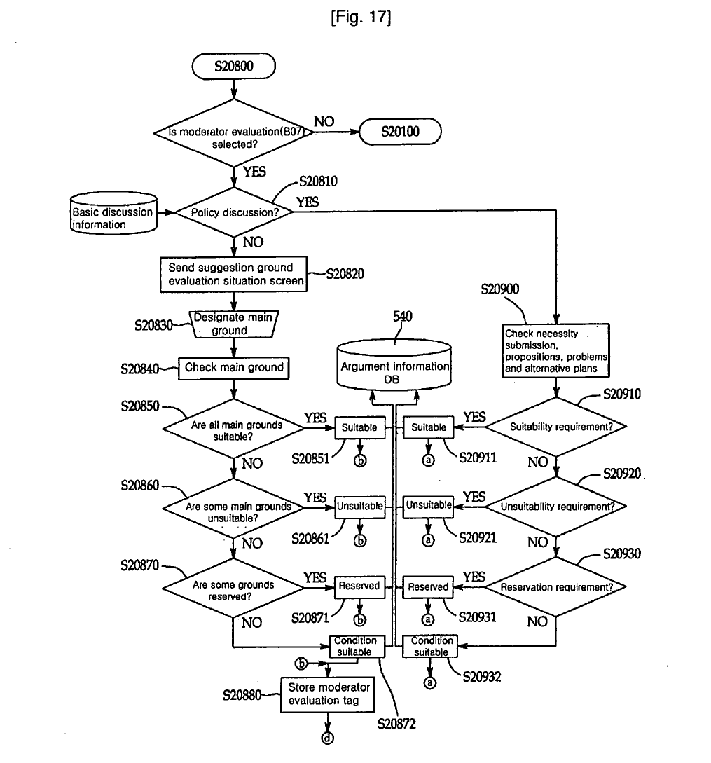

(7) Operation when a moderator evaluation (B07) is selected in a moderator mode (B mode) will be described with reference to FIG. 17. The moderator determines whether the discussion is a discussion-with-proposition to rule an argument, and if it is not the discussion-with-proposition, sends a suggestion ground evaluation situation screen to the terminal (S20800 to S20820).

Thereafter, the moderator designates and checks main grounds, and registers a suitability determination in the argument information DB 540 if the main grounds are all unsuitable, registers an unsuitability determination in the argument information DB 540 if some of the main grounds are unsuitable, and registers a reservation determination in the argument information DB 540 if some of the main grounds are reserved (S20830 to S20871).

If some of the main grounds are not reserved, the moderator registers conditional suitability in the argument information DB 540 to store a moderator evaluation tag (S20870 to S20880).

If it is determined that the discussion is a discussion-with-proposition, the moderator checks necessity suggestion, propositions, problems and alternative plans. The moderator registers a suitability determination in the argument information DB 540 if it is a suitability requirement, registers an unsuitability determination in the argument information DB 540 if it is not an unsuitability requirement, and registers a reservation determination in an argument information DB 540 if it is a reservation requirement (S20900 to S20931).

If it is not the reservation requirement, the moderator registers conditional suitability in the argument information DB 540 (S20932).

(8) Operation when an audience poll B20 is selected in a moderator mode (B mode) will be described.

Polling Condition
An audience poll is performed on only an initial subject argument only if the three following conditions are met.

1. If the initial SA is evaluated to be confronted,

2. If a ground classification of the initial SA is a tone (value), and

3. If a discussion rule defines that an audience poll is performed.

Performing Method
The method does not ask simple pro&con but seeks reflection of a more demonstrative public argument by selecting a pro&con reason so that a tendency of recognizing the pro&con reason is recognized.
The pro&con reason refers to all SA and CA suggested in the discussion process (hereinafter, referred to as public argument deduction item). Upon the agreement, the SA will be the public argument deduction item and upon the objection, the CA will be the public argument deduction item.
A polling period is determined in the discussion rule, and when the poll is performed, the system automatically sends a polling notice to the audience via E-mail.
The method may select limited audience through sample extraction to prevent persons of a specific class to do intentionally intensive voting according to cases.
A voting audience should necessarily be a pre-registered member with his or her real name in the system. If the person is not a member with his or her real name, it is necessary to verify the real name (resident number, name, E-mail, address, occupation). The real name verification is necessarily confirmed via E-mail.
The method seeks a system proposition of checking log-in information and verifying a one-person one-vote.

Processing a Polling Result
If a poll is terminated, the system automatically provides a pro&con result and a pro&con reason to all audience members and suggests local, sex, age, occupation-specific information of voters for recognizing inclination of the voting result.
The polling result automatically is recoded as evaluation information.

Next, processing operation when a user having access to a web site is a stakeholder (C mode) will be described with reference to FIG. 18.

When a delegated panel registration (C01) is selected, a discussion body information registration screen is sent to the terminal. The stakeholder registers the delegated panel in the panel information 552 of the discussion body information DB 550. When an advocacy request (C02) is selected, the process proceeds to S40200 described later where advocacy requesting and replying operation is processed (S30000 to S30010).

When an advocacy request registration C02-1 is selected, a requesting sentence producing screen is sent to the terminal. After the requesting sentence is produced, the requesting sentence is registered in the argument information DB 540 to be reflected in the discussion ping-pong situation (S30100 to S30130).

The system extends the counterargument time limit, registers it in the argument information DB 540, and notifies the extended time limit via E-mail, entering a review-requesting review (B05-1) mode (S30140 to S30150).

Next, processing operation when a user having access to the web site is a delegated panel (D mode) will be described with reference to FIGS. 19 to 22.

(1) Operation when a suggestion registration (D01) is selected in the panel mode (D mode) will be described with reference to FIG. 19. A process determines an input class. When the input is a suggestion, the process checks whether there is an installed statement editor (S40000 to S40010).

If the statement editor is not installed, the process downloads automatically the statement editor. If the statement editor is installed, the process executes the statement editor to sends a statement editor screen to the terminal (S40020 to S40040).

When an argument is input on the statement editor screen, the argument is uploaded so that the argument is registered in the argument information DB 540, and a automatic notification is made as to that the new argument has been registered (S40050 to S40070).

Argument Modification
An entire or some of registered argument (SA and OA) may be deleted/changed by a register only one time (hereinafter, referred to as argument modification) except for the following cases (hereinafter, referred to as a performed argument):
When a counterargument is submitted by others,
When an argument is added by others,
The argument modification refers to completely changing an original argument into a new argument. The system automatically notifies all discussion participants of change details via E-mail.
When the argument is changed, the system automatically extends a counterargument time limit.
An argument can be modified only one time, and a total of change number may be limited by discussion rule information determined prior to initiating the discussion.

Argument Withdrawal
While a prosecuting argument cannot be changed, a panel registering the argument may optionally withdraw the argument when accepting the counterargument or determining that there is a shortcoming in the suggested argument.
When the argument is redrawn, the system reflects the argument and counterargument to a screen presentation so that audience recognizes them as redrawn arguments, automatically notifies withdrawal details to all discussion participants via E-mail, and prevents inputting a counterargument or enquiry on the redrawn argument.
Counterargument and enquiry on the redrawn argument as well as the redrawn argument itself cannot be modified or deleted.

Alternative Argument
If a suggested argument is withdrawn due to some defects, one alternative argument can be registered. However, the alternative argument should be an argument with a content being modified from an original argument and cannot be a new argument having no relationship with the original argument.
If the alternative argument is registered, the moderator can confirms justice of the alternative argument through comparison between the original argument and the alternative argument, as well as an argument screen to kick-out the alternative argument.
If the alternative argument is registered, the system prepares means so that the audience enquires the original argument and the counterarguments in association with the alternative argument.
The alternative argument should be registered within 24 hours from argument withdrawal. If the alternative argument is not registered after the argument withdrawal, the system automatically processes the argument as unsuitability evaluation.

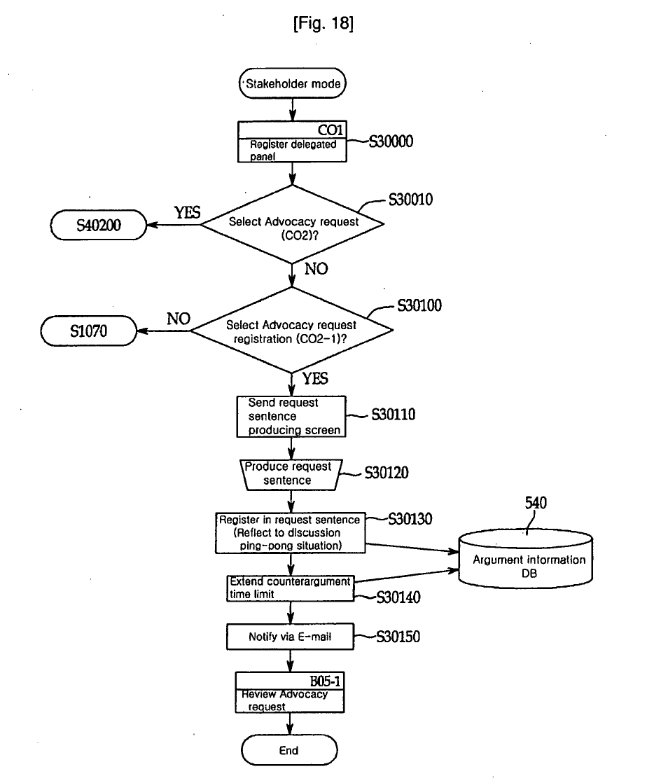

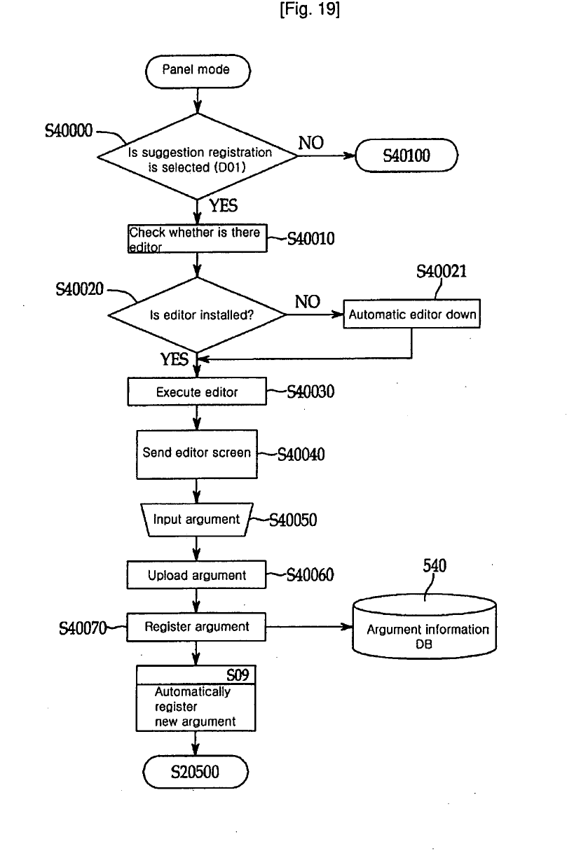

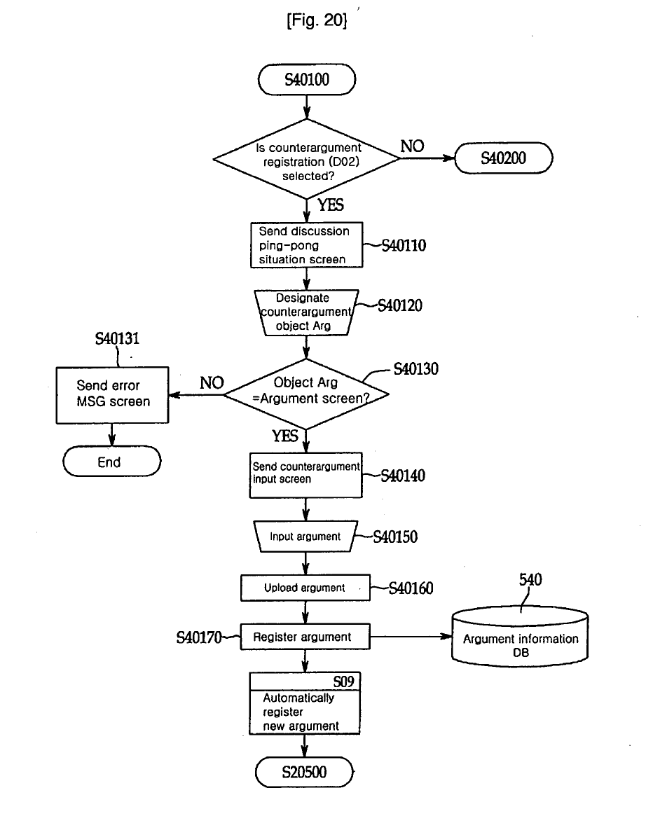

(2) Operation when counterargument registration D02 is selected in a panel mode (D mode) will be described with reference to FIG. 20. The process sends a discussion ping-pong situation screen to the terminal and designates a counterargument object argument to determine whether an object argument is an argument screen (S40100 to S40130).

If it is determined that the object argument is not the argument screen, the process sends an error message to the terminal screen (S40131) and if the object argument is the argument screen, the process sends a counterargument input screen to the terminal. If the argument is input, the argument is uploaded such that the argument is registered in the argument information DB 540 and the process automatically notifies that a new argument is registered (S40140 to S40170).

A suggestion and counterargument registration of the argument information DB 540 is summarized, as follows:

Input Class and Method
SA input: Input, addition and change of a ground of suggestion related to a new suggestion
Additional information input: An inputting person, various classifications of suggestion and ground of suggestion, etc.
Counterargument and enquiry input: Input of a counterargument on a specific number of arguments excluding SA, enquiry, etc.
Input method: Inputting in an off-line manner using an argument structure registration screen, as in FIG. 33 (See argument structure registration).

Core characteristics of argument structure registration of the present system include:

\textcircled{1} Breaking-down, structuring and registering various argument (suggestion and counterargument) for each point at issue (recognizing and deducing a problem),

\textcircled{2} Performing interactive discussion ping-pong on confronted points at issue between panels under a certain discussion rule (accumulating knowledge and confirming conflicts),

\textcircled{3} Deducing a discussion conclusion and a solution based on a discussion ping-pong result and a discussion rule,

\textcircled{4} Providing the discussion prosecution situation as systematic information to all audience through a structured presentation to seek to induce an agreement and derive a public argument (agreement and interest).

Subject argument (SA) input: Inputting SA using a structure input screen.

Counterargument (CA) input: Inputting a counterargument on a specific argument excluding the SA, and enquiry, etc. in an on-line manner by selecting the argument.

Structure Registration
Structure registration refers to inputting by a statement editor formatted in a structured off-line manner with breaking-down a suggestion as the SA and a ground of suggestion for discussion information-making and interactivity.
A special active X based statement editor is developed, downloaded, and processed for formatted input processing.
The downloaded statement editor is automatically executed by a server program.

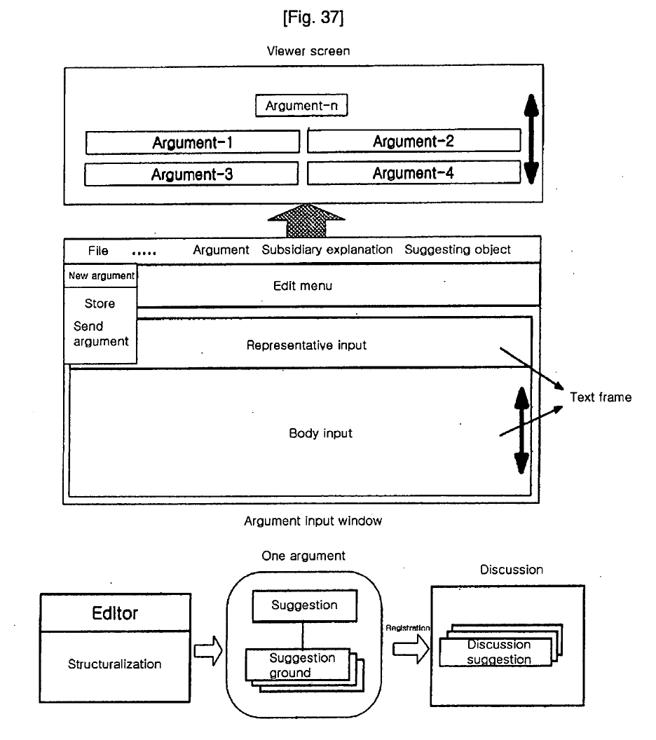

Editor Function
The statement editor has a typical text editing function for inputting, copying and aligning and automatically produces a word frame composed of a representative word and a body (See FIG. 37)
The statement editor uploads all input information to the DB when the input is terminated. If there is a trouble in communication with a server, the information is temporarily stored in a PC and then manually uploaded by a user later.
An input screen is composed of an input window for an individual argument and a viewer window through which input suggestion grounds are viewed. The input argument moves to the viewer screen.
Since respective ground of suggestion objects have several sizes on the viewer panel, arrangement functions such as movement, size adjustment, align, etc., using a mouse are given for visualization.
The argument input window is used for all arguments inputs.

Processing Description and Word Addition
A function of adding terms, concepts and the like, which are difficult for audience, in suggestion content.
An added content provides the following factions on a sub-window screen upon audience clicking.
Marking the word or sentence and providing a subsidiary screen upon selecting a subsidiary description ICON.
A marked word or sentence and a subsidiary screen form a pair of information, which is managed internally.

Representative Word
The representative word is a content that can abbreviate suggestion content, and becomes a key of the ground of suggestion.
The representative word is processed to be represented in a line.
The representative word is a key of a point at issue during discussion and becomes information key after discussion.
Since many arguments is difficult to be displayed on a screen, the representative word is processed to exist necessarily.

Meaning of Counterargument (Object Argument and Counterargument)
A first counterargument an initial subject argument is called an initial object argument (hereinafter, referred to as an initial counterargument).
A subject panel's further counterargument on a counterargument and a still further counterargument thereon are collectively called a counterargument.
Further, counterarguments of a subject panel and an object panel are classified and called a subject counterargument and an object counter-argument, respectively, which is shown in FIG. 43.

Argument Correspondence
There may be a plurality of initial object argument on one subject argument.
Further, there may be a plurality of counterarguments on one argument. However, one counterargument on a plurality of arguments is not approved.

Classifying the Nature of Counterargument
An initial counterargument is nature-classified according to nature classification of an initial SA. The nature is reflected to evaluation with a discussion ping-pong result and SA nature (See argument evaluation)
If a plurality of initial counterarguments on one SA are generated, the moderator designates all nature classifications to generate a plurality of ping-pongs.
Counterargument is dependent on each of SA and OA and determines a discussion ping-pong result on the SA. Accordingly, nature classification for all counterarguments is omitted.

Registering Counterargument
All counterarguments should be registered with an object argument to be necessarily rebutted being designated.
The counterargument is necessarily registered in anon-line mode, unlike the SA registration.

Designation of Counterargument Class (Nature Classification)
If an object argument as the first counterargument on SA is registered, the moderator designates a nature of the counterargument.
The counterargument nature should be classified into the following three types. Since a logically parallel counterargument cannot be ping-pong argued, it is kicked out.
   Suggesting a counter argument on a correspondent's argument,
   Suggesting a condition for realizing correspondent's argument, and
   Enquiring about correspondent's argument.
If a registered counterargument is not applied to the classification, the moderator kicks out as a meaningless argument as in the suggestion ground classification.

Counter Argument
The counter argument includes negative objection that suggests a reverse effect, a problem, a counter fact or a counter case, and active objection that directly objects, such as logical denial or fact denial on an argument.
The negative objection should be a counterargument on a fact and a proposition, which is measuring argument. Further, the negative objection may be not regarded as counterargument that entirely denies any argument but is only regarded as a counterargument that suggests a problem.
Since negative objection on non-measuring argument is a parallel counterargument or meaningless argument, the argument is kicked out.

<Case>

If a counterargument that “our society's loss is great due to the U.S. military in Korea,” is submitted against non-measuring suggestion that “our people still think that the North Korean would attack us if the U.S. military is withdrawn”, this may be said to be a parallel counterargument. Such non-measuring argument should be rebutted through a condition submission or enquiry that “Can the Korean military not defend the attack by itself?” or “What percentages of the people have such thought?”

Condition Submission
Condition submission refers to recognizing a suggestion and suggesting a realization condition, assumptions and exceptions of the argument (hereinafter, “suggestion condition”). The condition can be suggested only to a suggestion whose value is a ground classification, unlike the counter argument.
The condition submission may be provisory and defensive condition submission that simply suggests the realization condition, or attack condition submission that suggests a suggestion realizing condition in a reverse manner to argue that the suggestion is unsuitable based on the condition.
The attack condition submission is regarded as active objection.
The defensive condition submission has an effect making realize that even an excellent argument is not an absolute value or fact, and becomes the active objection in a suitable situation or time.
It is common that the condition submission is suggested by a counter arguing person but may be suggested by a suggestion ground suggesting person by himself or herself (hereinafter, referred to as arbitrary counterargument)
An arbitrary counterargument suggested by a subject panel may be an object of counterargument.

Enquiry and Reply
Enquiry is an argument for requesting a correspondent to respond and may be classified into the two following classes:
Counter-question: an enquiry for extracting a blind point or contradiction of a correspondent's argument
Question: an enquiry when a correspondent's argument contains the unclear element.
The enquiry should necessarily designate an object argument, i.e., a plurality of object argument in the counter-question and one argument in the question.
The counter-question and the question necessarily require a reply.
When a reply time limit to a question has elapsed, the system and the moderator regard the subject argument as withdrawal and process it.
When a reply to a counter-question is a counter-question as well, it is regarded as a reply to the counter-question: re-counter-question
A reply to a question may be a question: re-question
When the counter-question or question is enquired whether it is positive or negative, a responding person should necessarily a reply as positive or negative but may refuse to reply when it is difficult for the enquiry content to be reply as positive/negative.
The enquiry may be requested by a moderator or audience.

Moderator' First Question
The moderator first suggests an enquiry or a counterargument against a newly registered SA or OA to suggest a question or a problem on the registered argument earlier than an object panel (OP). Since many panels will be interested in the question from the moderator as an expected enquiry in common, a reply should be necessarily first provided.
Accordingly, the moderator can optionally reserve OA of all panels until the reply to the enquiry is provided by the moderator.

Counterargument on Background Information
Background information registered by a subject party may be an object of the counterargument, as well. The system should regard the background information as SA and process so that any panel suggests the counterargument.
If the counterargument on the background information is generated, it means that the background information is requested for the discussion. Accordingly, the moderator should immediately switch the counterargument to the SA via an argument screen and induce discussion between the subject party and the rebutting person. However, there is an exception when the counterargument is the question.
A counterargument time limit for background information is conference by the discussion rule in advance.

Nature-Specified Processing of a Plurality of Initial Counter Arguments
When a plurality of initial counterarguments on one SA are generated, the moderator designates all of the nature classifications.
The system automatically determines the highest level of counterargument to be a representative counterargument to be reflected to a discussion ping-pong result according to the following order of counterargument intensities by referring to each counterargument nature.
   Active counter, attack condition submission, counter-question > negative objection, defensive counter > question

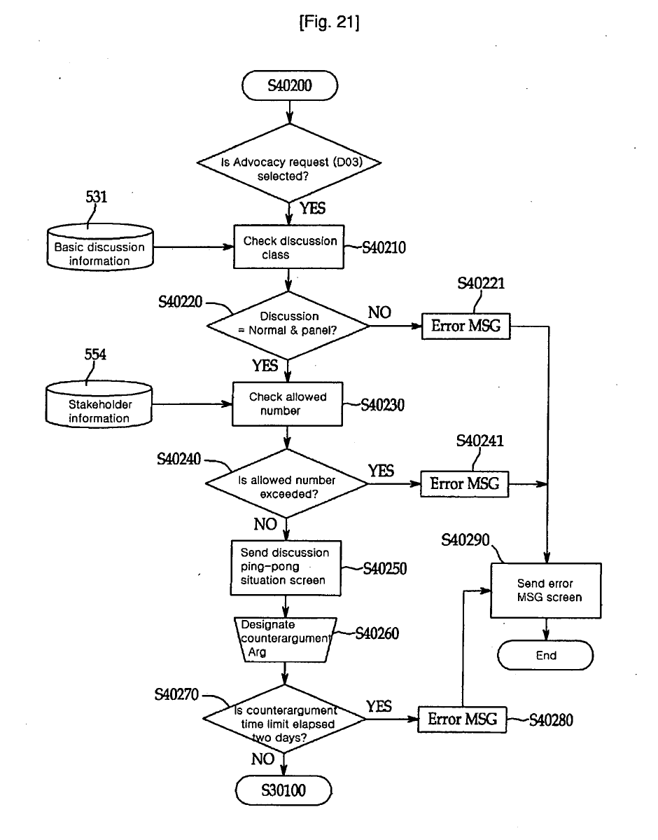

(3) Operation when an advocacy request D03 is selected in a panel mode (D mode) will be described with reference to FIG. 21. A process checks a discussion class in the basic discussion information 531 registered in the discussion information DB 530 to determine whether the discussion is a typical and panel discussion (S40200 to S40220).

If it is determined that the discussion is not the typical and panel discussion, the process sends an error message on a terminal screen (S40221), and if the discussion is the typical and panel discussion, the process checks an allowed number of the stakeholder information 554 registered in the discussion body information DB 550 and sends an error message if the allowed number is exceeded (S40230 to S40241).

If the allowed number is not exceeded, the process sends a discussion ping-pong situation screen to the terminal and designates a counterargument object argument to send an error message when the counterargument time limit exceeds two days (S40250 to S40290).

If the counterargument time limit does not exceed two days, the process proceeds to S30100 where the process performs advocacy request registration C02-1.

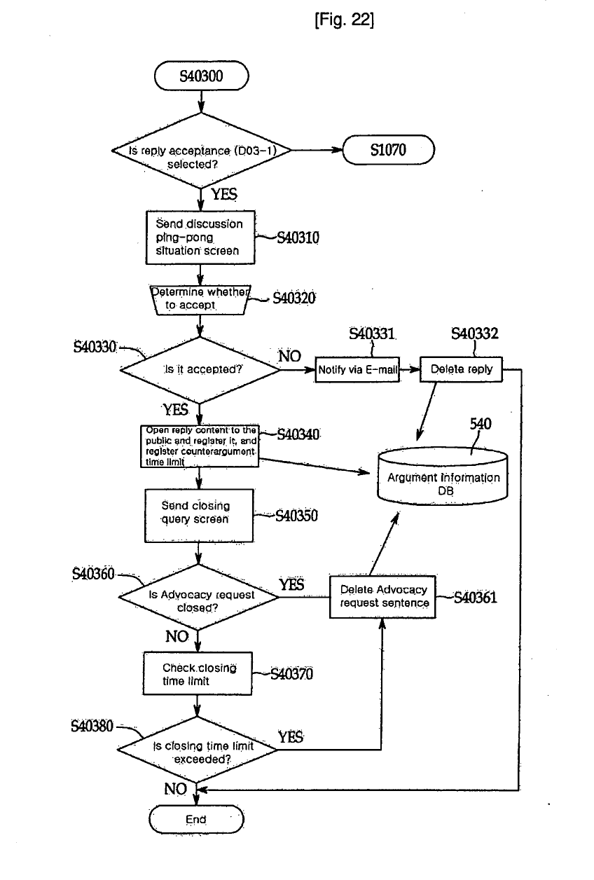

(4) Operation when reply acceptance (D03-1) is selected in a panel mode (D mode) will be described with reference to FIG. 22. A process sends a discussion ping-pong situation screen to a terminal to determinate whether a reply is accepted, and notifies that the replay is not accepted via E-mail and deletes the reply to registration it in the argument information DB 540 if the replay is not accepted (S40300 to S40332).

If the replay is accepted, the process opens the reply content to the public, registers the reply content, registers the counterargument time limit in the argument information DB 540, sends a closing query screen to the terminal, and determines whether it is an advocacy request closing (S40330 to S40360).

If it is determined that it is the advocacy request closing, the process deletes an advocacy requesting sentence and registers the sentence in the argument information DB 540 (S40361). If it is not the advocacy request closing, the process checks the closing time limit and deletes the advocacy requesting sentence to register the sentence in the argument information DB 540 if the closing time limit is exceeded (S40370 to S40380).

The advocacy request and reply registration is summarized, as follows:
The advocacy request is a behavior for requesting an unspecific audience or panel supporting one's argument to supplement a counterargument that can supplement the argument.
The advocacy request and the closing can be applied only to the panel discussion rather than the discussion-with-proposition and is performed by the stakeholder or a delegated panel (hereinafter, referred to as an advocacy requester).
An argument that can make an advocacy request can be submitted for only counterarguments such as counterargument, further counterargument, and enquiry except for the SA. That is, the request can be made only in the case where a special knowledge based argument is needed as a counterargument is submitted with a professional fact or tone that cannot be predicted by the panel while discussion ping-pong on a specific SA proceeds.
If an advocacy request is made, the moderator can review the advocacy request and forcibly cancel (close) the advocacy request if the necessity of the advocacy request is not recognized to be reasonable.
The advocacy requester necessarily forms and registers a requesting sentence that requests the advocacy, and the system processes the registered requesting sentence as an argument on which the counterargument is not allowed, and reflects and notifies it in a discussion ping-pong situation until the requester closes the request.

Processing a Reply to Advocacy Request
Suggesting an argument on an advocacy request refers to an advocacy argument (AA) reply. A replier may directly register an argument (“direct reply”). Further, an advocacy requester may register a reply by delivering a reply content to an advocacy requester via another path (“indirect reply”).
In the direct reply, everyone can suggest his or her argument through a registration procedure in an optional panel but can serves as an optional panel.
If the direct reply is registered, the system immediately processes the direct reply as a closed argument and notifies to a requester via E-mail so that the requester examines a reply content to refuse or accept the registration. The refused AA is deleted without a condition and the accepted AA is regularly registered to be rebutted by others.
The examination on the direct reply by the requester is limited only to an initially replied argument. Thereafter, refutation to the argument may be performed by the reply regardless of the requester. However, the requester may suspend a replier's discussion participation right at all times.
The moderator may kick-out the advocacy argument through argument screen as in other suggestion grounds prior to requester's examination. However, a determination as to whether it is a reply corresponding to the requesting content is leaved in requester's hands.

Time Limit Management Responsive to Advocacy Request
The advocacy request is necessarily made within 48 hours from a time when a counterargument time limit begins.
Since the advocacy request causes that a counterargument time limit to the SA is automatically extended such that the discussion period is extended, the discussion rule limits an allowed number for each stakeholder and determines an advocacy request closing time limit.
If the advocacy request is made, the counterargument time limit is extended to an advocacy request closing date plus two days.

Closing Advocacy Request
Closing an advocacy request refers to not requesting a further advocacy argument.
The advocacy request may be optionally closed by an advocacy request even before closing time limit.
If closing is not completed by the time a closing time limit defined in the discussion rule has elapsed, the system automatically performs the closing and regards it as giving-up of argument submission.
If the advocacy request is closed, the system deletes the advocacy request enquiry notice and blocks inputting an advocacy request reply.

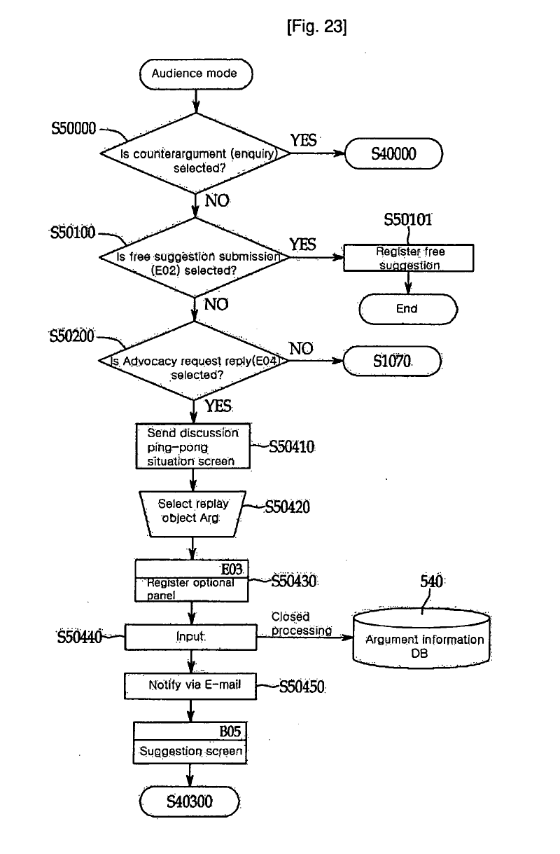

Next, processing operation when a user having access to the web site is an audience (E mode) will be described with reference to FIG. 23.

When a counterargument (enquiry) E01 is selected, the process proceeds to S40000 where the process performs argument and counterargument registration. If the free argument suggestion (E02) is selected, the process proceeds to S50101 where the process performs free argument registration processing. If an advocacy request reply E03 is selected, the process sends a discussion ping-pong situation screen to the terminal so that the audience selects a reply object argument to register an optional panel (S50000 to S50420).

Thereafter, the process sends a reply input screen to the terminal to perform closed processing of the input, registers it in the argument information DB 540, notifies the input processing result via E-mail, and then processes an argument screen (S50430 to S50450).

Audience's Discussion Participation
Audience's discussion participation includes \textcircled{1} direct discussion participation through enquiry and free argument on panel and \textcircled{2} vote of a confronted value as a result of a discussion result, and \textcircled{3} free pro&con argument suggestion on each argument.

Conversation Between Audience and Panel
Common persons are interested in an issue such as separation of dispensary from medical practice. However, such an issue cannot be an object of the discussion due to lack of the person's specialty, but leaving many questions to customers. Since the question is only common sense to the panel, the issue may be often excluded from the object of the discussion.
However, since most of issues have publicity and popularity in spite of non-professional audience and passing over an audience's question causes public negligence, there is a need for audience's participation.

Audience's Enquiry
An audience provides a counter-question or an enquiry to a specific panel (or stakeholder).
The enquiry and the counter-question are structuralized and input for future information, similarly to the argument registration.
Since the counter-question is an enquiry for discussion purpose, it is processed as an enquiry of audience, not a panel, similarly to the panel's enquiry.
The audience's enquiry should be argument-screened by the moderator and necessarily replied by the panel. Re-enquiry on the replied content is allowed. However, if a reply and re-enquiry are repeated on one enquiry, it may be prosecuted as the discussion, not enquiry, and accordingly the moderator coordinates it or makes a responding person to give up a reply.
Since the enquiry and the reply is paired to be information provided to the audience, the information providing method is provided as a method for visualization of arguments and counterarguments.

Free Argument Suggestion by Audience
A typical audience, not optional panel, can occasionally suggest a free argument regardless of the form and rule of the discussion as in the discussion-with-no-proposition site, in which the argument should be necessarily suggested for each argument (hereinafter, referred to as audience argument).
The audience argument can be suggested on all arguments like a conventional guest board, not as the structural argument but is subject to argument screen. Further, the suggested argument is presented with three classifications of agreement, objection and neutrality by allowing the three classifications to be designated to each argument.
Since the audience argument is only heard as an evaluation argument on each panel-registered argument and is not an argument for discussion, a reply on the audience argument is not provided.
Acceptance of the audience argument may be not allowed according to discussion rule agreement between stakeholders.

Audience Poll
Evaluation may be performed through voting for discussion result confronted value (See Closing).

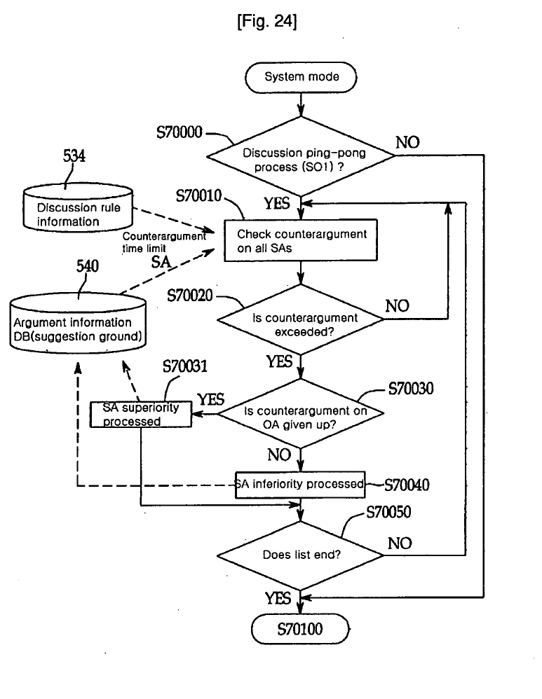

Next, processing operation in a system mode (S mode) will be described with reference to FIGS. 24 to 29.

(1) Operation of the discussion ping-pong processing (S01) in a system mode (S mode) will be described with reference to FIG. 24. A process checks a counterargument time limit for all SAs and determines whether the OA gives up a counterargument if the counterargument time limit is exceeded (S70000 to S70300). SA ping-pong processing used herein refers to the system automatically processing a ping-pong result as superiority, inferiority, or confrontation if one side accepts or the counterargument time limit is exceeded upon performing a ping-pong on a point at issue.

If it is determined that the OA gives up the counterargument, the process processes the SA as the superiority (S70031), and if the OA does not give up the counterargument, the process processes the SA as the inferiority and then determines whether the list is terminated (S70040 to S70050).

Processing the discussion ping-pong result is summarized, as follows:
The system performs the following task in a batch mode at 24 o'clock during the discussion period.
   The system screens all subject arguments with a counterargument given up.
   The counterargument giving-up allows a discussion ping-pong result to be recorded in the argument information depending on SA and OA.
   If the CA side gives up the counterargument; SA superior
   If the SA side gives up the counterargument; SA inferior
   If both do not give up the counterargument; confronted

Discussion Period, Argument Submission Time Limit, and Counterargument Time Limit (Discussion Time Limit)
The discussion period refers to a period from a discussion starting date to a termination date. The argument submission time limit refers to a time limit in which initial suggestion subject arguments that each stakeholder argues can be registered. The counterargument time limit refers to a time limit in which a counterargument is submitted on each subject argument. A further counterargument against the counterargument, and a re-enquiry in response to an enquiry and a reply, have the same counterargument time limit.
The discussion period, argument submission time limit, and counterargument time limit are determined in a discussion rule in advance.
In principle, the counterargument time limit is applied with the same time limit regardless of each argument's case.

Extending Discussion Time Limit
All discussion time limits can be extended by requesting the extension to the moderator through agreement between all discussion participants. However, the counterargument time limit can be extended within the discussion period.
A substantial discussion period is automatically extended to the counterargument time limit of a finally registered counterargument to provide an opportunity of a further counterargument on a counterargument suggested on the point of the discussion termination time.

Closing Additional Suggestion
The moderator can close new registration of an additional suggestion to block interrupting a conclusion within a discussion time limit by a specific stakeholder lately registering an important suggestion by intention.
The additional suggestion closing can be necessarily made after the initial suggestion submission time limit has elapsed, in which the additional suggestion closing time limit is notified to each panel in advance (which is automatically processed by the system upon processing a closing schedule)

Notifying and Enquiring Termination of Discussion Period and Counterargument Time Limit
The system automatically notifies all participants of discussion period termination on three days before termination via E-mail and counterargument time limit on one day (24 hours) before termination.
The system allows for enquiry of a counterargument time limit on each suggestion (or further counterargument on the counterargument and the like).
A post-counterargument (or further counterargument) on a ground of suggestion or counterargument, on which any counterargument or further counterargument is submitted by the time the counterargument time limit ends, is not accepted in principle except for the case where the stakeholder accepts it.

(2) Operation of SA evaluation (S02) in a system mode (S mode) will be described with reference to FIG. 25. The process checks discussion ping-pong information to determine whether the discussion ping-pong is terminated (S70100 to S70120). The SA evaluation used herein refers to the system automatically performing final evaluation on the thread by considering evaluation portfolio according to SA nature classification and OA nature classification, based on an SA ping-pong processing result for each detailed point at issue (thread).

If it is determined that the discussion ping-pong is terminated, the process checks the SA and OA nature classification, registers a suitability determination in the argument information DB 540 when it is a suitability requirement, a conditional suitability determination when it is a conditional suitability requirement, a unsuitability determination when it is a unsuitability requirement, and an evaluation reservation determination when it is not a unsuitability requirement (S70130 to S70170).

Thereafter, the process determines whether the suggestion ground structure is of a dependent type, and equally evaluates the dependent argument if it is of a dependent type and evaluates after determining whether the list is terminated if it is not of a dependent type (S70180 to S70190).

The SA evaluation of the system is summarized, as follows:
The system performs the following task in a batch mode during a discussion period at 24:00 o'clock every day.
The system checks whether discussion ping-pong information (superiority, inferiority, and confrontation) is recorded in all SAs.
The system evaluates an SA having the discussion ping-pong information therein based on the discussion ping-pong result and evaluation rule and records evaluation information in the SA.

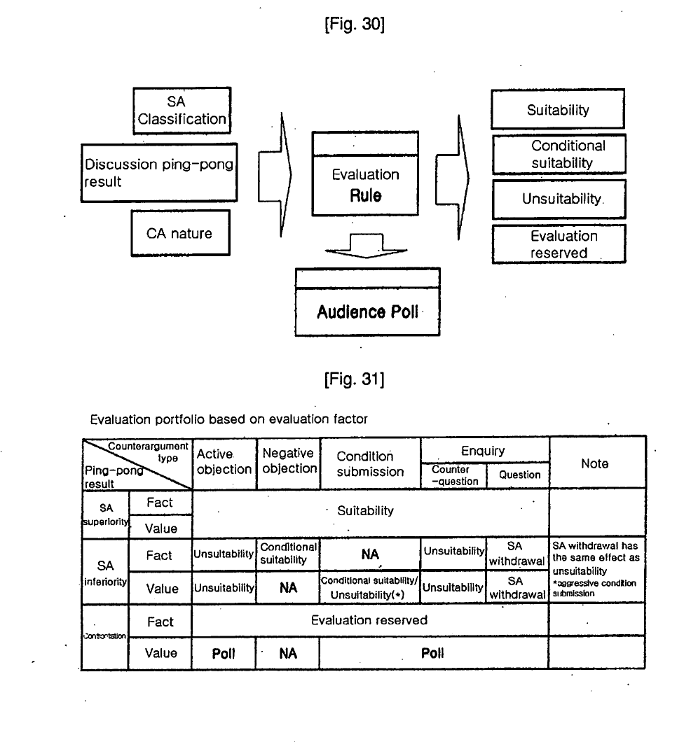

The argument (ground of suggestion) evaluation rule for the discussion ping-pong result is summarized in FIG. 30.

Evaluation Processing Principle
Evaluation on ground of suggestion is applied to all discussions excluding the public discussion without any exception.
Argument evaluation is determined as suitability, conditional suitability, unsuitability, and evaluation reservation by reflecting the three following factors, or an audience poll is performed.
If a suggestion ground structure of an unsuitability-processed argument is of a dependent type, the system automatically processes related arguments as unsuitability.

Argument Evaluation Factor
An argument is evaluated by considering the following three matters, as summarized in FIG. 31:
   Discussion ping-pong result: Superiority and inferiority determination in discussion ping-pong
   Nature of SA: Evaluation is processed depending on the type (fact and value) of suggestion ground classification when discussion ping-pong results are confronted
   Nature of CA: Evaluation is processed depending on the type of three counterarguments such as counter argument, condition submission, and enquiry.

Discussion Ping-Pong Superiority and Inferiority Determination Process
If one side does not suggest a counterargument within the counterargument time limit during discussion ping-pong, it is said as counterargument give-up. The three following ping-pong results are determined depending on whether the counterargument is given up.
   If CA gives up a counterargument; SA superior
   If SA gives up a counterargument; SA inferior
   If any of them does not give up; confronted
If there are a plurality of counterArgs on a specific argument, a counterargument on the plurality of counterArgs is regarded as being given up when a counterargument on one of the plurality of counterArgs is given up.

Argument Evaluation Rule

Suitability Requirement
If SA is superior as a result of a discussion ping-pong, an argument is evaluated as non-conditional suitability.

Conditional Suitability Requirement
If SA is inferior but a counterargument (CA) is a negative counterargument or a conditional counterargument as a result of a discussion ping-pong, an argument is evaluated as conditional suitability.

Unsuitability Requirement
If SA is inferior by active counterargument or enquiry, an argument is evaluated as unsuitability.

Evaluation Reservation
If the discussion ping-pong results are confronted and the SA is a fact, an argument is evaluated as evaluation reservation.

Audience Poll
The audience poll is performed only if SA is a value and discussion ping-pong results are confronted.

Evaluation with Plural Counterarguments Suggested
When a plurality of object arguments are suggested on one subject argument, evaluation on the SA is processed in the following manner according to the type of OA.
   If SA is superior in all counterarguments: suitability.
   If SA is inferior even in any one of active counterargument and enquiry: unsuitability.
   If SA is superior in all active counterarguments but SA is inferior even in any one of negative counterargument and condition submission: conditional suitability with the counterargument as a condition.

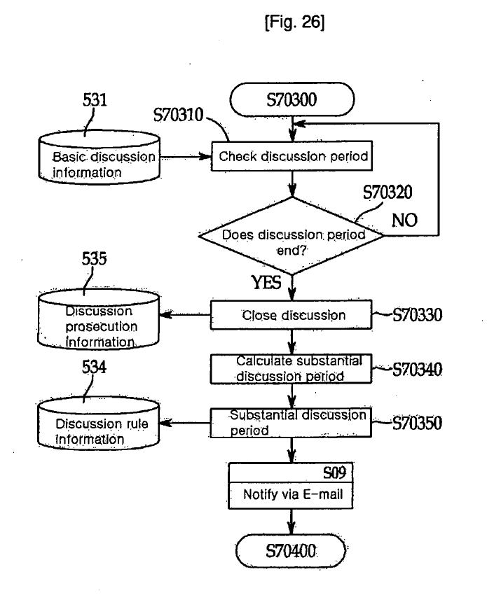

(3) Operation of the discussion closing (S03) in a system mode (S mode) will be described with reference to FIG. 26. The process checks a discussion period to determine whether the discussion period ends (S70300 to S70320).

If it is determined that the discussion period ends, the process closes the discussion and calculates a substantial discussion period to register the substantial discussion period in the discussion rule information 534 of the discussion information DB 530 and notify it via E-mail (S70330 to S70350).

The discussion closing of the system is summarized as follows:

When the discussion period ends, the system performs the following closing process at 24:00 o'clock in a termination date:
Discussion closing: The following is performed to prevent extension of various argument submission time limits:
Discussion closing is stored in discussion prosecution information (disabling a related registration program to register an additional argument).
Actual discussion termination time calculation: A counterargument time limit of a finally registered counterargument is calculated to thereby derive a substantial discussion termination time and store it in the discussion rule information.
Closing notification to all discussion participants: Closing is automatically notified via E-mail. The E-mail is a subsystem for automatically notifying all discussion participants of main prosecuting and variation information for all discussion cases within a discussion period, and is developed as a private E-mail engine for the system.
A recipient of all transmitted messages is automatically retrieved and determined.
There is a function of confirming whether a recipient inspects the messages.
There is connection information between transmission and replay of all messages, thereby allowing case-specific enquiry.
Address management: This uses member information.

Closing
Closing refers to a moderator terminating a discussion when a discussion period is terminated.
However, if there is an argument on which a counterargument time limit has not elapsed even when the discussion time limit has elapsed, actual discussion termination is extended to the counterargument time limit.
If the discussion is terminated, an argument can be no longer suggested.

Evaluation
Evaluation refers to a system or moderator deducing a conclusion from a discussion result under a certain principle to terminate the discussion upon termination of a discussion period.
Evaluation steps includes two steps of \textcircled{1} the system evaluating on each ground of suggestion (SA evaluation) and \textcircled{2} the moderator evaluating on all discussions based on each suggestion ground evaluation (discussion evaluation).
The discussion evaluation may be reserved by an agreement (discussion rule) between stakeholders.
The ground of suggestion based evaluation is automatically processed by the system occasionally when discussion ping-pong on each SA is terminated, but evaluations on all discussions are processed in bulk by the moderator by referring to the evaluation on the ground of suggestion when the discussion is closed.
The evaluated subject argument may be occasionally reserved as information by the moderator in advance in order to prevent an overlapping discussion, and automatically reserved as knowledge by the system when the discussion is terminated.
In the discussion evaluation, evaluation sentence is necessarily produced by the moderator, to which evaluation abstract table about a ground of suggestion by the system is automatically appended. This is shown in FIG. 19.

Discussion ping-pong superiority and inferiority determination processing
If one side does not suggest a counterargument within a counterargument time limit during discussion ping-pong, this is called counterargument giving-up. Depending on whether the counterargument is given up, a ping-pong result is determined as one of the following three results:
   If a CA side gives up a counterargument; SA superior
   If an SA side gives up a counterargument; SA inferior
   If both do not give up the counterargument; confronted
If there are a plurality of counterArgs on a specific argument, a counterargument on the plurality of counterArgs is regarded to be given up when a counterargument on one of the plurality of counterArgs is given up.

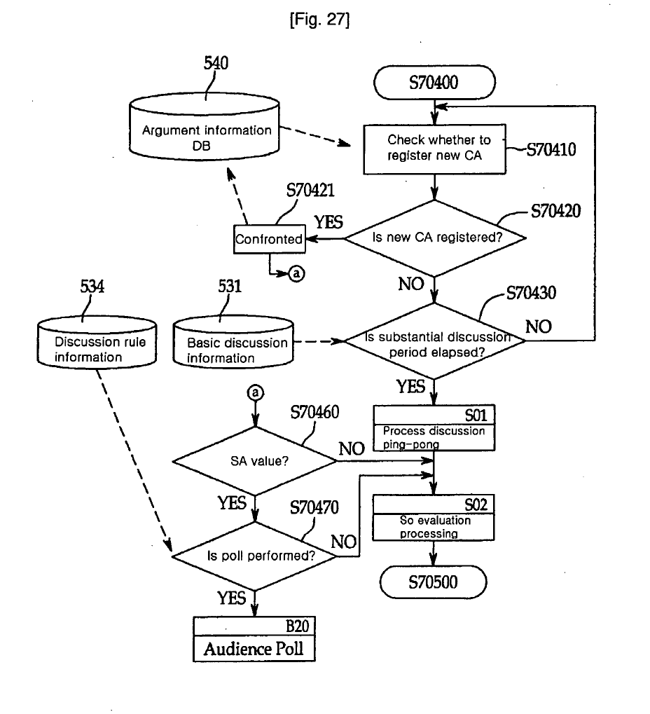

(4) Operation of confrontation evaluation (S04) in a system mode (S mode) will be described with reference to FIG. 27. A process determines whether a new CA is registered (S70400 to S70420).

If it is determined that a new CA is registered, the process registers confrontation in the argument information DB 540. If the new CA is not registered, the process determines whether a substantial discussion period has elapsed. If the substantial discussion period has elapsed, the process performs discussion ping-pong processing and then performs SO evaluation processing.

When there is an SA value, the process performs a poll to process an audience Poll (S70460 to S70470).

Confrontation evaluation processing in the system is summarized, as follows:

Next processing is performed every 24:00 o'clock at a next day from discussion closing processing.
A discussion ping-pong result is determined as confrontation after discussion is closed. That is, a discussion ping-pong result on the SA is processed as the confrontation if a new CA is registered after the closing.
When a confronted SA is a value, an audience poll is performed according to a discussion rule.
Further, if the CA is not registered by the time the substantial discussion termination time has elapsed, the discussion ping-pong result is processed as superiority or inferiority and evaluation processing is finally performed on the remaining SA argument.

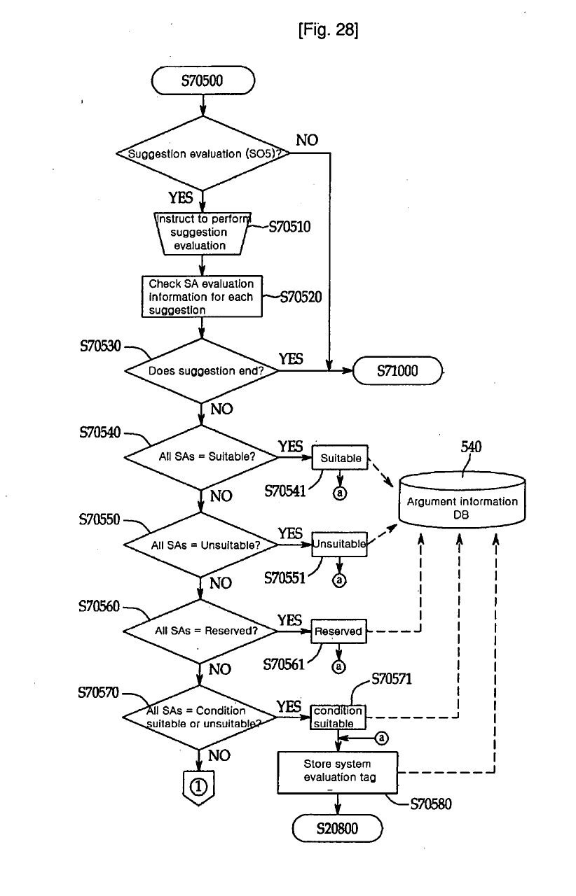

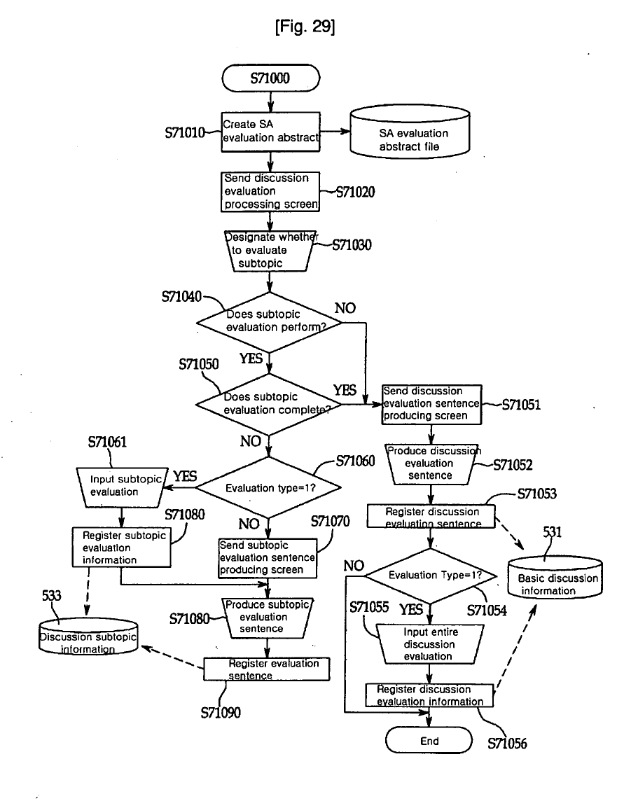

(5) Operation of suggestion evaluation (S05) in a system mode (S mode) will be described with reference to FIGS. 28 and 29. The process checks SA evaluation information for each suggestion in response to an instruction to perform suggestion evaluation, and enters a discussion prosecution information automatic notification mode S09 if the suggestion is terminated (S70500 to S70530).

If the suggestion is not terminated, the process registers a suitability determination in the argument information DB 540 when all SAs meet a suitability requirement, an unsuitability determination when they meet an unsuitability requirement, a reservation determination when they meet a reservation requirement, and a conditional suitability determination when they meet a conditional suitability or suitability requirement (S70540 to S70571). The process stores the determinations on all SA in a system evaluation tag, and creates an SA evaluation abstract table to store them in an SA evaluation abstract file (S70580 to S71010).

Thereafter, the process sends a discussion evaluation processing screen to the terminal, designates whether to evaluate a subtopic, and determines whether the subtopic is evaluated if the subtopic is to be evaluated (S71020 to S71050). If it is determined that the subtopic evaluation is not completed, the process determines whether the subtopic evaluation is Type=1, and inputs subtopic evaluation to register subtopic evaluation information in a discussion's subtopic information 533 of the discussion information DB 530 if the evaluation is Type=1 (S71060 to S71062).

If it is determined that the evaluation is not Type=1, the process sends a subtopic evaluation sentence production screen to produce a subtopic evaluation sentence and registers the evaluation sentence in the discussion's subtopic information 533 of the discussion information DB 530 (S71070 to S71090).

If it is determined in S71050 that the subtopic evaluation is completed, the process sends a discussion evaluation sentence production screen to produce a discussion evaluation sentence and registers the discussion evaluation sentence in the basic discussion information 531 of the discussion information DB 530 (S71051 to S71053).

The process determines whether the discussion evaluation sentence is Type=1, and inputs all discussions evaluations to register discussion evaluation information in the basic discussion information 531 of the discussion information DB 530 if the evaluation sentence is Type=1 (S71054 to S71056).

The evaluation processing of the system is summarized, as follows:

Overview of Evaluation Processing
Evaluation on discussion is manually made by the moderator in view of a meaning and importance of each SA based on the evaluation on the SA. Evaluation may be sub-divided into three steps of suggestion-specific evaluation, subtopic-specific evaluation, and evaluation on all discussions. If there are less points at issue, all discussions may be evaluated in bulk.
Suggestions should be evaluated as suitability, conditional suitability, unsuitability, and reservation regardless of a discussion type.
Evaluation on all subtopics and discussions may be made as the two following types depending on nature of the discussions and an SA evaluation result:
   Type1: Evaluation is made as suitability, conditional suitability, unsuitability, and reservation
Discussion-with-proposition and pro&con discussion
   A Type2: Only an evaluation sentence is simply produced
Evaluation on all subtopics of solution discussions and all discussions
Non-discussion-with-proposition among pro&con discussions: Subtopic evaluation

Evaluation Gist
A system's evaluation abstract table is automatically appended to discussion evaluation regardless of the evaluation type and also an evaluation sentence is produced and appended thereto by the moderator. A superiority or inferiority ground (ground of suggestion) is necessarily specified in the evaluation sentence. In the case of Type1, a requirement for counter-evaluation is suggested.

Evaluation Principle on Suggestion
Evaluation on suggestion is manually made by the moderator but should conform to the following principle:
In the evaluation on suggestion, a corresponding argument should be recognized as a requirement or assumption for suitability satisfaction of the suggestion if there is an unsuitability-evaluated suggestion ground argument even though the suggestion is evaluated to be suitable, unlike the evaluation on the ground of suggestion.

Suitability Requirement
Discussion-with-no-proposition: A primary ground is evaluated to be suitable and the gist of the entire argument is significantly suitable even when some of suggested arguments are unsuitable.
Discussion-with-proposition: Both a proposition and a necessity suggestion of ground of suggestion requirements are suitable.

Even though the problem suggestion and case suggestion are evaluated to be unsuitable, they are not accepted to be a fatal fault for argument's suitability.

Unsuitability Requirement
Discussion-with-proposition: Any one of necessity suggestion and enquiry is unsuitable.
Discussion-with-no-proposition: Some or all of primary ground arguments are evaluated to be unsuitable and the gist of all the arguments cannot be regarded to be suitable.

Evaluation Reservation Requirement
Discussion-with-proposition: Any of the necessity suggestion and the proposition is evaluation-reserved.
Discussion-with-no-proposition: Some or all of primary ground arguments are evaluated to be reserved and the gist of all the suggestions cannot be regarded to be suitable or unsuitable.

Subtopic and Discussion Evaluation
For evaluation for both subtopic and discussion, a moderator should perform evaluation processing depending on the type and produce and append evaluation sentence.
The evaluation sentence is optionally produced by a moderator. In the case of Type1, a requirement that can be evaluated by a counter is suggested.
The system automatically appends evaluation abstract table regardless of evaluation type.

Evaluation Processing:

After a substantial discussion period is terminated, discussion evaluation is performed as follows:
First, the moderator instructs the system to perform possible system suggestion evaluation.
Suggestions that cannot be system-evaluated are classified into a discussion-with-proposition and a discussion-with-no-proposition depending on a suggestion evaluation principle and are performed by the moderator or system.
The system stores, in suggestion the argument, tag information indicating whether the evaluation is evaluation by various evaluation information and systems or evaluation by the moderator.
A determination is made by a moderator as to whether to omit subtopic evaluation.
Evaluation for a subtopic or discussion is held for each type, and moderator's evaluation sentence and system's evaluation abstract table are appended thereto.

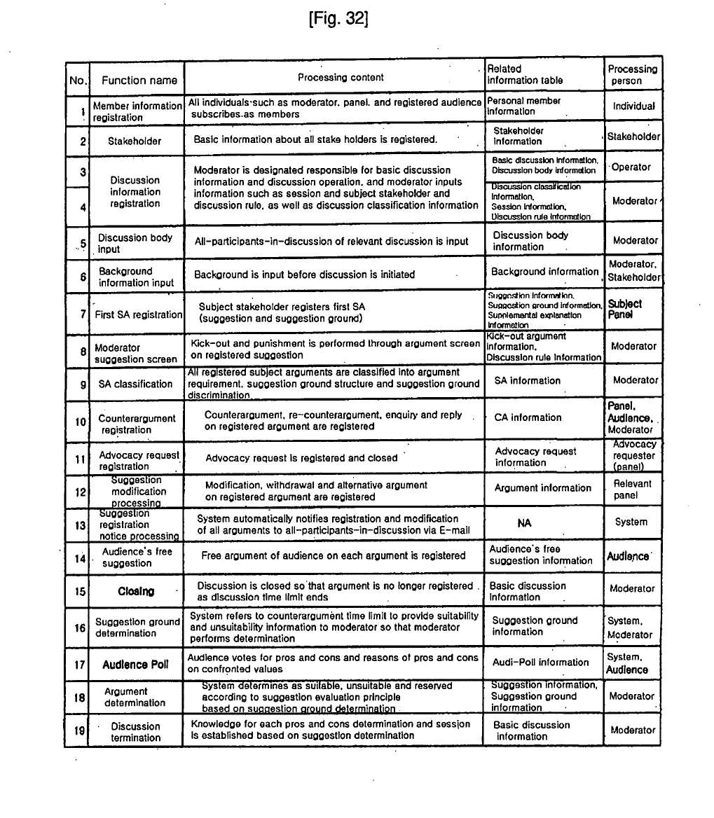

As described above, a processing content of a discussion managing server 100 that performs overall discussion processing is summarized in a table of FIG. 32.

4. Output Function

A class, nature, and a processing procedure of core output materials used in this system will be now described in brief.
This system holds solid nature of all information representations. Accordingly, almost all outputs are provided only on the screen in principle.

(1) General Specifications

Basic screen structure: This includes a main screen and a discussion status screen of a site.
Main screen: This simply provides a list of on-going points at issue together with contents of the points at issue.
List of points at issue: The title of the discussion (three to four on-going discussions)
Content of point at issue: This is a phrase that describes a main point case at issue that can attract interest or on-going confrontation situation appearing during the discussion. The content is a sensational phrase that can attract audience's attention, and may be occasionally changed according to discussion prosecution situation.
Discussion screen: Main prosecuting situation of each point at issue should be recognized at a glance in the following manners:
Highlighting a main argument, confronted argument, etc.
Highlighting a superior suggestion and a new suggestion

Main Menu of Main Screen
Purport of site: This represents purport, philosophy, etc.
Discussion prosecution method: Help for a discussing method, attention, etc.
Panel registration and member registration (registration stipulation and registration processing)
Providing information: This provides past discussion and various information.

Information Providing Function
This function makes actualized or supported values in all suggestions as information, classifies the information, and makes the information as a DB to be provided to all audience.
Classification information—discrimination (information or value), a title of discussion, date, classification (politics, society, health, education, national defense, etc.), originator classification (arguing person and occupation), etc.
Information structuring—This indicates a level of information. Lower level information that becomes a reason or source of the information is provided on a sub window screen when being clicked.
Inputting classification information—allowing for defining and inputting classification information.
Search function (logical search)

(2) Screen Processing

Consideration
The two following matters should be considered to produce the output.
   Much information is accommodated in a typical web screen due to its size.
   Chaining of a counterargument and further counterargument on counterarguments, and upper and lower level classification (Indentation, level and position) on a phase II screen.
The following special processing is performed to solve the problems.

Special processing for screen arrangement
A full screen and a up and down scroll are used by developing a viewing tool independent from a web browser using the Active X to accommodate a number of objects on one screen.

Screen Size
The size of a screen is automatically calculated depending on the number of registration objects.
The size of the screen is expanded infinitely by scrolling left, right, up and down depending on the number of registration objects.

Processing in a Number of Object Arguments
The pro&con discussion can apparently determine pro&con-divided stakeholders while the solution discussion encounters multipolarized counterarguments on a specific point at issue. However, since the counterargument becomes another dimensional counterargument if counter parties differ in a specific SA, which is a detailed point at issue, the process recognizes another point at issue and screen-processes it as a separate point at issue.

Visualization Rule
A vertical class of respective arguments is called a position, and a horizontal class is called a level.
The vertical position determines a class according to a generation sequence of arguments.
   Position 1; Arg-n & Arg-nn

Position 2; Arg-nn-n & Arg-nn-nn
The horizontal level indicates a step from a top step and makes a determination based on the following rule:
   A counterargument on all subject Arg-n and object Arg-n is positioned on the same level, and a counterargument on an object argument and counterArg-n goes down by one step.
A counterargument on all counterarguments and further counterarguments is determined by a color of a representative word caption, and a further counterargument (or counterargument) on a specific counterargument (or further counterargument) is classified depending on a position. Thus, a chaining arrow is not used.
Arg-n+1 at the same position as the Arg-n does not appear on an upper level until there is a counterArg on the Arg-n.

(3) Screen Representation of Ground of Suggestion (Argument Presentation)

Processing Argument Object Screen
All arguments objects such as SA, counterargument and the like includes information as shown in FIG. 34 as presentation identification from which various information and prosecuting situation can be recognized, in addition to a basic argument content.
   Suggesting person and attack object person
   Counterargument information: counterargument and counterargument-id
   Evaluation information: In the case of an initial SA
A representative word is indicated to overcome limitation to the size of the screen, and an argument body may be viewed on a sub-window through clicking a representative word caption.
Correspondent, suggesting person and suggestion time are provided through a pop-up menu activated by right-clicking after an object is selected.
The counterargument information is identified by a background color of the argument object (the color is separately defined).
Counterargument situation information indicates whether there is a counterargument or not.
Evaluation information corresponds only to the case of an initial SA and is indicated, as follows:
Evaluation is identified by a background color depending on suitability, unsuitability and reservation, and a color of counterargument information is overwritten.
In the reservation, counterargument information is indicated by a white background.
The number of argument object letters is limited to up to 25 letters×2 lines/10 fonts in Korean, and a subject argument and a counterargument can be represented on one screen.

(4) Discussion Ping-Pong Situation
As dispute such as multiple suggestions and counterarguments, repeated counterarguments, further counterarguments and still further counterarguments is fierce, numerous arguments ping-pongs. A screen structure represented in such a manner that everyone easily recognizes the dispute is important in inducing an objective and reasonable discussion result upon all discussions.
Since many arguments cannot be all accommodated in on screen, screen presentation is structuralized with two phases, as follows:

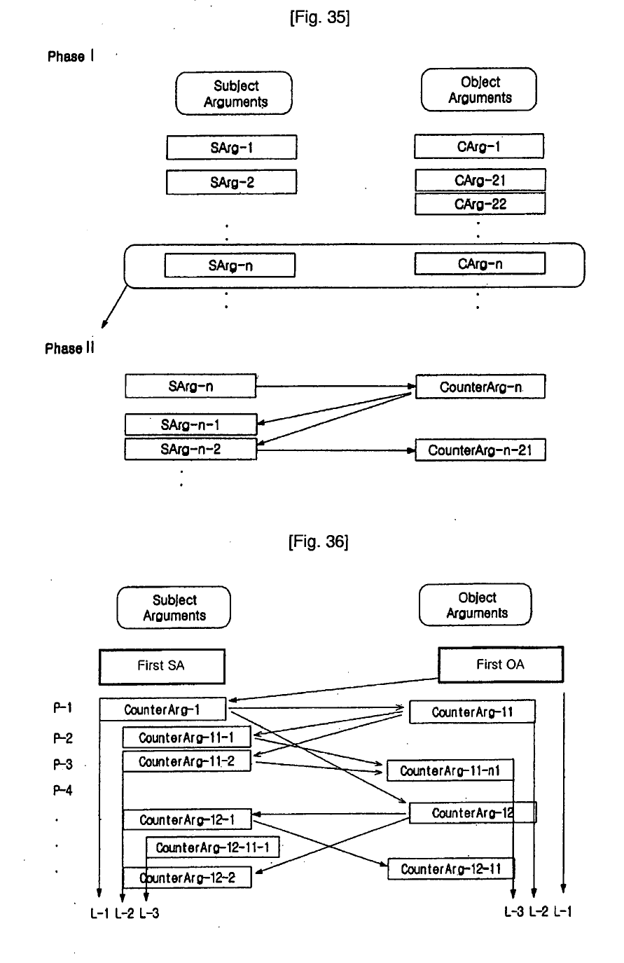

PhaseI: Initial subject arguments and object arguments as counterargument thereon are represented as shown in FIG. 35 so that entire discussion ping-pong situation is recognized.

PhaseII: All arguments such as a counterargument, a further counterargument, and a still further counterargument on specific subject argument are represented as shown in FIG. 35 so that ping-pong situation of specific SA (detailed point at issue) is recognized.
An enquiry function is provided that can enquire only all CAs on a specific argument, in addition to the enquiry presentation.

(5) Class of Main Outputs

Discussion Status
Output showing the overview of various discussions which are performed in a site.
   a discussion list is provided as on-going, on-going scheduled and termination (past).
   Subject and subtopic, discussion initiation date and discussion period, stakeholders, panel, and moderator's personal information are provided for each discussion.

Discussion Ping-Pong Situation
A screen from which a detailed point at issue (suggestion) of each discussion and counterargument ping-pong situation can be recognized.
There are a screen showing a situation of suggestions and counterargument on all discussions and a screen showing a situation of all ping-pong situations for each selected detailed point at issue.

Processing an Argument Object Screen
Technical specification of a screen output for an argument object applied to all outputs.

(6) Visualization-processing of discussion ping-pong will be described with reference to FIG. 36.
A subject counterargument is placed on the left and an object counterargument is placed on the right.
A vertical class of respective arguments is called a position and a horizontal class is called a level. The system analyzes all arguments generated on an enquiry time point to calculate the position and the level.
The vertical position is a class indicating an order of a counterargument, and the horizontal level is a class indicating a generation sequence of arguments. The following rule is applied thereto.
   Position
A specific subject counterargument and an object counterArg as a counterargument thereon are placed at the same position, and a counterargument on the object counterargument, subject counterArg, is placed down one step.
If there are a plurality of counterArgs on a specific argument, the counterArgs are placed at the same position.
   Level
An argument generated later cannot have a level coming first compared to an argument generated first.
If there are a plurality of counterArgs on a specific argument, a level goes down.
A counterargument on all object counterArgs, subject counterArg levels down without condition.
A counterargument on all counterarguments and further counterarguments is determined based on a color of a representative word caption. Further, since counterArgs on a specific argument are apparently identified based on a position and a level, a connection arrow is not used.

The entire discussing method of the present invention is further summarized, as follows:
In this system, it is assumed that all discussions are performed on a detailed case regardless of the type of discussions, in which one side first suggests his or her argument and a correspondent side retorts it.
In this case, a stakeholder and a panel first suggesting an argument are called a subject party and a subject panel, respectively. Further counterarguments of a subject panel on initial arguments and counterarguments suggested by the subject panel are collectively called as subject arguments. On the other hand, a stakeholder and a panel suggesting counterarguments on the subject argument are called an object party and an object panel, respectively. A counterargument of an object party on the subject argument is called an object argument.
As in the discussion-with-proposition, a limit stakeholder first suggesting an argument on a core case of all discussions is called an object stakeholder (debate subject party) for the discussion. As in the discussion-with-no-proposition, a stakeholder suggesting a specific suggestion on a detailed case is called an object stakeholder (argument subject party) for the argument.

Consideration. Who will first suggest his or her suggestion?
In the discussing method, the two following elements should be considered:
   Who will first suggest his or her argument?

In most discussions, who will first suggest his or her argument is a very sensitive case for the stakeholder.
What is an effective method showing screen presentation to an audience?

It should be considered on the screen presentation that any argument is effectively shown as a subject argument in view of a nature of an issue subject for the audience to easily understand on-going discussion.
Considering the foregoing problem, the system uses different performing manners depending on whether the discussion is the discussion-with-proposition or the discussion-with-no-proposition, as in FIG. 39.

Determination of Subject Party
In all discussions-with-proposition, a stakeholder, i.e., a suggesting person desiring to establish or enforce (suggest) a specific policy or proposition establishment becomes a debate subject party of all discussions in view of the nature of the discussion-with-proposition.
In the discussion-with-no-proposition, a subject party of all discussions is not determined according to dispute generation nature unlike the discussion-with-proposition but a specific stakeholder may be a subject party or an object party according to the nature of a subtopic of the discussion since various detailed discussion topics are generated in the discussion.
The determination of the subject party based on the nature of the subtopic is designated by the moderator but the designation may be reserved according to the nature.
The argument subject party may be designated for each subtopic by the moderator. The subject party may become by optionally suggesting an argument in discussion initiation or during the discussion. However, if the debate subject party is determined, the other party cannot be a subject party in the discussion, as in the discussion-with-proposition or pro&con discussion.
While the subject panel may omit a suggestion in each subtopic of the discussion, the subject party should register at least one suggestion in the subtopic of the discussion and all subject panels should register at least one argument in all discussions.

Screen Presentation Principle for Discussing Situation (See Visualization of Discussion Status)
Screen presentation for discussing situation has the following principle:
A subject argument and object argument are displayed together on a screen.
Argument position: all subject arguments are placed on the left and all object arguments are placed on the right.
Point-at-issue-specific grouping: Presentation for identifying detailed points at issue (SA), i.e., an individual SA and a corresponding OA as one group is considered.
Chaining of points at issue: It is considered that all connection relationships on discussion ping-pong such as a specific argument and a corresponding counterargument and further counterargument are recognized.

Argument Structuring Break-Down
Arguments may be classified into a specific subject argument and a corresponding counterargument.
For interactivity of the discussion, this system first breaks down and itemizes all newly registered suggestions for each detailed point at issue, as follows, and allows the counterargument to be suggested for the items.

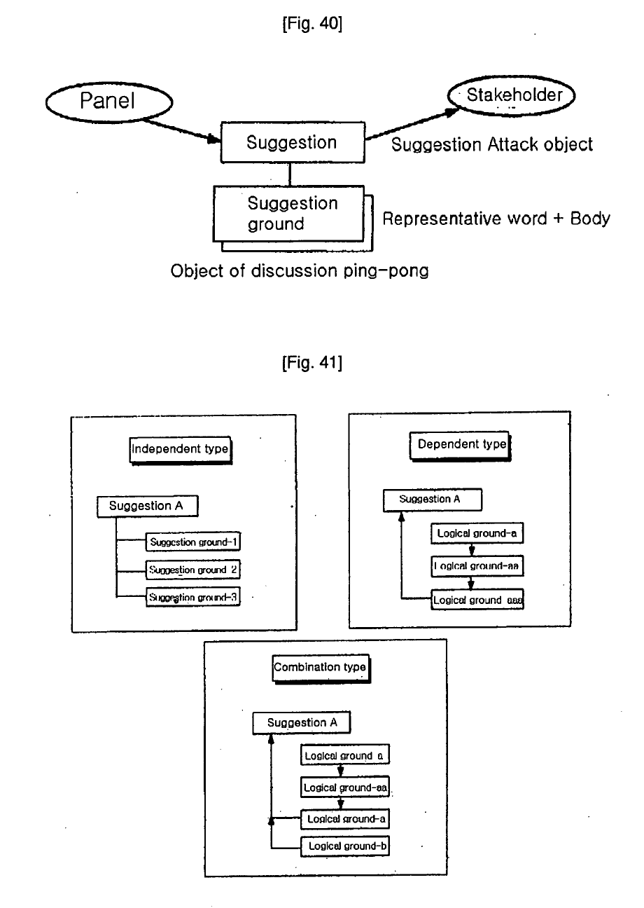

Argument Break-Down
All new arguments are divided into a suggestion that submits specific suggestions and suggestion grounds that supports the argument as in FIG. 40, allowing each to be briefly and concisely registered in a recursive manner.
The suggestion often represents a ground of suggestion but is an abstract content, not an object of a discussion (counterargument). The ground of suggestion supporting the suggestion is the object of the discussion.
The ground of suggestion is composed of a representative word (title) and a body. The ground of suggestion may be composed only of the representative word excluding the body when the content is short.
There is no limitation to the size (the number of letters) of the argument to register, but the argument should be broken down for each point at issue for the sake of an interactive discussion importantly sought by the system and cannot be a long sentence.
For persons who do not adapt to structuring and cannot submit an argument, a long-sentence argument is accepted and the moderator has a conference with an argument suggesting person to structuralize the long-sentence argument and reflect it to the discussion.
Argument registration may be classified into initial suggestion registration that is initially made and registration of a suggestion obtained by exchanging and sharing a number of arguments and information in the discussion process or obtained by generating and adding a new argument.

Attack Object
In all suggestions and suggestion grounds, attack objects (stakeholders) may be designated. The attack object designation refers to designating a correspondent that should suggest a counterargument on the relevant suggestion.
If the attack object is set to the suggestion, the same attack object is regarded to be designated for all suggestion grounds dependent to suggestion.
Since the pro&con discussion is a discussion between stakeholders in which pros and cons are obvious, designation of the attack object is omitted and the system automatically designates the attack object internally.

Structure Registration Statement Editor
All suggestions and suggestion grounds are broken down and registered in a structuralized format by a program of the system so that information-making and interactive discussion is possible, as in FIG. 37.
To this end, the system develops and supports a special statement editor having the following function, which may be available in an off-line mode.
The statement editor has the function of breaking down a descriptive sentence into items and objectifying suggestions and suggestion grounds into argument structures.
The statement editor has a viewer window and an argument input window.

Arguments input in the argument input window is displayed on the viewer window.

Supplemental Explanation Function (“Reference Window”):

Each argument such as a suggestion or a ground of suggestion is prevented from being a long sentence by providing a special function of inputting supplemental description data such as explanations on and concepts of used specific terms or phrases as independent sub-objects. The reference window may allow other specific arguments to be directly referenced when the argument is rebutted.
If the input is completed, the input content is stored in a personal computer (PC) of an inputting person, and uploaded to the DB via Internet in response to inputting person's selection.
The registered argument may be necessarily modified in an on-line mode.
The statement editor is processed to be automatically downloaded.

Definition of Terms
Argument: All objects of broken-down detailed points at issue (argument, ground of suggestion, counterargument, further counterargument, enquiry, etc.)
Suggestion argument: This refers to an object of the above-defined suggestion.
Suggestion ground argument: This refers to an object of the above-defined ground of suggestion.
Suggestion: one suggestion suggestions and suggestion grounds argument belonging to it are collectively called an argument.
Subject argument: Initial suggestions and suggestion grounds (“SAs”) suggested by a subject panel.
Object argument: all counterarguments (“SAs”) suggested by a subject panel.

Subject panel: A panel that first submits an argument (suggestion).

Object panel: A panel who rebuts an argument of a subject panel.
Statement: An argument is also represented as a statement according to contexts.

Registration of Suggestion
There is no limitation on the number of suggestions that can be registered in one subtopic of the discussion.
At least one suggestion ground argument may be registered in each suggestion.
All suggestions are opened to the public immediately after registration. However, all registered arguments may not be opened to audience and other stakeholders by the time of an argument submission time limit through agreement between all discussion participants according to nature of discussion.
In view of the discussion time limit, the initial suggestion registration should be registered within a time limit determined according to an agreement between all discussion participants in advance (See Argument submission time limit).

Object Structure of Suggestion and Suggestion Ground Arguments
The suggestion argument is a conclusive suggestion abstracting all suggestion grounds, not the object of the discussion. A detailed suggestion ground argument supporting the suggestions is an object to be actually discussed. Accordingly, the system should refuse to register a suggestion argument having no suggestion ground argument.
Both the suggestion and the suggestion ground arguments have the same object structure as in FIG. 34.
The suggestion argument is composed only of a representative word and has the following nature.
It can include a content or manifesto abstracting all suggestion grounds, metaphorical suggestions, representation with a public relation, and the like.
The suggestion ground argument is composed of a representative word and a body, and the body is indicated by a sub-window object.

Registration and Nature Classification of Suggestion Grounds
The ground of suggestion is a minimal object of a point at issue, broken-down, that becomes the object of an actual discussion.
Only suggestion grounds for a pre-registered suggestion may be additionally input. Suggestion grounds for a new suggestion may be designated with specific suggestion grounds of conventional other suggestions. To this end, the system provides a list of suggestion grounds to be selected.
If the ground of suggestion is represented in the same content level as a subtopic of the discussion, the ground of suggestion may be directly registered without submitting a separate suggestion in the subtopic of the discussion. In this case, the system internally produces and manages a dummy suggestion.
Even though the suggestions and suggestion grounds are broken down and registered, the following matters should be considered in systemizing a discussion prosecution or discussion termination process.

\textcircled{1} Correlation between suggestion grounds: this is hereinafter referred to as “ground structure.”
This is correlation in a logical structure between the suggestion grounds and is referred to when the argument is evaluated.

\textcircled{2} Nature of suggestion grounds: this is hereinafter referred to as “ground classification.”
This is classification based on nature of a content of each ground of suggestion, which is a factor determining the evaluation method.
All suggestion grounds should be necessarily applied to the classification. If they are not applied to the classification, it means that the ground of suggestion is a ground of an illogical argument about which interactive discussion is impossible, and is not suitable argument. In this case, the moderator should coordinate through conference with the panel, and kicks out the argument if the coordination fails.

Ground Structure:
Suggestion grounds may be classified into an independent type suggestion ground, a dependent type suggestion ground, and a combination type suggestion ground depending on structural nature.
Ground structuring for registered arguments is performed by the moderator and referred to by the system when the subject argument is evaluated.

Ground Classification:
All suggestion grounds may be classified into the following three cases depending on nature of a suggestion content:

\textcircled{1} The case where specific information or fact is represented,

\textcircled{2} The case where definition or specific logical suggestion of certain value, concept, model and the like is represented, and

\textcircled{3} The case where a specific proposition, a policy or the like is suggested as in the discussion-with-proposition.

Type of Suggestion Ground Structure
A number of suggestion grounds dependent on a specific suggestion may be classified into independent suggestion grounds (independent type), logically associated dependent suggestion grounds (dependent type), and combination type suggestion grounds thereof depending on each content, as in FIG. 41. Preferably, the combination type is produced as an independent type and a dependent type by dividing an upper level suggestion, if possible.
The panel and the audience do not have to care the structure of the ground of suggestion at all. The system designates the independent type as default, and modifies and designates it according to content when the moderator screens the argument. The ground of suggestion is referred to when the argument is finally evaluated and the system reflects it to the presentation of the argument depending on the moderator's designation.

Independent Type
In the independent type, respective suggestion grounds are independent from each other. Incorrect suggestion grounds somewhat affect a theoretical ground of the argument but do not cause the argument to be fundamentally denied.

Dependent Type
The dependent type refers to a deductive (or inductive) logic prosecution type suggestion ground in which a ground of a final argument is based on respective suggestion grounds. Listing problems and establishing an alternative plan is said to be a representative dependent type. Since each argument is composed of a ground of suggestion and a logical ground of the ground of suggestion, the ground of suggestion and/or suggestion itself in the dependent type are denied if some of logic grounds are denied.
The system should regard the logical grounds as the suggestion grounds.
The dependent type ground structure may be registered as one ground structure without being divided into the logical ground and the ground of suggestion according to panel's capability. In this case, the moderator is allowed to adjust an optionally registered argument, including the combination type. In particular, in the case of a ping-pong discussion in which unspecific persons participate, the moderator will have to adjust most of registered arguments.
The moderator should a dependent relationship for each dependent type suggestion ground. That is, the moderator should clearly designate all arguments that become the direct logic ground of the suggestion ground.

Type of Suggestion Ground Classification: Factor that Determines an Evaluation Method Upon Evaluating a Ground of Suggestion

Measuring suggestion and non-measuring suggestion
As shown in an example described below, if the ground of suggestion is represented as a measuring one or designates a detailed category, this is called a measuring suggestion, and otherwise, it is called a non-measuring suggestion.
In general, a suggestion representing a specific fact or information will be a measuring suggestion, and a suggestion representing definition or value, tone and the like of a specific concept, requirement, model and the like will be a non-measuring suggestion.
In this system, the proposition is regarded as a measuring suggestion since the proposition is a content in a detailed category.
However, if the nature of the ground of suggestion is represented in a measuring manner even though it is a value or tone of an argument, this is regarded as an actual suggestion. A fact represented in a non-measuring manner is regarded as a tone (value) of an argument.
If the ground of suggestion is a non-measuring suggestion even though the ground of suggestion is a fact (information), the suggestion may be a suggestion having a logical defect. However, if measuring representation is omitted or estimated in an implied manner or on a context, the suggestion may be a measuring suggestion.
Even though a realistic suggestion is a non-measuring suggestion, the moderator cannot kick out an argument through argument screen. The suggestion can be processed to be unsuitable only by the counterargument from other panels.
This system assumes that all non-measuring suggestions have assumptions for satisfying the suggestion.

<Case of Ground Classification>
If one nation people's consciousness level is not high, democracy cannot be insisted to be optimal identity for operating a nation (tone of an argument).
A doctor should not refuse medical treatment of a patient even though the patient cannot pay a medical fee (value).
Our people still attaches great importance to industrial development over environment (tone of an argument since it is a non-measuring one): about thirty percentages of the people prioritizes environment over industry (fact since it is a measuring one)
With a current educational technique of information communication, it is impossible to properly educate an information-alienated class (non-measuring tone of an argument): This is a non-measuring suggestion and a tone of an argument since detailed description of a reason that a current educational technique of information communication cannot properly educate the information-alienated class is lacking.
Our people have recognized that withdrawal of U.S. military in Korea causes severe threat to the national defense from the North Korea (non-measuring or measuring): For measuring, it should be specified what percentages of the people have such consciousness, and the argument may be construed to be a suggestion in which half the people or more have such thought.
The purpose of a labor union's activity (establishment) should be necessarily restricted to private economy activity (non-measuring value): arguing definition of limitation on the necessity of the labor union.
As of 2003, Korea is ahead of Japan in all fields of typical information communications such as information communication device diffusion rate, communication infrastructure environment, and information communication application technique, excluding some information communication equipment parts.

Suitability Determination Based on Nature of Fact (Information) and Tone (Value)
If arguments of opponents concerned in a specific SA (subject argument) are so similar in persuasiveness that it is difficult to determine superiority and inferiority of the arguments, a method of determining suitability based on nature of suggestion ground classification varies as follows:
Since a fact-based SA is a suggestion that is based on a specific fact, it has nature that cannot deny genuineness of the suggestion if there is no apparent ground (counterargument) that can deny a counter fact or a fact.
Accordingly, if a specific ground of suggestion is true, the arguments of opponents concerned cannot be justified by decision-by-majority, unlike the tone or the value, even though it is difficult to determine superiority and inferiority of the arguments. However, since the tone or the value is a variable element which is dependent on a temporal, cultural, or social situation, it has nature that can be justified by the decision-by-majority if the points at issue are confronted.

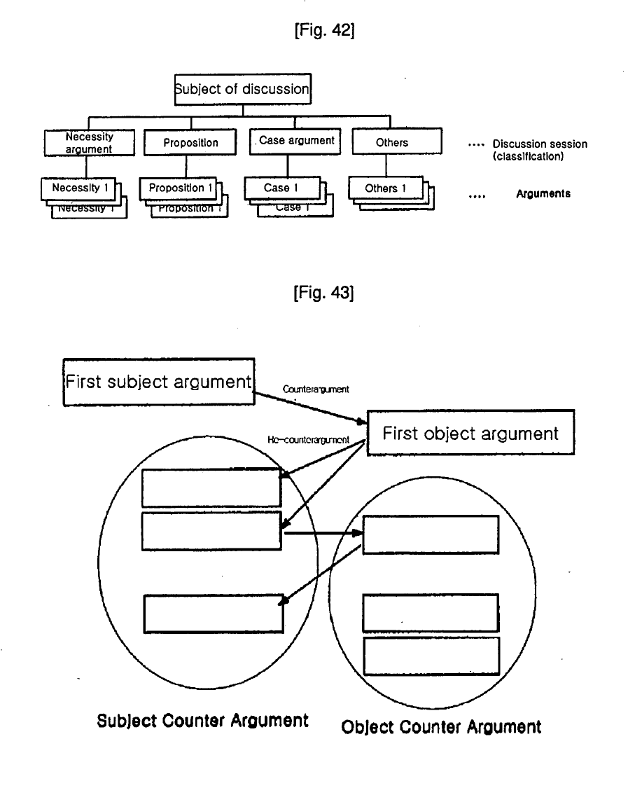

Suggestion Registration in Discussion-with-Proposition
In the discussion-with-proposition, all initial registered SAs, suggestions, may be classified as in FIG. 42. That is, the following suggestions are included in view of a satisfying requirement of the initial SA.
The system recognizes and registers the classification of these suggestions as subtopic information.
   Suggestion proposition (referred to as proposition): Submitted (suggested) detailed propositions
   Necessity suggestion: This refers to contents of the necessity such as effects of the proposition, merits and the like, the present arisen problem, and an alternative plan (effect and merits)→Reverse effect and drawback
   Expected problem and alternative plan submission: This refers to contents about problems arisen upon executing the proposition (or expected to be arisen), and an alternative plan, identifying the arisen one and an expected one.→Alternative plan

The expected problem stated herein is not a current problem for causing the necessity but a problem expected to be additionally arisen when execution is made according to the suggestion. For example, in a discussion of abolition of the-master-of-a-house system, a problem arisen by the-master-of-a-house system means necessity of the abolition, and an expected problem in a ground requirement refers to a problem expected to be reversely arisen by abolishing the-master-of-a-house system.
Case suggestion: Specific cases supporting a ground of suggestion include case application (country, person, group/organization, etc.), content, effect, and reference.→Reverse case
Others: Dummy or other contents.
Necessity suggestion and suggestion proposition should be necessarily registered (hereinafter, referred to as “suggestion requirement”).

If there is no necessity submission and suggestion proposition, the system notifies a moderator of all suggestions and the moderator precisely screens a registered SA to obtain a satisfying requirement of the suggestion.
All suggestion propositions should designate items of the necessity suggestion resulting in the proposition, and a connection relationship.
Since the necessity suggestion becomes a ground of the suggestion proposition, the argument proposition is denied if the necessity is denied as a result of the discussion ping-pong.
The system automatically registers suggestion ground classification for all suggestion propositions (proposition) as a proposition and suggestion ground classification for case suggestion as a fact, and other necessity suggestion, expected problems, alternative plans and the like are determined by the moderator according to a detailed content.
The expected problems and alternative plans are suggested by an suggesting person. The person may suggest an alternative draft and the rebutting person may suggest a counterargument.

Conclusion in the Present System
This system has different features from the conventional discussion in an operating manner, as follows:

\textcircled{1} All arguments are break down for each detailed point at issue.

\textcircled{2} The system performs an interactive discussion based on a certain discussion rule so that the point at issue clearly proceeds.

\textcircled{1} The moderator filters all defective arguments so that only a meaningful healthy argument is reflected.
It is not concluded that no counterargument on a specific argument until a certain time limit has elapsed means that the argument is correct.
Accordingly, the system performs the following discussion conclusion processing by referring to a discussion prosecution result.

A Evaluation of Subject Argument:

The system automatically processes evaluation such as suitability and unsuitability to seek conclusion by considering nature of the SA and CA around a discussion ping-pong result with respect to all SAs (detailed points at issue).

A Evaluation of all Discussions:

For argument, subtopic or all discussions, the moderator performs the evaluation by considering evaluation of the SA, opens the evaluation to the audience, and specifies that the suitable arguments are problems and solution premise conditions for the conclusion of the discussion.

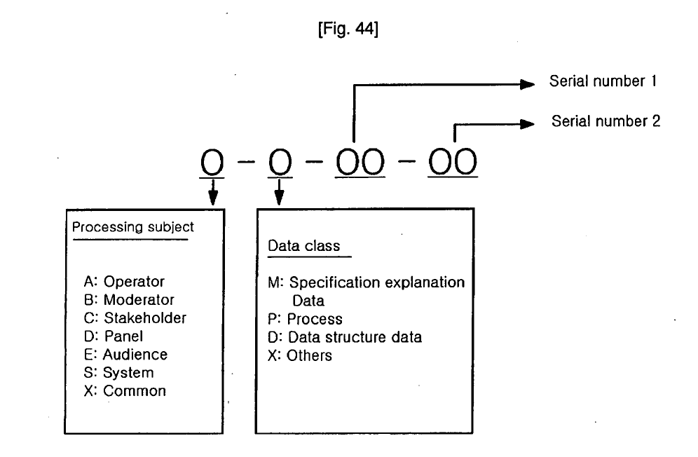

FIG. 44 illustrates a document identification notation structure according to the present invention.
Various description materials and specifications herein use identification notations having the following structure in common.
   Processing object: Operator, moderator, stakeholder, panel, audience, system, and common
   Data class: Specification and rule description material, process (processing flow), and data structure material
   Serial number 1: Data class-specific serial number
   Serial number 2: Lower level detailed classification number of specific material class

Meanwhile, the method according to exemplary embodiments of the present invention includes a billing step of providing certain money to all discussion participants subscribing as members or prosecuting discussion ping-pong, and an authenticating step of verifying all discussion participants. This is well known in the art and detailed description has been omitted.

In addition, detailed description of typical known techniques, not related to the gist of the present invention, has been omitted.

While the present invention has been described with reference to exemplary embodiments thereof, it will be understood by those skilled in the art that various changes in form and detail may be made therein without departing from the scope of the present invention as defined by the following claims.

### INDUSTRIAL APPLICABILITY

With the above-described system and method for Internet-based discussion according to the present invention, it is possible to structuralize arguments and suggestions of all levels of society for each nature so that points at issue are focused and to deduce a conclusion through interactive point-at-issue ping-pong such as counterarguments and further counterarguments, such that a scientific reasonable conclusion is deduced by cycles such as agreement, interest, and deduction and optimal direction, not perfect conclusion of discussion, is sought. Optimal direction opens certain processes based on collected information and values to the public, deducting a conclusion having certain vital power and limitation, not an absolute conclusion.

According to the present invention, it is possible to build powerful journalism capable of realizing new substantial society reform so that new politic mechanism is created and to reflect healthy arguments of all levels of society by providing a novel, innovative model, leading to healthy public arguments and correcting prejudiced consciousness of people.

In addition, the discussion system of the present invention can be utilized to the following:
Open debate about a social issue
Internal pre-evaluation system for a business program, a policy and an enforcement draft in a specific group
Public hearing about government agency's various laws and tentative plans
Public conference for seeking solutions and propositions to various problems of enterprises and groups
Decision-making systems for outstanding management problems in enterprises and public organizations

1. An Internet-based discussion system supporting decision-making through Internet discussion, the system comprising a discussion managing server for performing interactive viewpoint ping-pong for each detailed point at issue of the subject of a discussion according to a certain rule predefined for each type of discussion by panels having access to the server via the Internet, deriving a conclusion by an evaluation rule defined depending on nature of each viewpoint and a ping-pong result, and registering and managing discussion information, discussion ping-pong information, and discussion result deduction information, as well as personal information of all discussion participants, in a database,
wherein the discussion managing server is connected with a number of panel client terminals over the Internet, and with a number of audience client terminals for participating in a public viewpoint poll, suggesting a free viewpoint on a discussion ping-pong situation processed according to the discussion ping-pong between a number of the panels, and asking a panel's viewpoint or participating in the discussion ping-pong in response to a panel's advocacy request.

2. The system according to claim 1, wherein the discussion managing server comprises:
a master code information DB that stores reference information for various classifications on a discussion;
a member information DB that stores basic information about all members;
a discussion information DB that stores each discussion object related information such as discussion division and classification, discussion prosecution rules and prosecuting situation, which define nature of the discussion, as well as information such as a title and a subtopic of the discussion;
an argument information DB that stores argument information such as all suggestion grounds, counterarguments and enquiries produced in a discussion process; and
a discussion body information DB that stores all participants-in-discussion information for each discussion extracted from the member information DB.

3. The system according to claim 2, wherein the member information DB includes stakeholder information about specific organizations or groups; and individual member information about individuals such as a moderator, panels and audience members.

4. The system according to claim 2, wherein the discussion information DB includes basic discussion information for identifying each discussion; various discussion type classification information for the discussion; discussion rule information for defining all operating rules for the discussion; discussion prosecution information for recognition of prosecuting situation of the discussion; and discussion subtopic information for classification for each discussion case.

5. The system according to claim 2, wherein the argument information includes various argument information having discussion background information and all suggestions, counterarguments and enquiries produced in a discussion process; additional information such as various evaluation information and kick-out information; and background information 543 and kick-out 544.

6. The system according to claim 2, wherein the discussion body information DB includes essential registration information of stakeholders, panels and a moderator; and audience information for restricting selective visit or participation in the discussion.

7. The system according to claim 2, wherein the discussion body information DB stores information extracted from the member information DB by an operator, a moderator or stakeholders when the discussion is determined.

8. (canceled)

9. A method for Internet-based discussion that combines discussions of all participants-in-discussion having access via Internet to deduce a conclusion, the method comprising the steps of:
automatically connecting a terminal to a discussion managing server and sending a discussion body-specific menu screen to a terminal in response to an access request from all discussion participants; and
determining whether an operator is selected from a group consisting of an operator, a moderator, a stakeholder, a panel, an audience on the discussion body-specific menu screen sent to the terminal.

10. The method according to claim 9, comprising the steps of:
when the moderator is selected in the determining step, sending a moderator menu screen for discussion body registration, discussion operating information registration, discussion's subtopic registration, background information registration, viewpoint screen, advocacy request review and moderator evaluation to the terminal;
if the discussion operating information registration is selected on the moderator menu screen sent to the terminal, sending a discussion information registration screen to the terminal;
inputting discussion operating information such as a discussion classification and a discussion field on the discussion information registration screen sent to the terminal to register the discussion operating information in the discussion information DB; and
determining whether the discussion classification registered in the discussion information DB is a main discussion and inputting discussion classification information and discussion rule information when it is the main discussion to register the information in the discussion information DB.

11. The method according to claim 10, comprising:
a discussion class determining step of, when the discussion body registration is selected on the moderator menu screen sent to the terminal, determining whether a discussion class registered in the discussion information DB indicates a panel discussion;
a step of, when the discussion class indicates a panel discussion, sending a discussion body information registration screen to the terminal;
a step of inputting discussion body information such as a stakeholder and a panel on the discussion body information registration screen sent to the terminal to register the information in the discussion body information DB;
a step of, when the discussion class does not indicate the panel discussion, determining whether the discussion class indicates a closed discussion or a private discussion; and
a step of, when the discussion class indicates the closed discussion or private discussion, inputting specified audience on the discussion body information registration screen to register the audience in the discussion body information DB.

12. The method according to claim 10, comprising:
a discussion classification determining step of, when the discussion subtopic registration is selected on the moderator menu screen sent to the terminal, determining whether the discussion classification registered in the discussion information DB indicates a discussion-with-proposition;
a step of, when the discussion classification does not indicate the discussion-with-proposition, sending a subtopic information registration screen to the terminal;
a step of, by a moderator, inputting subtopic information and subtopic-specific subject party on the subtopic information registration screen sent to the terminal to register the information in the discussion information DB;
designating the subtopic-specific subject party and counting a suggestion submission time limit from a designation date to register it in the discussion information DB; and
announcing a discussion initiation processing notice registered in the discussion information DB and notifying the notice via E-mail.

13. The method according to claim 10, comprising:
a discussion classification determining step of, when the background information registration is selected on the moderator menu screen sent to the terminal, determining whether the discussion classification registered in the discussion information DB indicates a background discussion;
a step of, when the discussion classification does not indicate the background discussion, sending a background information registration screen to the terminal; and
a step of inputting the background information on the background information registration screen sent to the terminal to register subtopic-specific background information in the argument information DB.

14. The method according to claim 10, comprising:
a step of, when the argument screen is selected on the moderator menu screen sent to the terminal, producing an argument screen object list and sending an argument screen processing screen to the terminal;
a non-processing determining step of selecting and an argument classification code for each object argument item on the argument screen processing screen sent to the terminal to determine whether there is a non-processed item;
a kick-out determining step of, when there is no non-processed item, determining whether there is argument kick-out;
a step of, when there is the argument kick-out, performing system kick-out processing to register kick-out result in the discussion body information DB and register kick-out content and kick-out reason code in the argument information DB; and
a step of, when there is no argument kick-out, registering an argument classification code in the argument information DB and counting a counterargument time limit.

15. The method according to claim 10, comprising:
a step of, when the advocacy request review is selected on the moderator menu screen sent to the terminal, sending a discussion ping-pong situation screen to the terminal;
a step of reviewing a requesting sentence on the discussion ping-pong situation screen sent to the terminal to determining whether the requesting sentence is cancelled; and
a step of, when the requesting sentence is cancelled, selecting forced closing to register it in the argument information DB and notify it via E-mail.

16. The method according to claim 10, comprising:
a discussion classification determining step of, when the moderator evaluation is selected on the moderator menu screen sent to the terminal, determining whether the discussion classification registered in the discussion information DB indicates a discussion-with-proposition;
a step of, when the discussion classification does not indicate the discussion-with-proposition, sending a suggestion ground evaluation situation screen to the terminal;
a step of, when the main ground of suggestion is selected by the moderator on the suggestion ground evaluation situation screen sent to the terminal, evaluating a suggestion based on suitability, unsuitability, reservation or conditional suitability of a main ground of suggestion by a system to register an evaluation result in the argument information DB; and
a step of, when the discussion classification indicates the discussion-with-proposition, evaluating whether the discussion-with-proposition is suitability, unsuitability, conditional suitability or reservation requirement by checking necessity suggestion, proposition, problem and alternative plan to register an evaluation result in the argument information DB.

17. The method according to claim 14, comprising sending a re-processing requesting message to the terminal screen if it is determined in the non-processing determining step that there is a non-processed item.

18. The method according to claim 9, comprising the steps of:
when the stakeholder is selected in the determining step, sending a discussion body information registration screen to the terminal;
inputting a delegated panel on the discussion body information registration screen sent to the terminal to register the panel in the discussion body information D;
when the delegated panel is registered, sending a requesting sentence production screen to the terminal; and
producing a requesting sentence on the requesting sentence production screen sent to the terminal to register the requesting sentence in the argument information DB.

19. The method according to claim 9, comprising the steps of:
when the panel is selected in the determining step, sending a panel menu screen for argument registration, counterargument registration, advocacy request, and reply acceptance to the terminal;
when argument registration is selected on the panel menu screen sent to the terminal, determining whether an editor is installed;
when the editor is not installed, automatically downloading the editor and executing the editor to send an editor screen to the terminal when the editor is installed; and
inputting a viewpoint on the editor screen sent to the terminal to register the viewpoint in the argument information DB and automatically notifying all discussion participants and a related audience that the new viewpoint is registered in the argument information DB via E-mail.

20. The method according to claim 19, comprising:
a special statement editor function step of breaking down a suggestion and a plurality of suggestion grounds supporting the argument for each point at issue item (for each argument) on the statement editor screen and structuralizing and inputting them to register the argument in the argument information DB; and
a step of performing classification into suggestion proposition, necessity (problem) submission, expected arisen problem and corresponding alternative plan, and case suggestion through the statement editor upon argument registration in the discussion-with-proposition, and inputting them in a pre-formatted manner.

21. The method according to claim 19, comprising steps of:
when the counterargument registration is selected on the panel menu screen sent to the terminal, sending a discussion ping-pong situation screen to the terminal;
when a counterargument object argument is specified on the discussion ping-pong situation screen sent to the terminal, sending a counterargument input screen to the terminal; and
inputting a counterargument on the counterargument input screen sent to the terminal to register the counterargument in the argument information DB, and automatically notifying that the new argument is registered in the argument information DB.

22. The method according to claim 19, comprising:
a discussion class determining step of, when the advocacy request is selected on the panel menu screen sent to the terminal, checking the discussion class registered in the discussion information DB to determine whether the discussion class indicates a normal panel discussion;
a step of, when the discussion class indicates a typical and panel discussion, determining whether an advocacy request number of the stakeholder information accumulated in the discussion body information DB exceeds an advocacy request allowed number approved in the discussion rule; and
a step of sending a discussion ping-pong situation screen to the terminal when it does not exceed the allowed number and sending an error message to the terminal screen when it exceeds the allowed number.

23. The method according to claim 19, comprising steps of:
when the reply acceptance is selected on the panel menu screen sent to the terminal, sending a discussion ping-pong situation screen to the terminal;
determining, by an advocacy requester, whether to accept a reply on the discussion ping-pong situation screen sent to the terminal and, when the advocacy requester does not accept, notifying a replier of it via E-mail, deleting a registered reply and modifying a relevant argument information DB;
when the advocacy requester does not accept, opening a reply content to the public, registering the replay content, and registering a counterargument time limit in the argument information DB;
when the counterargument time limit is registered in the argument information DB, sending a closing enquiry screen to the terminal to determine whether the closing is advocacy request closing;
when the closing is not the advocacy request closing, checking a closing time limit to determine whether the closing time limit is exceeded; and
when the closing time limit is exceeded or the closing is the advocacy request closing, deleting an advocacy request sentence and registering it in the argument information DB.

24. The method according to claim 9, comprising the steps of:
when the audience is selected in the determining step, sending an audience menu screen for counterargument, free viewpoint opinion, and advocacy request reply to the terminal;
when the advocacy request reply is selected on the audience menu screen sent to the terminal, sending a discussion ping-pong situation screen to the terminal;
selecting a reply object argument on the discussion ping-pong situation screen sent to the terminal to register an optional panel;
when the optional panel is registered, sending a reply input screen to the terminal to perform closed-processing an input and then register an input processing result in the argument information DB; and
notifying the input processing result registered in the argument information DB via E-mail and then processing viewpoint screen.

25. The method according to claim 9, further comprising a discussion result deduction step of processing a result of discussion ping-pong between all discussion participants and processing evaluation as suitability, conditional suitability, unsuitability or reservation on subject arguments (SAs), suggestions, subtopics, and discussions.

26. The method according to claim 25, wherein the discussion result deduction step comprises:
a discussion ping-pong processing step of performing superiority and inferiority processing on a ping-pong result of the SA on which a counterargument is given up;
an SA evaluation step of performing system evaluation processing on the SA, on which the discussion ping-pong processing step has performed the ping-pong result processing, as suitability, conditional suitability, unsuitability or reservation;
a discussion closing step of closing the discussion upon discussion period termination and notifying a discussion termination notice via E-mail;
a confrontation evaluation step of processing a ping-pong result on a confronted SA;
a suggestion evaluation step of checking evaluation-processed SA evaluation information for each suggestion and processing evaluation on the suggestion according to an evaluation principle on the suggestion; and
a discussion evaluation step of performing evaluation on all subtopics and discussions based on each suggestion.

27. The method according to claim 26, wherein the discussion ping-pong step comprises steps of:
checking counterargument time limit for all SAs registered in the discussion information DB to determine whether the counterargument time limit is exceeded;
when the counterargument time limit is exceeded, determining whether a counterargument on the OA is given up; and
processing SA superior when the counterargument on the OA is given up, processing SA inferior when the counterargument on the OA is not given up, processing as confrontation when the counterargument on the SA and OA is not given up, and registering information about ping-pong result processing in the argument information DB.

28. The method according to claim 26, wherein the SA evaluation step comprises steps of:
checking discussion ping-pong information on a ground of suggestion registered in the argument information DB to determine whether the discussion ping-pong is terminated;
when the discussion ping-pong is terminated, checking SA and OA nature classification, processing evaluation of suitability, conditional suitability, unsuitability, and evaluation reservation according to an argument evaluation rule, and registering the processing result in the argument information DB; and
determining whether a dependent one of suggestion grounds registered in the argument information DB, i.e., a suggestion ground structure is of a dependent type, and performing evaluation processing on the dependent argument in the same manner as an independent argument when it is of the dependent type;

29. The method according to claim 26, wherein the discussion closing process comprises steps of:
checking a discussion period registered in the discussion information DB to determine whether the discussion period is terminated; and
when the discussion period is terminated, closing the discussion and calculating a substantial discussion period to register it in the discussion information DB; and
notifying a discussion termination notice via E-mail.

30. The method according to claim 26, wherein the confrontation evaluation step comprises steps of:
checking CA registered in the argument information DB to determine whether a new CA is registered;
when the new CA is registered in the argument information DB, determining whether a substantial discussion period registered in the discussion information DB has elapsed; and
when the substantial discussion period has elapsed, finally processing non-processed discussion ping-pong and SA evaluation.

31. The method according to claim 26, wherein the suggestion evaluation step comprises checking, by a system, ground-specific SA evaluation information in response to a moderator's argument evaluation instruction and automatically performing suggestion evaluation when all SA evaluations are equally made as suitability, unsuitability, conditional suitability or evaluation reservation.

32. The method according to claim 31, comprising steps of:
when the ground evaluation is terminated, creating an SA evaluation abstract table abstracting evaluation on all SAs registered in the discussion information DB and sending a discussion evaluation processing screen to the terminal;
checking a discussion evaluation type and inputting subtopic evaluation information when the evaluation type=1 to register the subtopic evaluation information in the discussion information DB;
when the evaluation type≠1, sending a subtopic evaluation sentence production screen to the terminal; and
producing a subtopic evaluation sentence on the subtopic evaluation sentence production screen sent to the terminal to register the sentence in the discussion information DB.

33. The method according to claim 32, comprising steps of:
when the subtopic evaluation is completed, sending a discussion evaluation sentence production screen to the terminal;
producing a discussion evaluation sentence on the discussion evaluation sentence production screen sent to the terminal to register the sentence in the discussion information DB;
determining whether the discussion evaluation sentence registered in the discussion information DB indicates that evaluation type=1; and
when it indicates that the evaluation type=, inputting all-discussion evaluation to register the discussion evaluation information in the discussion information DB.

34. The method according to claim 14, further comprising a discussion ping-pong situation enquiry displaying step of displaying discussion ping-pong such as counterarguments and further counterarguments on one screen for each the subject argument.

35. The method according to claim 34, wherein the discussion ping-pong situation enquiry displaying step comprises an outputting step of grouping subject counterarguments and object arguments produced in a ping-pong process for each panel for discussion ping-pong situation enquiry processing, and calculating a screen output position of each argument regardless of the number of the produced arguments to automatically adjust a screen size.

36. A method for Internet-based discussion that combines discussions of all participants-in-discussion having access via Internet to deduce a conclusion, the method comprising:
a discussion preparation step (S100) including a discussion determination process (S110) of determining a subject of a discussion, a moderator, a stakeholder and an audience; a basic discussion data determination and conference process (S120) of determining a discussion period and discussion rules through conference and determining a panel for each stakeholder; an all participants-in-discussion registration process (S130) of first registering a moderator to perform the discussion by an operator of a discussion managing server and registering remaining all participants-in-discussion directly participating in the discussion by the registered moderator; a discussion operating information registration process (S140) of registering basic discussion data, discussion nature classification and background information; and a subtopic registration process (S150) of registering subtopics of the discussion and determining and registering a subject party for each subtopic;
a discussion ping-pong step (S200) including a discussion initiation process (S210) of announcing a registration and guide message in a site on-going discussion list and notifying a discussion initiation notice via E-mail; a subject argument registration process (S220) of registering a subject argument (SA) and automatically notifying all discussion participants of a new argument registration notice via E-mail; an argument screen process (S230) of classifying and registering subject argument (SA) nature and notifying defect argument kick-out via E-mail; and a counterargument registration process (S240) of registering a counterargument on the SA and automatically notifying all discussion participants of a counterargument registration notice via E-mail;
a discussion evaluation step (S300) including a discussion ping-pong result processing process (S310) of performing superiority and inferiority processing as a result of ping-pong on the SA on which a counterargument is given up; and an SA evaluation process (S320) of performing system evaluation such as suitability, conditional suitability, unsuitability and reservation on the SA; and
a discussion termination step (S400) including a discussion closing process (S410) of performing closing processing upon discussion period termination and notifying a discussion termination notice via E-mail; a ping-pong termination process (S420) of performing on-going ping-pong confrontation processing and confronted ping-pong SA evaluation processing; and a discussion evaluation process (S430) of performing suggestion system evaluation, subtopic evaluation, and all-discussion evaluation processing.

37. A method for Internet-based discussion that combines discussions of all participants-in-discussion having access via Internet to deduce a conclusion, the method comprising:
a branch discussion step of prosecuting, by a few specific group, a discussion independently from a main discussion and reflecting a result in the main discussion when special knowledge is needed in a discussion prosecution process; and
a counter discussion step of attempting discussion ping-pong on a specific case at a reversed position, the branch discussion step and the counter discussion step being included as sub-discussions dependent on the main discussion.

38. A recording medium having a method for Internet-based discussion recorded thereon, the method combining discussions of all participants-in-discussion having access via Internet to deduce a conclusion, the method comprising:
automatically connecting a terminal to a discussion managing server and sending a discussion body-specific menu screen to a terminal in response to an access request from all discussion participants;
determining whether an operator is selected from a group consisting of an operator, a moderator, a stakeholder, a panel, an audience on the discussion body-specific menu screen sent to the terminal;
when the operator is selected on the discussion body-specific menu screen, sending a discussion information registration screen to the terminal;
inputting basic information such as a discussion period and a discussion title on the discussion information registration screen sent to the terminal to register the basic information in a discussion information DB;
when the basic discussion information is registered, sending a discussion body information registration screen to the terminal; and
designating the moderator on the discussion body information registration screen sent to the terminal to register the moderator in the discussion body information DB.

39. A recording medium having a method for Internet-based discussion recorded thereon, the method combining discussions of all participants-in-discussion having access via Internet to deduce a conclusion, the method comprising:
a discussion preparation step (S100) including a discussion determination process (S110) of determining a subject of a discussion, a moderator, a stakeholder and an audience; a basic discussion data determination and conference process (S120) of determining a discussion period and discussion rules through conference and determining a panel for each stakeholder; an all participants-in-discussion registration process (S130) of first registering a moderator to perform the discussion by an operator of a discussion managing server and registering remaining all participants-in-discussion directly participating in the discussion by the registered moderator; a discussion operating information registration process (S140) of registering basic discussion data, discussion nature classification and background information; and a subtopic registration process (S150) of registering subtopics of the discussion and determining and registering a subject party for each subtopic;
a discussion ping-pong step (S200) including a discussion initiation process (S210) of announcing a registration and guide message in a site on-going discussion list and notifying a discussion initiation notice via E-mail; a subject argument registration process (S220) of registering a subject argument (SA) and automatically notifying all discussion participants of a new argument registration notice via E-mail; an argument screen process (S230) of classifying and registering subject argument (SA) nature and notifying defect argument kick-out via E-mail; and a counterargument registration process (S240) of registering a counterargument on the SA and automatically notifying all discussion participants of a counterargument registration notice via E-mail;
a discussion evaluation step (S300) including a discussion ping-pong result processing process (S310) of performing superiority and inferiority processing as a result of ping-pong on the SA on which a counterargument is given up; and an SA evaluation process (S320) of performing system evaluation such as suitability, conditional suitability, unsuitability and reservation on the SA; and
a discussion termination step (S400) including a discussion closing process (S410) of performing closing processing upon discussion period termination and notifying a discussion termination notice via E-mail; a ping-pong termination process (S420) of performing on-going ping-pong confrontation processing and confronted ping-pong SA evaluation processing; and a discussion evaluation process (S430) of performing suggestion system evaluation, subtopic evaluation, and all-discussion evaluation processing.

40. The method according to claim 9, further comprising the steps of:
when the operator is selected in the determining step, sending a discussion information registration screen to the terminal;
inputting basic information such as a discussion period and a discussion title on the discussion information registration screen sent to the terminal to register the basic information in a discussion information DB;
when the basic discussion information is registered, sending a discussion body information registration screen to the terminal; and
designating the moderator on the discussion body information registration screen sent to the terminal to register the moderator in the discussion body information DB.
